(19) United States
(12) Patent Application Publication
(10) Pub. No.: US 2002/0065826 A1
(43) Pub. Date: May 30, 2002

(54) Systems and processes for measuring, evaluating and reporting audience response to audio, video, and other content

(76) Inventors: Christopher Nathan Bell, Acworth, GA (US); Michael Jay Becker, Atlanta, GA (US); William Christopher Carson, Acworth, GA (US); Mark Leslie Henry, Marietta, GA (US); Robert Steven Glassley, Woodstock, GA (US); Bernadette O?apos;Grady DiMauro, Acworth, GA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 09/766,504

(22) Filed: Jan. 19, 2001

Related U.S. Application Data
(60) Provisional application No. 60/219,277, filed on Jul. 19, 2000.

(51) Int. Cl. G06F 7/00

(52) U.S. Cl. 707/10

(57) ABSTRACT

The invention provides a system and method for more effective measurement and observation of listener or viewer response or commitment to various forms of audio and visual content, including music, film, television and Internet based content. The invention offers activities to users who can accrue incentives such as points for engaging in various activities. The invention tracks the user activities and matches it with user disembodied demographic information. Users who have accrued points can participate in auctions for various prizes. The invention also measures and tracks the commitment level to the content based on the types of activities selected by the user. The information gathered by the invention may be processed and reported to the content provider for better understanding of user tendencies.

### RELATED APPLICATIONS

This application claims the benefit of U.S. Provisional Application No. 60/219,277 filed on Jul. 19, 2000.

### FIELD OF INVENTION

The present invention relates to systems and processes for measuring, evaluating, and reporting audience response to various forms of content including audio, video, and information-based content. Such systems and processes are of value to various entities in the recording, other audio, television, film, other video, information-based and other content fields, including artists or other talent, record labels, studios, producers, publishers, advertisers, retailers, content owners, media providers, various intermediaries, and consumers.

### BACKGROUND OF THE INVENTION

Proliferation of high speed data infrastructure including the World Wide Web is profoundly changing the way the entertainment industry operates, whether the film industry, the music industry, or the television industry. These changes flow from the opportunities provided by the new digital and data network infrastructure to create, promote, copy, and distribute content and to measure listener and viewer response to content. The changes have a great deal to do with the ever-increasing speed and ease with which content can be created, copied and distributed, and with which audience response and reaction to such content can be measured, evaluated and reported.

These changes are inevitable, increasing in pace, and in many ways applicable for all industries which provide music, video, movie content, internet content and other forms of entertainment or information based content. The present invention seeks to benefit various participants in these industries by, among other things, providing new ways to measure and report information relating to how listeners, viewers and others are responding and reacting to content in real time. This possibility allows participants, among other things, to identify potentially successful content or talent early, monitor audience or consumer reaction to talent or content, and tailor marketing and promotion of talent or content based on such information.

As one example of changes wrought by the Internet and the consequent power of the present invention to harness such changes to the benefit of participants in the entertainment industry, consider how the music industry has operated in the past and the changes it faces. One reason the music industry is an apt example is because the labels encountered these changes sooner than the film and television industries, where early adoption of Internet distribution was precluded by bandwidth-related issues.

Since the beginning of recorded music, talent in the form of musicians, bands and other artists were identified, capitalized and marketed by the record companies which had requisite financial wherewithal. Up until around the mid 1960's, labels typically recorded and promoted single-track recordings in the form of so-called “45's,” discs which rotated on a phonograph at 45 rpm, and which contained a single spiral groove from the periphery to the inside of the disc, the groove receiving a phonograph stylus which tracked and vibrated to reproduce, in analog fashion, the sound that corresponded to serrations along the edges of the groove. Recording was an expensive process, and phonograph technology had not evolved to the point where records could be reliably molded with grooves sufficiently narrow to contain more than one track which could be heard with adequate audio fidelity. Accordingly, the recording industry financed, recorded and promoted artists one track, one 45 (and before that, one 78), at a time. Single track recordings can still be found on the CD medium and vinyl 45's, although availability of music in the single-track format is currently far from ubiquitous and no longer, until Internet times, commercially significant.

As time progressed, developments in plastics technology and machining techniques made it possible to manufacture a so-called long playing vinyl album, which could contain multiple tracks totaling approximately 45 minutes of music, and could faithfully produce near-studio, even if only monaural audio-fidelity. The vinyl LP was first adopted for recording the classics because it could contain an entire symphony or opera.

Since the early days, the radio medium had been a central marketing channel for the recording companies, who distributed records to the radio stations for free, receiving their quid pro quo in the form of free exposure and listener statistics. Clearing houses such as Billboard and later Arbitron tracked performance of artists and tracks on the radio medium using listener surveys. It was not long before the record companies began more actively to promote airplay on radio stations in an effort to generate exposure and numbers, using cross media campaigns and certain promotional emoluments in an effort to persuade radio stations to play certain cuts or feature certain artists.

Three developments in the 1960's drove the commercially relevant music format from track to album. First, further developments in manufacturing technology and significant advances in recording and audio reproduction technology gave rise to stereophonic recordings on LP albums. About the time these recordings became widespread and affordable, new radiofrequency modulation techniques opened the FM radio bands to broadcast stereo musical content with decent audio fidelity. Third, new electronic transducer and amplification technology gave rise to new electric guitars, marketed by companies such as Gretsch and Fender. Listeners could now hear these artists and their new instruments, via the stereo LP recording as played on FM radio, with the same power as ten feet away in the studio. This new climate made it possible for artists to develop and explore themes spanning an extended procession of tracks, not dissimilar to opera and the classics. The labels quickly recognized that concert tours and advertising campaigns could be structured around these albums and these themes. Artists got increased control over the context in which their works were presented to their listeners, and the record companies got the advantage of a commercial image and theme on which to base promotional activities.

Beginning in the mid 1980s, radio markets began to consolidate generally in ownership and into several major content categories, including rhythm and blues, album oriented, popular, so-called “country,” and classical. As ownership of radio stations consolidated and advertising became more centralized through major ad agencies, radio stations adjusted their play lists to minimize risk by focusing on artists and albums with proven track records. Accordingly, new artists without a track record faced a growing challenge to get airplay and the level of popularity that would leverage them exposure and financially satisfactory deals with the labels. Even then, however, certain strong artists could command a culturally important if small underground following, based on the club scene, exhaustive touring efforts, sheer force of personality, word of mouth or other non-mass media/major label channels. This dialectic based on mass market cooption of artistic trends previously viewed as commercially unacceptable or unacceptably risky or radical, combined with the fact that each generation of listeners learns its own truth, continues to drive progress in the music industry in current times, and one of the objectives of the present invention is to discover and promote the emerging artists and tracks which will start or fuel future broader musical trends.

The advent of chain music stores and just in time inventory control techniques in the late 1980s diversified musical trends. New point of sale tracking systems allowed the chains to manage inventory more effectively, but labels became a third party beneficiary. In addition to using point of sale information to supply the chains, they could now leverage, almost in real time, information about what artists and albums were actually selling as opposed merely to that music to which radio station listeners were responding. These systems increasingly provided new opportunities to artists who had a local following or were otherwise known by word of mouth. They stimulated college radio and the genesis of efforts by labels to promote their music on that format as well. Now, labels for their own commercial success needed to identify and begin backing artists in a number of categories other than simply the radio formats, including adult contemporary, alternative rock, big band, Christian contemporary, classic rock, classical, college, country, progressive country, dance, disco, goth, jazz and so called smooth jazz, blues, industrial, latin, metal, new age, house, oldies, top 40, hip hop, world, trance, electronic, and techno. Independent labels found market niches and began taking share from the major labels in some of these areas. In part because it became more difficult to predict which trends would become mainstream, the major labels found it necessary through their advertisers to be increasingly creative in identifying which of these areas to participate in, which artists to back, and the media channels in which to back them. One seeming constant, despite this diversification, continued to be the centrality of the album format in the recording and promotional process.

The emergence of affordable consumer electronic video camera equipment in the 1980's added a new marketing driver: Artist as icon. Television stations and channels started with formats based on low cost, highly creative and challenging video music content. This format quickly consolidated, however, into the handful of national cable music video channels which even if they continue to offer certain works of high artistic merit, tend to err on the side of avoiding risk and focusing on mainstream proven quantities. Accomplished movie and television producers, financed by the labels, leveraged their talent to create unforgettable videos whose visual imagery elevated even mundane music and artists into a new order of style and charisma. Within a period of only a few years, the labels had perfected marketing based on the artist as icon, in addition to using album oriented strategies to maintain predictability and ensure to the maximum extent possible they were backing the right artists and formats. Certain artists, of course, accrued massive visual brand equity of the sort previously possible only through grueling concert tours.

Recent developments in packet-based data networks, including the Internet, breathe fresh air into this icon-based and album oriented world, and in doing so they resuscitate the viability of the track as a relevant format. With the advent of data modulation and formatting techniques which allow users to connect to the Internet with reasonable speed and bandwidth, music tracks began to be distributed in packetized form either by file transfer or real time or “streaming” techniques. Standards such as Moving Picture Expert Group Level 3 or so-called “MP3” standards and other proprietary streaming standards allowed users to select, listen to and download single tracks of music. These could be stored on computer hard drives and on stand-alone devices such as portable players. Tracks could be copied and disseminated anywhere in the world almost instantaneously. Users could search engines to point them to sources of virtually any track from any artist on the planet. Ultimately, whether or not listeners have to account for performance, copying, or other use of copyrighted works at the same level as in previous times, these potential alternative distribution pipelines and the resurgence of the track as relevant format present significant challenges and opportunities to everyone in the music industry. Users now have the power to access and obtain artists' works without having to buy into the whole album on which the track is found. Established labels and artists are finding that this loss of control is perhaps one of the most formidable presented by the new Internet climate. On the other hand, however, artists who have the courage and vision to embrace these new changes have the potential to rise out of nowhere and in a matter of hours demonstrate resonance to their music through fan listening, downloading, review, and other activities which can be recorded and reported in real time. Labels have the potential in real time to know who is listening and responding to what.

Some have attempted to leverage these developments to change the way in which music is sold and profits are made. For instance, many sites offer MP3 files for download while tracking demographics which may ultimately be desired by those who finance and promote artists and music. More conventionally oriented web sites sell CDs, allow music review and track demographics. Yet other sites allow users to stream audio, download files, buy products, give reviews and conduct other activities while accruing incentives or otherwise building affinity for the universally desired “stickiness factor.” These organizations and systems fall short, however, of exploiting more nearly the full potential offered by the Internet and emerging future content management and distribution opportunities in a data networking infrastructure.

In short, it is fair to say that the new Internet infrastructure for music distribution has created a climate of flux and opportunity characterized at least by:

Clutter: Literally thousands of consumer-oriented music and lifestyle websites have emerged over the course of the last few years and new music sites launch every day.

Piracy: Digital distribution of music has exploded as a leading use of the Internet, but a significant amount of the content being distributed is violative of copyright. For instance, a recent survey reported that 70% of college students used a particular file sharing program which allows user to user downloading of music front-ended by a centralized database, and that 57% are weekly users of this system. As a result, sales of CD's in college communities have dropped dramatically, at least according to the recording industry, while labels are litigating and determining how to alter their business model.

Distrust: Given the absence of third-party validation and a strong market incentive to exaggerate, data reported by music web sites is typically not trusted by the industry. This dynamic is similar to the decreased relevance of radio station listener response surveys as compared to point of sale information in conventional record industry decision making. Additionally, typical web site information is viewed as insufficiently comprehensive to guide marketing decision making.

Confusion: The falloff in signal to noise ratio caused by thousands of sites, the distraction of piracy, and the distrust of current data reporting leaves talent intermediaries such as labels confused about how to leverage the Internet as a new channel to market, promote, distribute and receive real time feedback on content from artists.

Similar changes have occurred and will continue to occur in other segments of the entertainment and content fields. For instance, in the movie industry, the advent of the video camera and video playback equipment introduced a new distribution medium which allowed studios a new mode of garnering potential profit after initial theater run. Recent implementation of functionality on servers, combined with increased bandwidth and standardization on packet based distribution of video content based on Motion Picture Expert Group standards have again changed the way studios and others in the film industry will finance and produce films and make money. The present invention and its principles leverage the real-time distribution and information-gathering potential of the connected environment to allow more effective, efficient and profitable identification, financing, production, marketing and distribution of any form of content..

### SUMMARY OF THE INVENTION

Systems and processes according to the present invention provide functionality that enables more effective measurement and observation of listener or viewer response or commitment to various forms of audio and visual content, including music, film, television and Internet based content. Systems and processes according to the present invention operate to the benefit of talent, labels, producers, media content owners, other intermediaries, advertisers, affiliate web sites, retailers, listeners, viewers and others by providing fresher more reliable information about which content listeners, viewers or other users prefer, their level of commitment in such preferences, changes in preferences and level of commitment, and other information that is useful or desirable about which content should be made available in which manner on which media with which business entities. Such platforms and processes may interface with users on dedicated, third party and/or the users' platforms, systems or networks, and wherever else desired on the Internet, whether such platforms, systems or networks are connected via physical medium such as twisted pair, fiber or coaxial, or via air interface such as wireless or satellite communication enabled devices.

According to one example embodiment of the present invention aimed at the music industry, systems and processes according to the present invention present via dedicated and/or third-party web sites music tracks for downloading, information about artists and music news, opportunities to buy music, opportunities to review artists and tracks, concert calendar information and other opportunities to interact. Users who engage in these activities can accrue certain electronic incentives such as points. The incentives offered users by systems and processes of the present invention are preferably relative in value rather than absolute, power based rather than cash based: Users who have accrued points can participate in auctions for recorded music, electronic equipment, concert tickets and other prizes. The auctions may be controlled in real time, such as by controlling minimum and/or maximum bids, overtime periods and other adjustments to stimulate participation and interest. The user's earned auction power, when combined with the auction operator's power to control the dynamics of the auction by selection of prizes, adjustment of rules, bid sizes, and time periods, amplifies excitement, participation and stickiness in many ways, including increased log-on periods, increased return rates, and increased and more comprehensive participation in the range of interactive options presented by the interface. All of this increased level of intensity and activity drives better and more comprehensive harvesting and reporting of statistically relevant and accurate information about which listeners, by gender, age, and zip code, are responding to which artists and tracks in various situations, and their level of commitment in responding. For instance, listeners who click to hear an artist may be considered to have interest but generally less so than those who download an MP3 file for the artist. Similarly, various forms of activity including downloading a track, participating in an auction for an artist's CD or purchasing a CD from an affiliate's site, can be considered to demonstrate enhanced levels of commitment which could, if desired, correspond to differences in treatment of points, other incentives, frequent user rules, and other techniques to stimulate interest, participation, comprehensive and sustained interaction and returned visits.

Such processes and systems according to this example can thus offer a comprehensive suite of placement, assessment, promotion and management services and opportunities to labels, other talent intermediaries, advertisers, affiliates, artists, management, and users in the music industry. Such systems and processes allow labels and artists to outsource the research, select, place and manage content on third-party web sites. They allow aggregation of data reported by each of these sites for consolidated and customized reporting, highlighting and analyzing response to content. The systems and processes also offer targeted promotional services which leverage the full extent of the communications resources available on the Internet and other emerging data networking media. Those include electronic mail, chat room and more conventional promotional campaigns as well as conventional print media, television and other coordinated campaigns to promote artists and content.

One version of processes and systems according to the present invention allows labels and artists to enhance their web presence with their own sites or interfaces driven by systems and processes of the present invention. The artists or labels can thus offer, using their own branding, some or all of the interactive activities mentioned above together with the incentive programs and demographic harvesting and reporting opportunities. These third-party front-ends supported by systems and processes according to the present invention not only increase user participation, but they also garner a broader cross section of the Internet and other public as well.

The auction system and processes according to an alternate embodiment of the present invention can influence behavior, stimulate length and intensity of user sessions on a site, and incentivize users to listen to and become familiar with certain music. The model can reward an artist's fans with points every time they interact such as by streaming a track, downloading a file, referring a friend, joining a fan club, buying a CD, offering a review, or other activity. Points can be redeemed in a highly competitive and entertaining auction environment where premiums can be provided by third-party merchants in exchange for promotional exposure in the auctions. The very nature of the auction-based reward model, as opposed to a more absolute model, motivates continued interactivity and consumption of music, given among other things that the medium is power-based (bidding power) rather than cash or absolute value based.

According to other embodiments of systems and processes according to the present invention, observational functionality according to the present invention, with or without a userface, and without the incentives/auction aspects mentioned above, can reside on third party platforms, systems or networks, on user platforms, systems or networks, or wherever else desired or opportune to observe and measure any desired aspect of what listeners, viewers, or other users are doing relative to various forms of content. The information generated by such observational functionality can be reported to an entity which collects, collates, processes and/or otherwise prepares and provides information that enables various entities operate more effectively and/or efficiently in the content or entertainment fields.

Accordingly, systems and processes according to the present invention allow talent intermediaries and those who promote and distribute various forms of content to increase their understanding of their consumer base, improve their product offerings in various media and channels of trade, retain and increase interest and traffic, drive electronic commerce and conventional commerce in content, motivate user-generated content, motivate word-of-mouth referrals, increase distribution of product information, special promotions or coupons, and grow and activate fan bases for media products and artists.

According to business exchange systems and process aspects of the invention, central database capacity can capture activity information relating to activities such as consumption of digital media including streaming audio/video, downloading audio/video or any of the other activities mentioned above and correlating these demographics to a lyric database, artist or media specific information, site or location information and disembodied demographic data. The data may be combined and/or applied to create customized and granular information at many levels about what users like about tracks and artists, to what extent the commitment exists, and why there is this commitment.

Accordingly, systems and processes according to the present invention provide systems, processes and other functionality which add value for record labels, film studios, artists and management, music publishers, concert promoters, booking agents, entertainment attorneys, talent agencies, clearing houses, corporate advertisers, electronic commerce presences, and others by supplying a space for interactive entertainment, electronic commerce, harvesting of consumer response information, demographic collection, processing and reporting, and payment of royalties among other opportunities.

In at least these ways, systems and processes of the present invention recognize and address the online world's forcing the entertainment industry to reconsider and change the ways in which they identify talent and market content In particular, these systems and processes recognize the vulnerability of marketing strategies based on conventional marketing techniques such as album oriented paradigms or iconography. They address such vulnerability by giving entities in the industry real time, concrete and reliable information about which talent and content which listeners, viewers and other users are responding to, and how, why and when they are responding. Such systems and processes thus offer the opportunity to identify in their nascency emerging or vanguard trend-setting talent or content. Artists now have new and unparalleled opportunities for exposure and success. Users have the opportunity to listen to or view fresh, exciting and challenging new movies, television content, music or internet content, and to help change the trends in the industry to reflect more accurately what they want to hear. Such systems and processes thus have the potential to be even more powerful than, for instance, previous point of sale data collection systems, box office sales information or listener or viewer surveys in changing the way the entertainment industry conducts business.

### BRIEF DESCRIPTION OF THE DRAWINGS

FIG. 1 is a functional block diagram showing a platform of one embodiment of the present invention in relationship to other entities in a data network.

FIG. 2 is a functional block diagram showing components of a platform 100 according to an alternate embodiment of the present invention.

FIG. 3 is a functional block diagram showing certain activities performed by the platform of FIG. 2.

FIG. 4 shows certain user interaction processes in connection with platforms according to an alternate embodiment of the present invention.

FIG. 5 shows certain affiliate presentation process flow according to an alternate embodiment of the present invention.

FIG. 6 (as do FIGS. 7-54) relates to the embodiment shown in FIG. 2 and shows a screen shot showing an entry page to a site or interactive space according to an embodiment of the present invention which is particularly adapted for the music industry and for generating information based on incentives and auctions.

FIGS. 7A and B are a screen shot of a main navigational interface of the site of FIG. 6.

FIGS. 8A and B are a screen shot of a member registration page of the site of FIG. 6.

FIGS. 9A and B are a screen shot of page two of a member registration page of the site of FIG. 6.

FIGS. 10A and B are a screen shot of a registration success page of the site of FIG. 6.

FIG. 11 is a screen shot of a further success and confirmation page for member registration on the site of FIG. 6.

FIGS. 12A and B are a screen shot of a member logon screen face for the site of FIG. 6.

FIGS. 13A and B are a screen shot of a navigational screen face for members of the site of FIG. 6.

FIGS. 14A and B are a screen shot of a points tracking screen face for members of the site FIG. 6.

FIGS. 15A and B are a screen shot of a screen face which contains rules for the site of FIG. 6.

FIG. 16 is a screen shot which shows current auctions being conducted on the site of FIG. 6.

FIGS. 17A and B are a screen shot of rules for obtaining points and participating in auctions on the site of FIG. 6.

FIGS. 18A and B are a screen shot of rules for member points of the site of FIG. 6.

FIGS. 19A and B are navigational screens for an electronic commerce functionality for the site of FIG. 6.

FIG. 20 is a screen shot showing a drill down from FIGS. 19A and B.

FIG. 21 is a shopping cart screen face corresponding to the product shown in FIG. 20.

FIG. 22 is a screen shot of address and payment information for purchase of items in the electronic commerce functionality shown in FIGS. 19A and B.

FIG. 23 shows an order history for the electronic commerce functionality shown in FIGS. 17A and B.

FIGS. 24A and B are a screen shot which shows current auctions underway on the site of FIG. 6.

FIGS. 25A and B show frequently asked questions for auctions on the site of FIG. 6.

FIGS. 26A and B show a drill down of a particular auction, rules for the auction, and history of the auction listed in FIGS. 25A and B.

FIG. 27 is a screen shot which shows upcoming auctions on the site of FIG. 6.

FIG. 28 is a screen shot showing clothes auctions on the site of FIG. 6.

FIGS. 29A-D show rules for artists to submit music to the site of FIG. 6.

FIGS. 30A-D are screen shots showing an artist profile information form for artists who wish to participate on the site of FIG. 6.

FIG. 31 is an artist logon screen shot for the site of FIG. 6.

FIG. 32 is a screen shot showing discussion groups currently in operation on the site of FIG. 6.

FIG. 33 is a screen shot listing featured artists on the site of FIG. 6.

FIG. 34 is a screen shot of a drill down to a particular artist listed on FIG. 33.

FIGS. 35A-C are a continuation of FIG. 34 which allows users to email friends, check the photo gallery, download and rate songs and otherwise interact and gain points relative to the artist shown in FIG. 34.

FIG. 36 is a screen shot which shows a note from the artist shown in FIG. 34.

FIG. 37 is a screen shot which shows the photo gallery for the artist shown in FIG. 34.

FIGS. 38 and 39 are screen shots which show an event column for the artist featured in FIG. 34.

FIG. 40 is a screen shot showing a concert calendar for artists participating on the site of FIG. 6.

FIGS. 41A and B are screen shots that show an interactive functionality for allowing artists to gain points, receive premiums, and obtain data about user response to them and their content.

FIG. 42 is a screen shot that shows tips for maximizing opportunities in the functionality shown in FIG. 41.

FIG. 43 is a screen shot that explains the rating system for the functionality shown in FIG. 41.

FIGS. 44A and B are screen shots that show rankings of particular artists based on activities in the functionality shown in FIG. 41.

FIG. 45 is a screen shot that shows ranking based on total points for artists who participate in the functionality shown in FIG. 41.

FIGS. 46A and B are screen shots explaining the rules for a cross media promotion featured on the site of FIG. 6.

FIGS. 47A and B are screen faces which allow the user to participate in the cross media promotion shown in FIG. 46.

FIG. 48 is a screen shot showing a listing of artists whose names begin with A featured on the site of FIG. 6.

FIG. 49 is a registration screen shot showing rules and benefits for a higher level of membership on the site of FIG. 6.

FIG. 50 is a screen shot showing address and payment information for obtaining higher membership status as described in FIG. 49.

FIG. 51 is a screen shot that shows a billing address entry screen to support the screen shot shown in FIG. 50.

FIG. 52 is a verification screen shot for purchase of the higher membership status as shown in FIG. 49.

FIGS. 53A and B are confirmation screen faces showing the order for the higher membership status of FIG. 49.

FIG. 54 shows one proforma of a user data report according to a preferred embodiment of the present invention.

### DETAILED DESCRIPTION

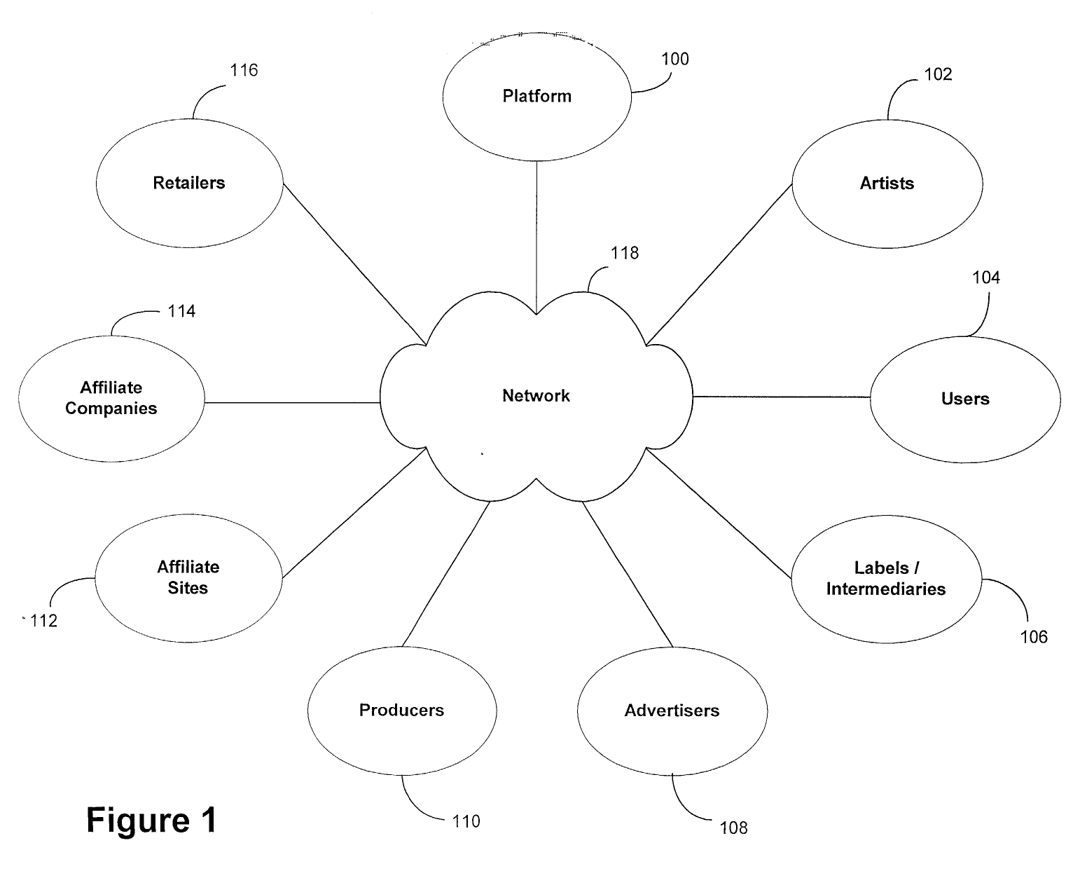

FIG. 1 shows a functional block diagram of one version of systems and processes according to the present invention. Platform 100 may be an interactive platform such as a web site running on conventional platforms and containing processing, memory, input/output, and other conventional computer components. Memory contains a database or databases of information relating to artists, music, users, responses, interactive activities, and other relevant or desired information for use and presentation via input/output functionality through or with the aid of processor functionality. Platform 100 can interacts through Internet or other data or telecomms network 118 with any or all of talent or artists 102, consumers 104, content owners or providers or other intermediaries 106, advertisers 108, producers 110, affiliate web sites 112, affiliate companies 114, retailers 116, and any other entity as desired. All of these may communicate with each other via the Internet or other suitable data or telecomms networks. Whether switched or unswitched, communications media may include fiber, wireline, wireless, infrared or otherwise, and may occur using any desired platform and software. Users 104 may access platform 100 to access systems and processes according to the present invention; platform 100 is but one embodiment of such systems and processes. Interfaces for such interaction, which can be connected to platform 100 or supported by independent platforms, can also or alternatively be placed on affiliate sites 112 which may be sites of artists, labels, distribution entities, or other entities. Any other site can just as easily provide an opportunity for an interface to access systems and processes according to the present invention.

Users 104 access platform 100 or affiliate sites 112 in order to interact or engage in certain activities. These include:

1. downloading content;

2. streaming files;

3. reviewing or rating artists or tracks;

4. joining a fan club;

5. participating in surveys;

6. purchasing merchandise;

7. logging on;

8. sending e-mail;

9. listening to electronic radio stations;

10. entering a code or number from a scratch-off-coupon;

11. participating in an auction or other activity provided by alternative embodiments of the invention;

12. reading news;

13. conducting a search;

14. accessing information such as an interactive concert calendar or a link about an artist.

Each of these activities may be assigned a code and tracked as the user participates. The activity code may be combined with user disembodied demographic data including, for instance, an identification number or other unique user ID, age, gender, and zip code. This information which may be tracked and recorded as the user participates can be stored in the platform 100 mass memory or database for processing in privacy-sensitive reporting to artists 102, labels 106, advertisers 108, producers 100, affiliate companies 114, retailers 116, and others who may desire to know concretely what users 102 are responding to when and why. The key is that activity codes matched to disembodied user demographic data shows what categories of music and artists users are responding to and not responding to in real time in order to reflect a sort of “music DNA.”

According to one alternative embodiment of the invention, users 104 can accrue points or other incentives as they interact. The size of the point award can be tailored to correspond to the activity. Higher awards could, for instance, be based on level of effort, level of commitment to artists or tracks, level of economic effort, such as purchase of CDs and other goods, and any other ranking desired.

After users 104 have accrued points, they may according to another alternative embodiment of the present invention, participate in an auction for certain premiums. The premiums may be made available to the operator of platform 100 in recognition of its promotional value on interfaces supported by platform 100; they can be provided under any other circumstances that make sense commercially. The premiums may be obtained and presented as otherwise desired. In the auction process, which may be subject to human intervention and control if desired, the intensity and length of activity and thus the dynamics of activity that reflect the value of the points, may be adjusted by controlling the minimum and/or maximum bid, as well as the time period in which the auction occurs, among other things. For instance, overtime can be invoked if significant bids begin to happen as closing time approaches. Other rules may be invoked to stimulate conduct, prevent gaming the system, or other concerted or unfair conduct or activity. The user's activities in the auction can also be assigned various activity codes for tracking and reporting. For instance, bids for a CD reflecting a certain artist can be combined with disembodied demographic information to reflect significant commitment by a particular category of user to a particular artist. If that user is also participating in another auction for a new form of consumer electronics, that information can be combined to show sophistication of the user in correlation with resonance to a particular artist or track or lyric. Thus, award of points and participation in the auction based on the points distinguishes systems and processes of the present invention from other music related presences. First, systems and processes according to the present invention are involved and active as opposed to television or passive content sources. The points engine which awards auction power and potential competitive strength and excitement instead of absolute value points attracts and incentivizes users to listen to new artists and thus to reinforce favorable responses to new artists. Second, demographics provided by this intensified auction activity provide labels and other distribution entities higher quality information they need in order to test artists ahead of time for more accurate prediction of what opportunities to promote and how to promote them in order to maximize profits. Incentives exist for artists, who have the opportunity to get ranked and to be paid, according to a certain formula.

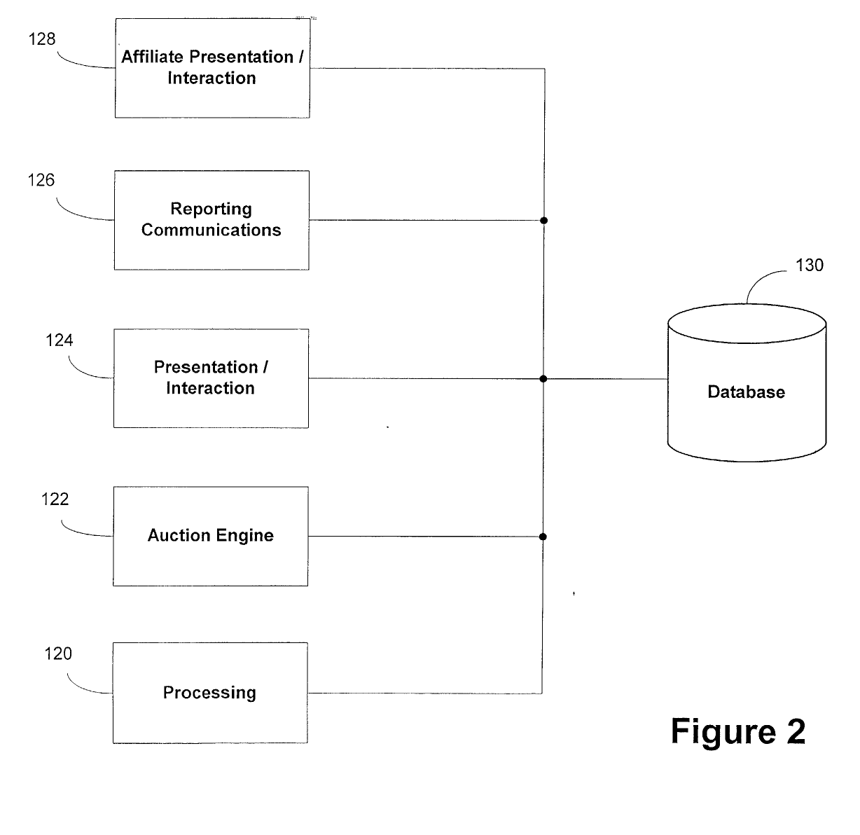

FIG. 2 shows a functional block diagram of components of platform 100 according to one embodiment of the invention. Platform 100 may be include a database 130 which communicates with an auction engine 122 and processing functionality 120 to store, process, and provide information to and receive information from presentation/interaction functionality 124 and reporting communications functionality 126. Platform 100 may also similarly service affiliate/interaction functionality 128 over any communications facility including the Internet

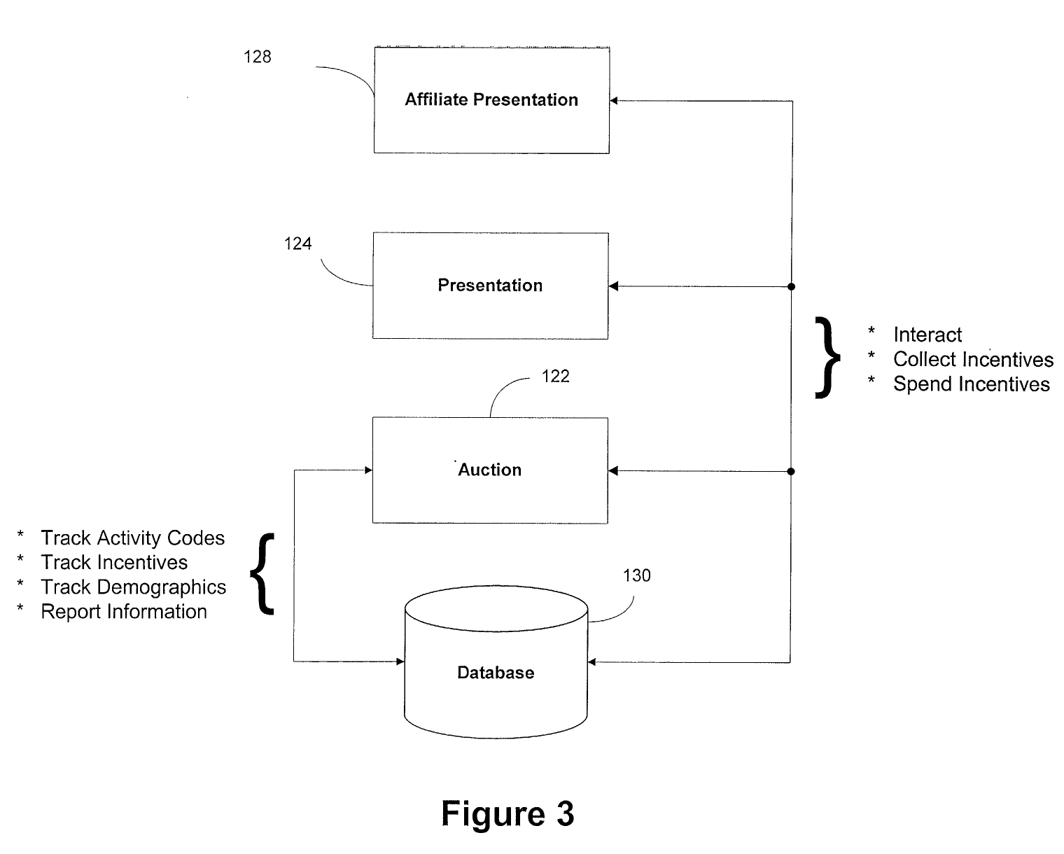

FIG. 3 shows one form of a presentation/interaction functionality 124 and/or 128, according to one embodiment of the invention in which users have the chance to interact with platform 100 as described above including streaming and/or downloading content or other activity and including, in alternative embodiments of the invention, collecting points and spending them in an auction. As that happens, platform 100 tracks using activity codes, correlates them with disembodied demographic data, track points, and reports information as desired to industry entities.

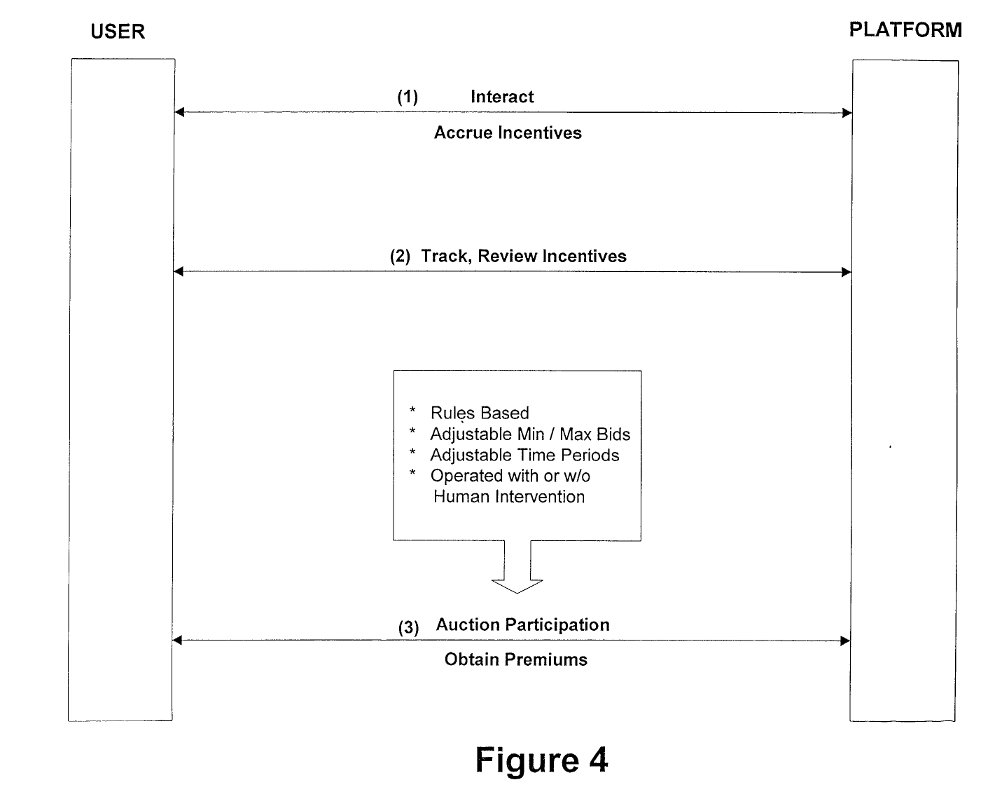

More specifically, flow diagram FIG. 4 shows a process according to an alternative embodiment of the invention where in step 1 a user interacts in any of the ways mentioned above to accrue incentives. The platform awards incentives, allowing tracking and review of the incentives in Step 2. The user participates in an auction in Step 3, which itself may be considered a form of interaction. The user obtains the premiums in an auction environment which can be rules based and adjustable as mentioned above in order to stimulate and modulate activity in the auctions.

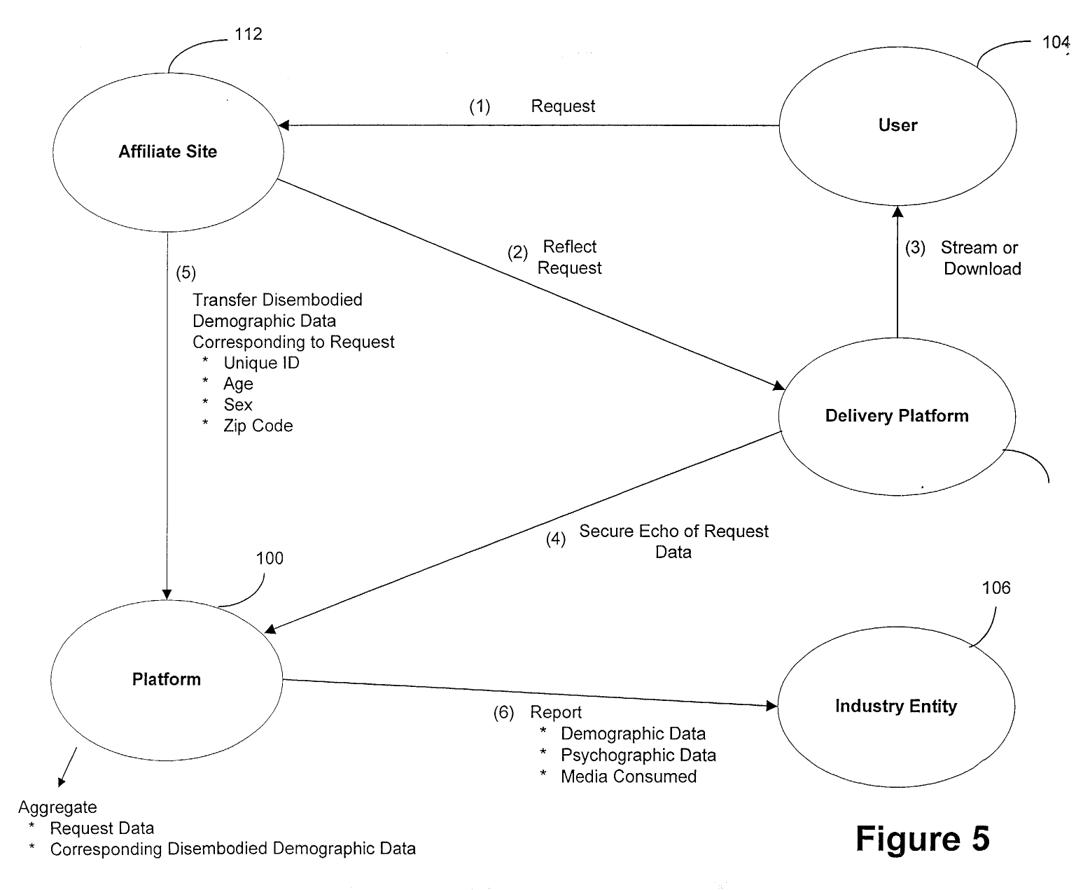

FIG. 5 shows a flow diagram of one process according to the invention in which a user 104 requests streaming of a particular track or other form of content or media. The user in Step 1 issues a request which may flow to an affiliate site or platform 100. That receiving entity reflects the request to a delivery platform in Step 2, according to which the content is streamed in Step 3. The request is captured and echoed in a secure fashion in Step 4 to platform 100 which also receives, if the request was initiated to an affiliate site 112, disembodied demographic information from site 112 in Step 5. Platform 100 correlates the activity code or request with this demographic data which can include unique identification information, age, gender, and zip code. That information can be stored and then processed in order to report in Step 6 demographic, psycho graphic, media consumed or other information to industry entities such as content owners or controllers 106 (such as labels 106), advertisers 108, producers 110, affiliate companies 114, retailers 116, and others.

In this diagram, the data collected by platform 100 can include the following:

a. who: (user ID, gender, age, zip)

b. what: (media info, file/format type, any of the activities mentioned above)

c. when: (time stamp which can include start, stop, length of play);

d. where: (site/partner identification)

e. other: (genre preference, media ratings, skips/deletes, auction results versus what the user did before, lyrics, tours/attendants)

f. client profiles: (what clients want)

g. artist profiles: (what artists want)

Collection methods for the data can include:

a. the third-party platforms, systems or networks 112 echoing from an agent on the third-party site;

b. a manual reporting;

c. sites owned or controlled by the platform operator;

d. partner provided information;

e. direct collection from users' platforms, system, networks or other client-side application;

f. collection from any other platform, system, network or space desired.

Reporting format can include:

a. lyric matches;

b. reports showing artists' perspective, promoter perspective for tour routing, including geographic information about what tracks and artists are hot where.

c. Webcaster report.

d. Compression/decompression reports to show that is being streamed by whom when.

e. Top 10, Top 100 Charts.

f. Psychocomps showing linkage between particular categories of users' response to certain artists or tracks compared to their response to other artists and/or tracks.

g. Individual artists reports from auction responses or purchase of merchandise.

According to another alternate embodiment of the invention, artists may be incentivized to participate in the activities of platform 100 by virtue of receiving certain royalties. Such royalties can be calculated, among other ways, as follows:

a. Operator of platform 100 allocates a certain percentage of all dues from subscribers to an Artist Royalty Pool (ARP).

b. Allocations into the ARP are calculated on a periodic base such as monthly as the operator recognizes revenue from its subscriptions.

c. The total value of the ARP is calculated periodically such as at midnight on the last day of the end of each calendar quarter and is equal to the allocated sum of recognized subscription revenue for that quarter. For example, if during the quarter there are 200,000 paying subscribers for the quarter and each subscriber pays $20.00 for the year, the ARP at the end of the quarter would be calculated as $200,000 *1.66*0.3 months*0.51=$507,960.

d. Each artists' payout is a function of variables such as the following tracked during each calendar quarter:

1. total full-length tracks uniquely downloaded by the total paid subscriber base (TD).

2. total number of each artist's full length tracks uniquely downloaded by paid subscribers (TA).

3. total value of ARP (ARP).

4. Payments are calculated for the quarter as follows:

a. artists' payment equals TA*ARP/TD. For example, if total downloads for the quarter equal 2,000,000 and total artist downloads equal 4,000 in the above-referenced example, the artist payment would be $1,014.

e. The number of artists may be limited to sustain a prospect of being paid a reasonable amount in royalties. For example, if 1,500 artists were allowed to participate and there were completely uniform distribution of downloads, the average artists' payment would amount to $338 for the quarter.

f. Costs may be specified in addition such as manufacturing costs and distribution costs per custom compilation album. Platform 100 can also support other services for artists including development of sites for artists which may be supported by Platform 100. Sites can allow artists to administer content on their site, review download and referral histories, choose electronic fan club options, obtain career development counseling from industry professionals, participate in preferred pricing on various services such as studio time, CD duplication, touring support services and other services. Artists can also obtain feedback on key metrics such as radio airplay statistics, number of CDs sold, number of downloads, streams, and impressions and other information reflecting performance. These services may be provided for a fee which may be adjusted based on factors such as artists' participation and contribution and content supported by Platform 100.

Platforms 100 can support interfaces such as in a window or frame on third-party sites such as artists' sites, label sites, Internet service provider sites, portals or other opportune spaces on any media. Alternatively, the interface on such third party space can be supported by functionality corresponding in part or in whole to that found on platform 100, but which is instead located at the third party location; such functionality can linked to platform 100 if desired for coordinated tracking and reporting. Such support, shown in functional fashion in FIGS. 2 and 3 as support of affiliate presentation/interaction, can, among other things, provide affinity value and other value added to such third-party sites. The availability of such an interface can attract users to concentrate activity on the third-party site and motivate longer visits, more intense activity, and more commercial or electronic commerce activity. Such activities can include any of the activities listed above.

As shown in FIG. 5, according to an alternate embodiment of the invention, activities can be tracked and points awarded based on activity on the third-party site interface supported by platform 100. It is preferable that control of points remain in the organization supporting platform 100 in order to ensure that users who access activities supporting point awards via a particular affiliate 112 do not gain a special advantage vis-à-vis users who access platform 100 directly or other affiliates who support interfaces to platform 100.

Third-party affiliates 112 are incentivized to support interfaces linked to or corresponding to platform 100 in view of at least the following incentives and advantages:

1. They obtain data about traffic on their site and an increased understanding of their on-line customers through reports about activity and demographics;

2. Stickiness;

3. Improved on-line product offerings;

4. Increased electronic commerce transactions;

5. Stimulation of user-generated content such as reviews and survey completion;

6. Motivation referrals;

7. Grow and activate fan bases for media products and artists;

8. Reinforcement of preferences for artists based on interacting with content relating to the artist or product;

9. Group based promotions in which users can earn points dedicated to an organization, which then empowers one individual to bid on behalf of the organization.

Users have the opportunity to participate at various levels according to various embodiments of the invention. As one specific and nonlimiting example, they can join as members by paying a subscription fee or by conducting certain activities such as signing up for an affiliate company 114 credit card and having their membership sponsored by that affiliate company 114. Users 104 who are members can have access to a wider array of interactive opportunities and can be assigned a greater number of points or other incentives for participating in certain activities than users who are not members. There can be various levels of membership, which can affect among other things, access to certain functionality and/or interactive activity, and value of points awarded for certain activity.

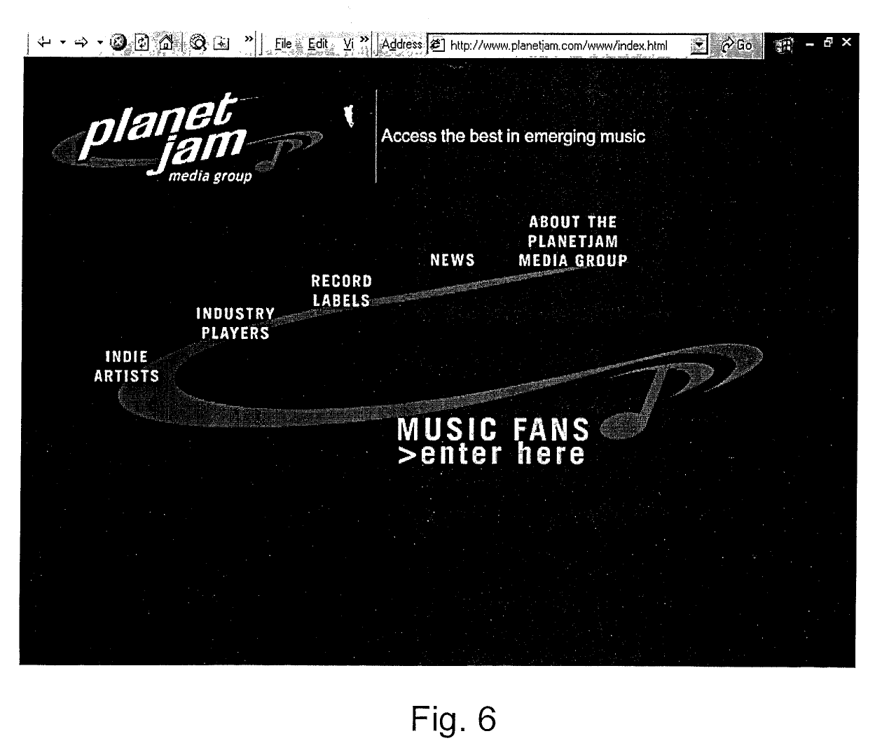

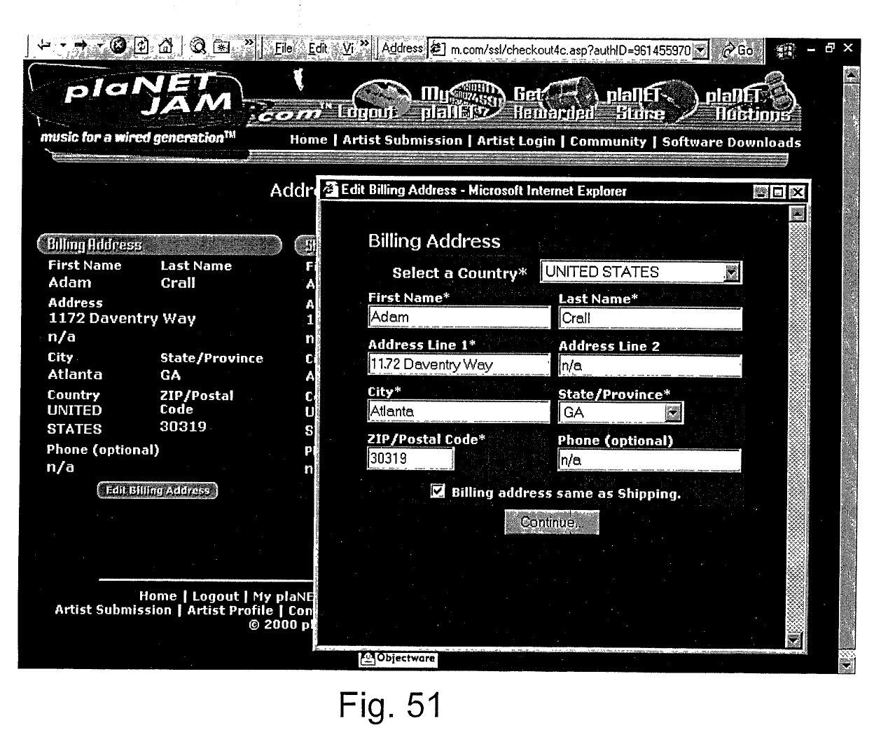

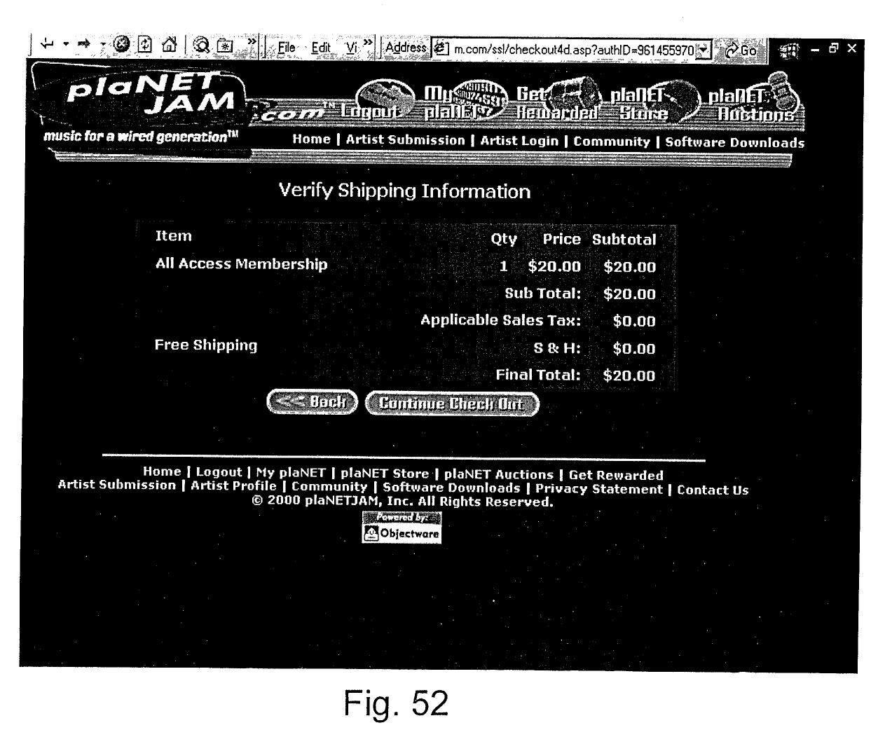

FIGS. 6-53 are a series of screen shots showing interfaces which may occur on presentation interaction functionality 124 as shown in FIG. 2; the following text applies to that embodiment of the invention.

FIG. 6 is a screen shot which shows an entry interface to content supported by platform 100. The user may click on information about independent artists, industry players, record labels, news or information about the organization which operates the platform 100. The user may click “music fans” to enter the site.

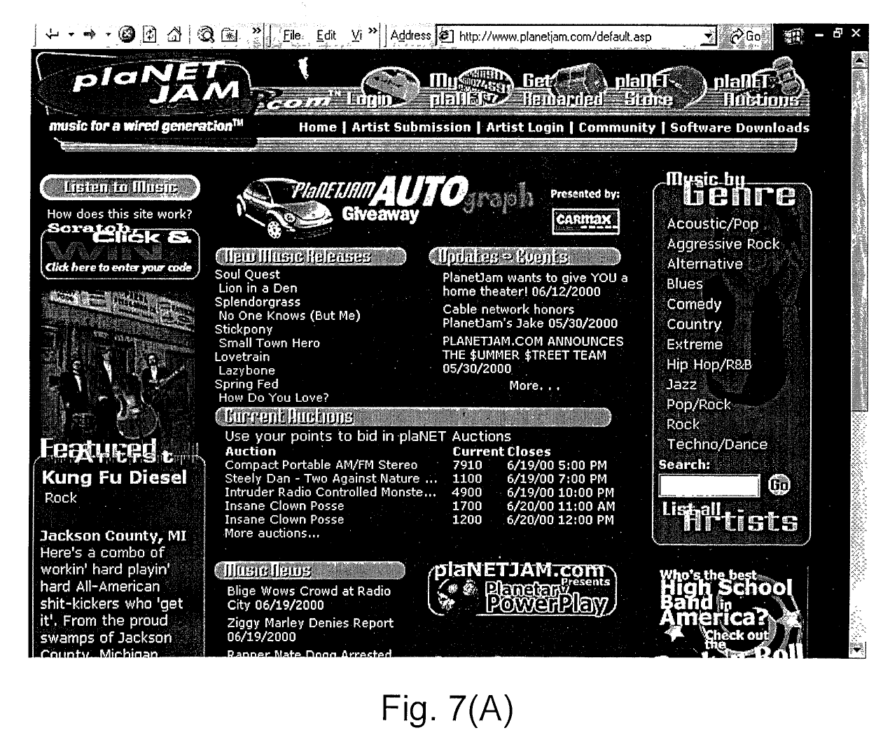

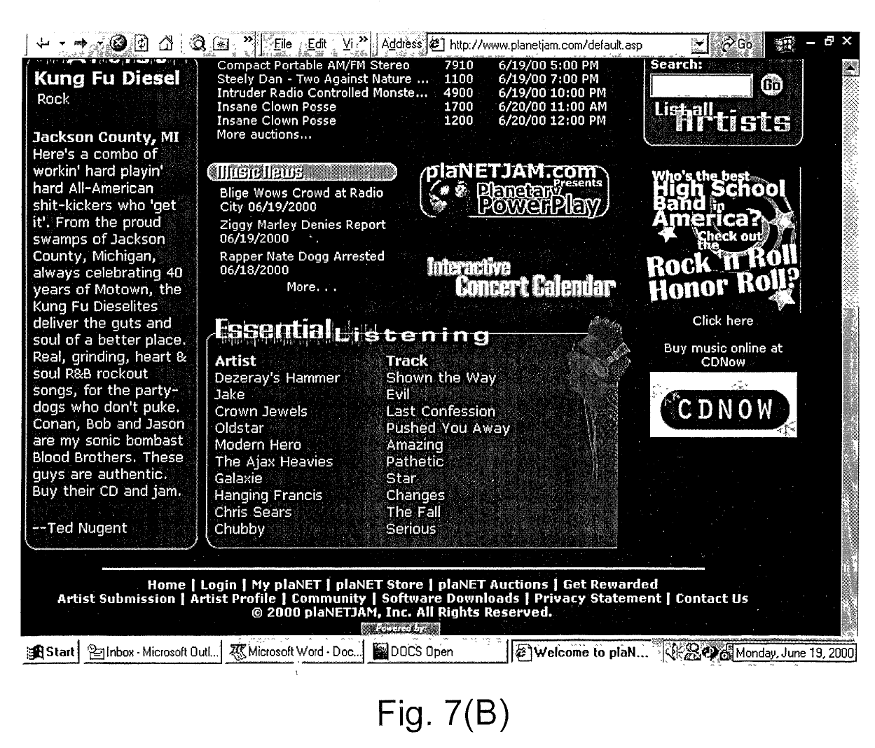

The main navigational screen face for non-member users is shown in FIGS. 7A and 7B. Users are presented a number of options including searching the site, clicking on new releases, updates or events, participating in current auctions, clicking and selecting music news, participating in a scratch and win contest, selecting information about the featured artist, selecting music news, listening to featured tracks, and linking to third-party sites such as CD suppliers. Any number of contests, other activities, and links may be provided as desired.

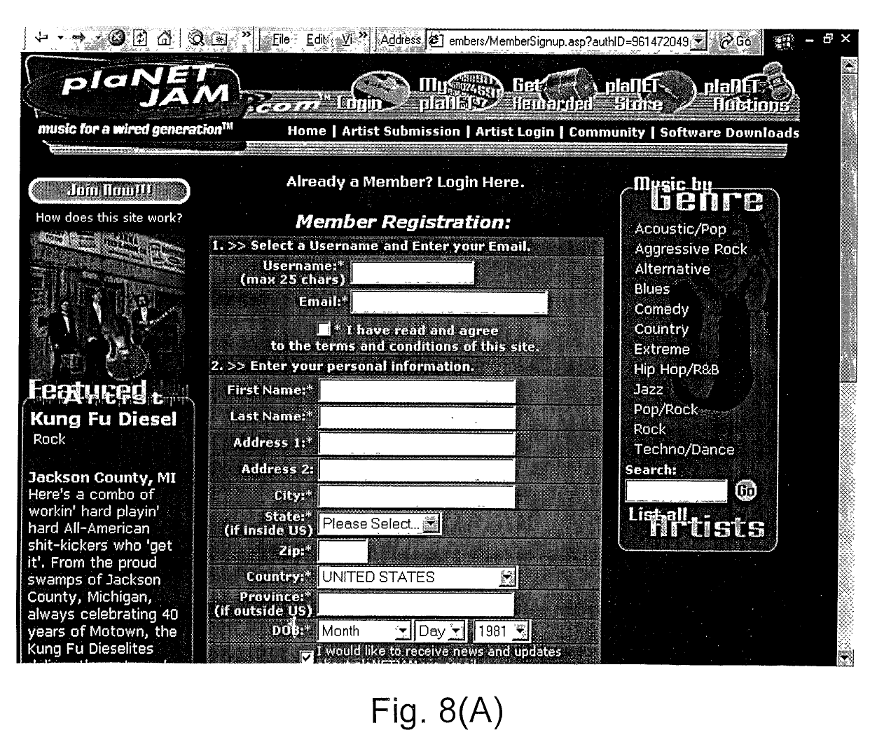

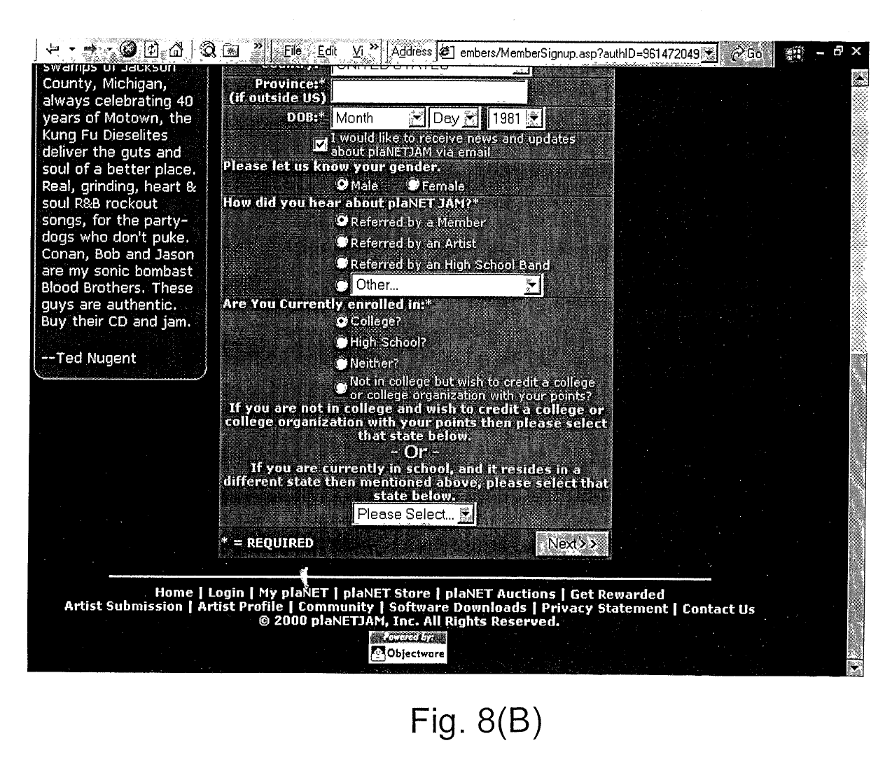

FIGS. 8A and 8B show a member registration interface which can be supported in html or otherwise. The user is asked for username and e-mail address information as well as a clickwrap set of provisions to which the user must agree. Name, city, state, zip, country, birthday, gender, referral source, and educational status information are solicited.

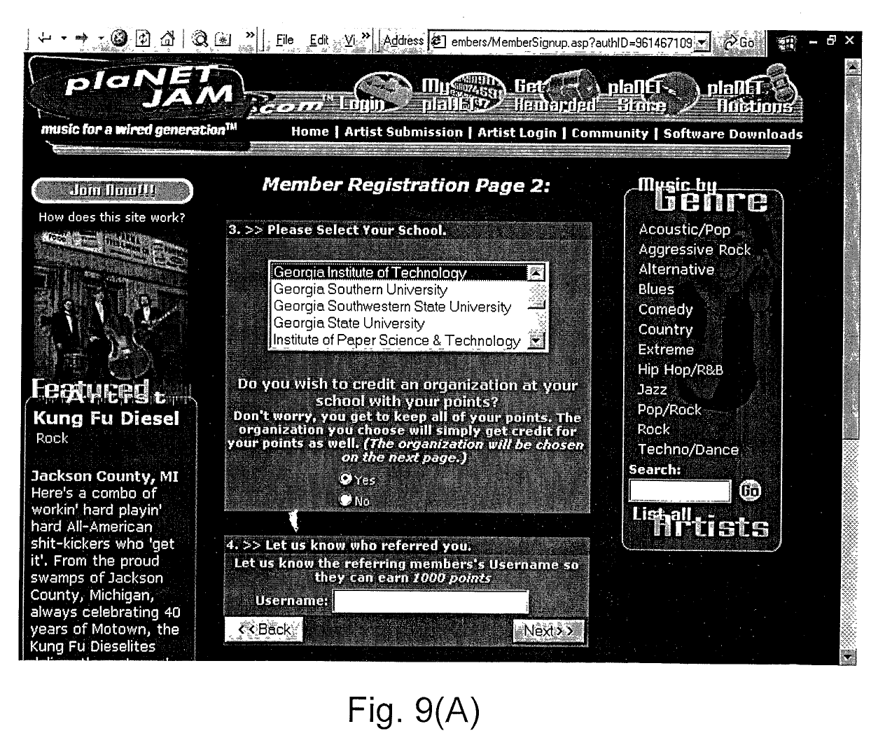

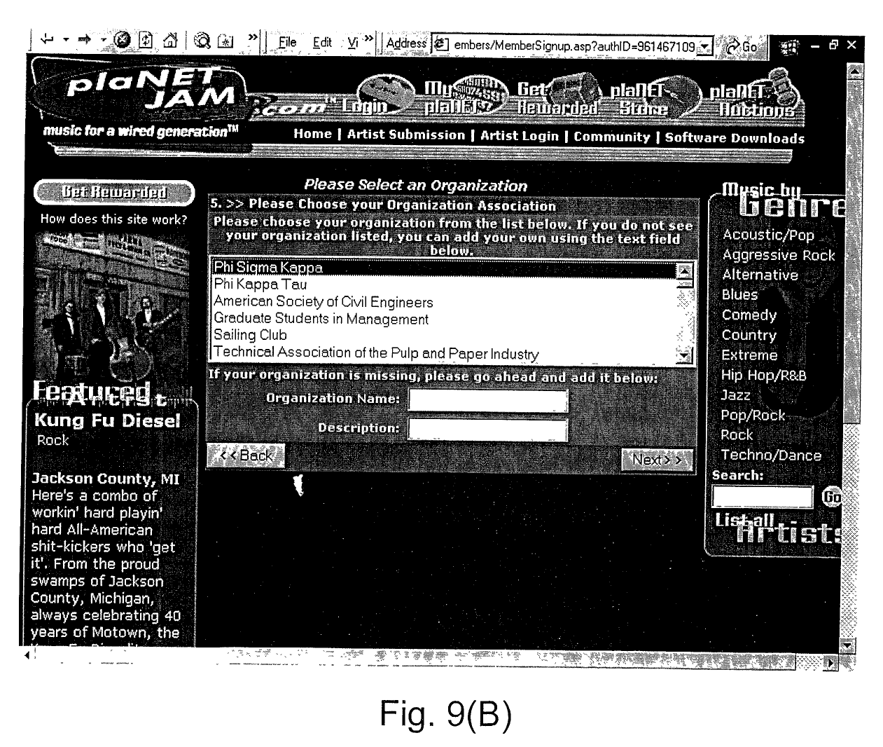

FIGS. 9A and 9B allow the user to specify his/her educational institution and to allow that institution to accrue points.

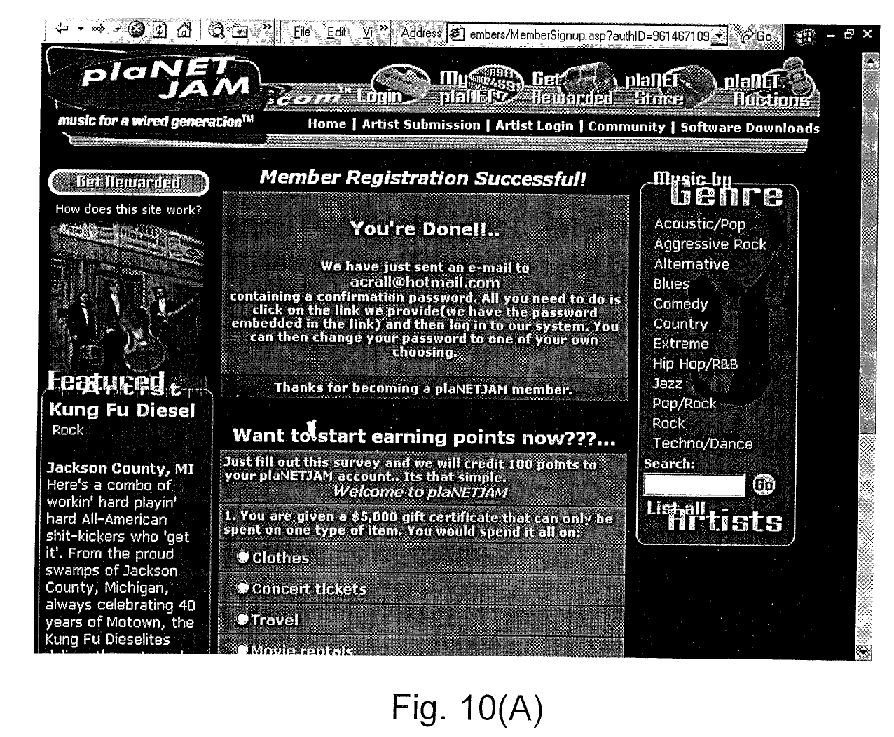

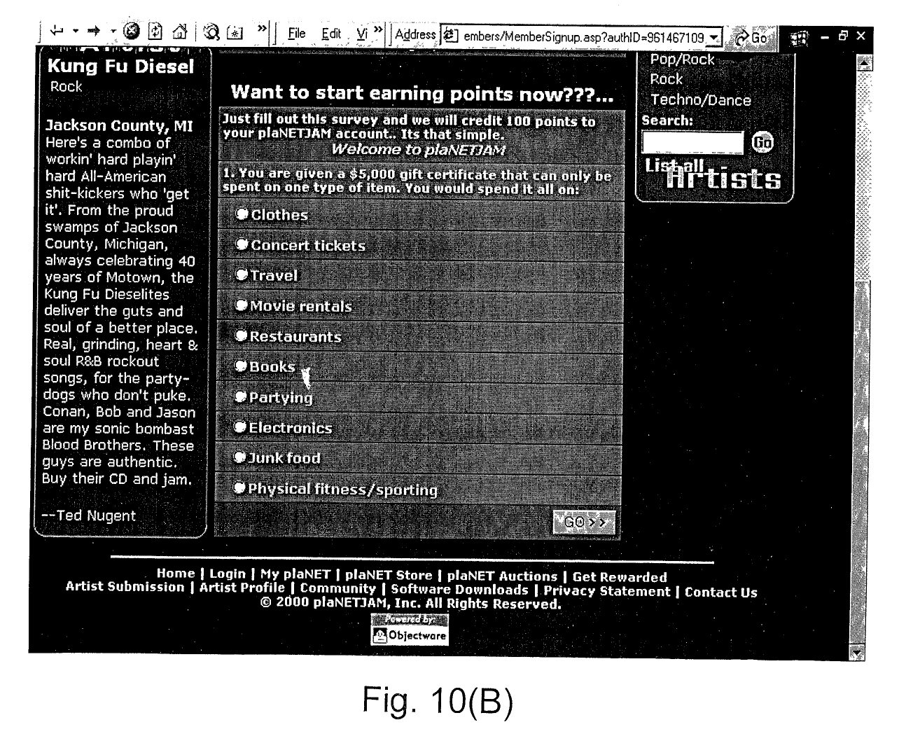

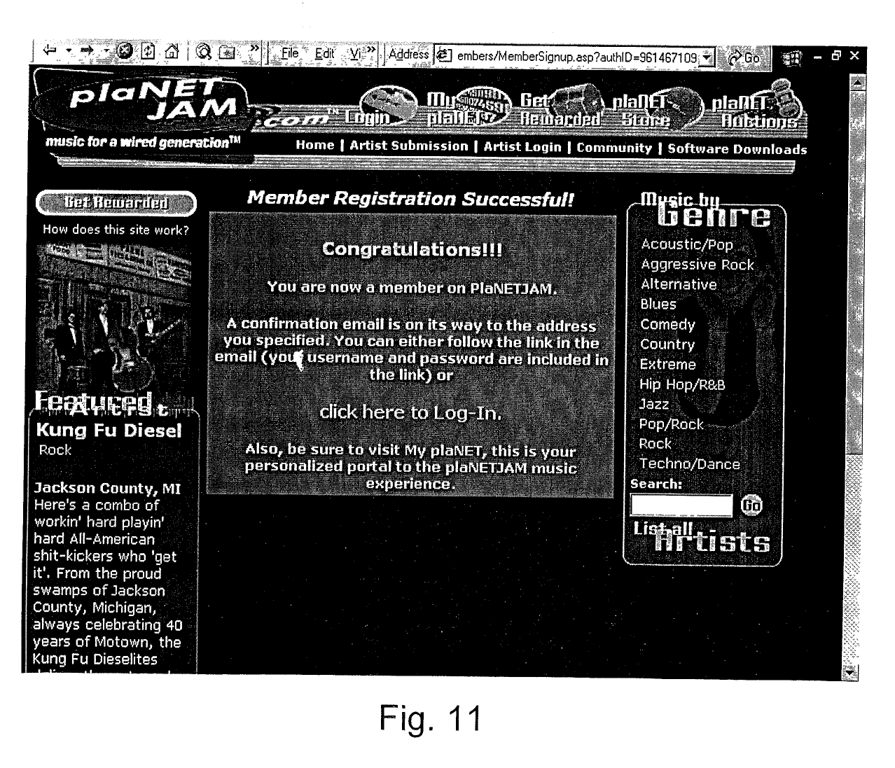

FIGS. 10A and 10B are a success screen face for the registration process which allows the user to begin earning points by completing a survey. FIG. 11 confirms the registration and survey.

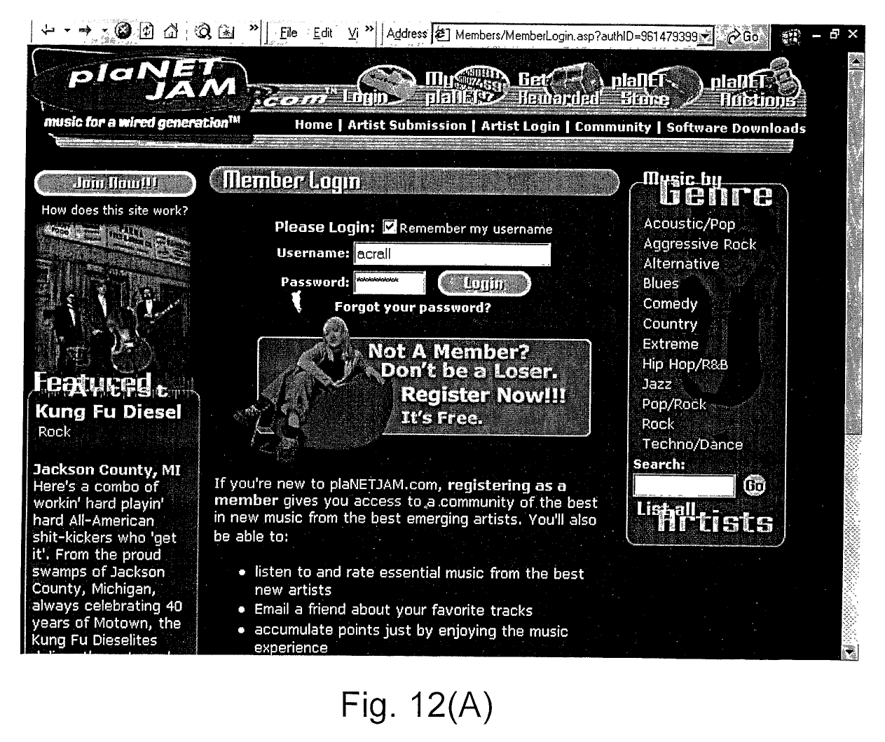

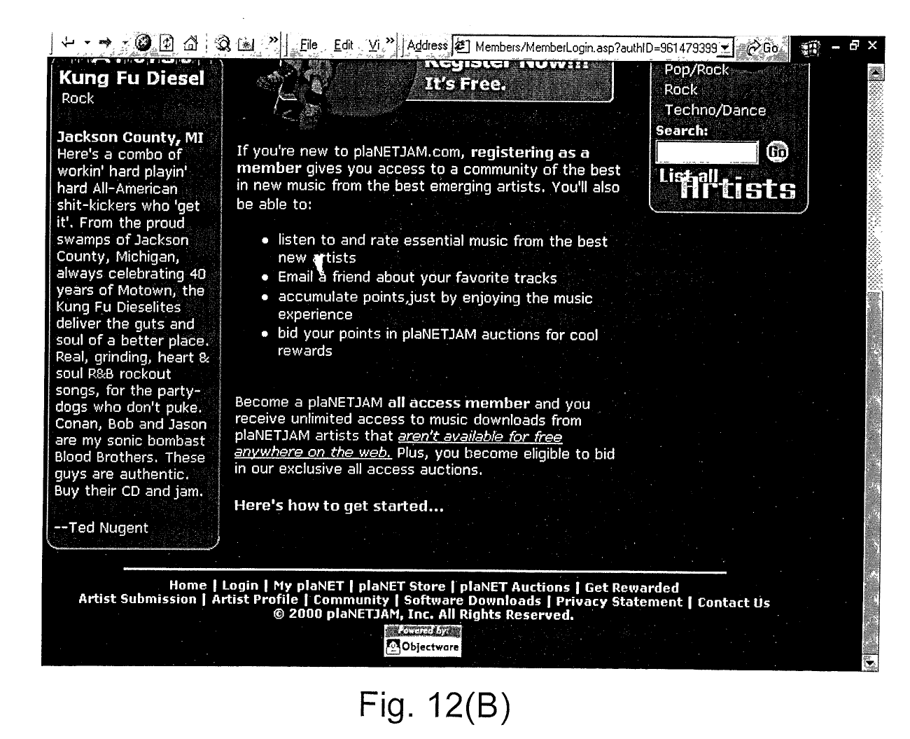

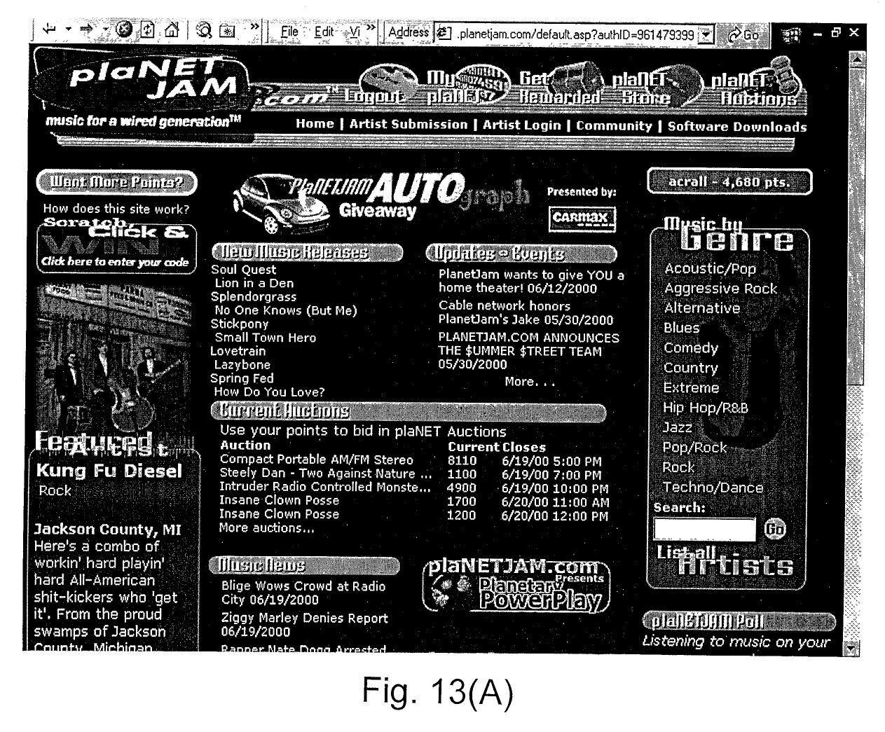

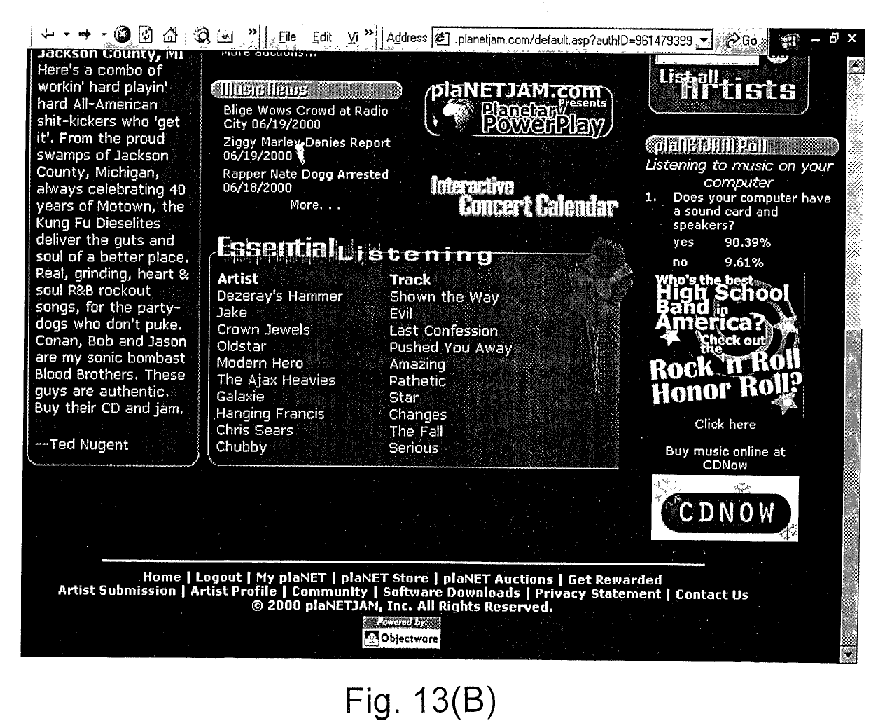

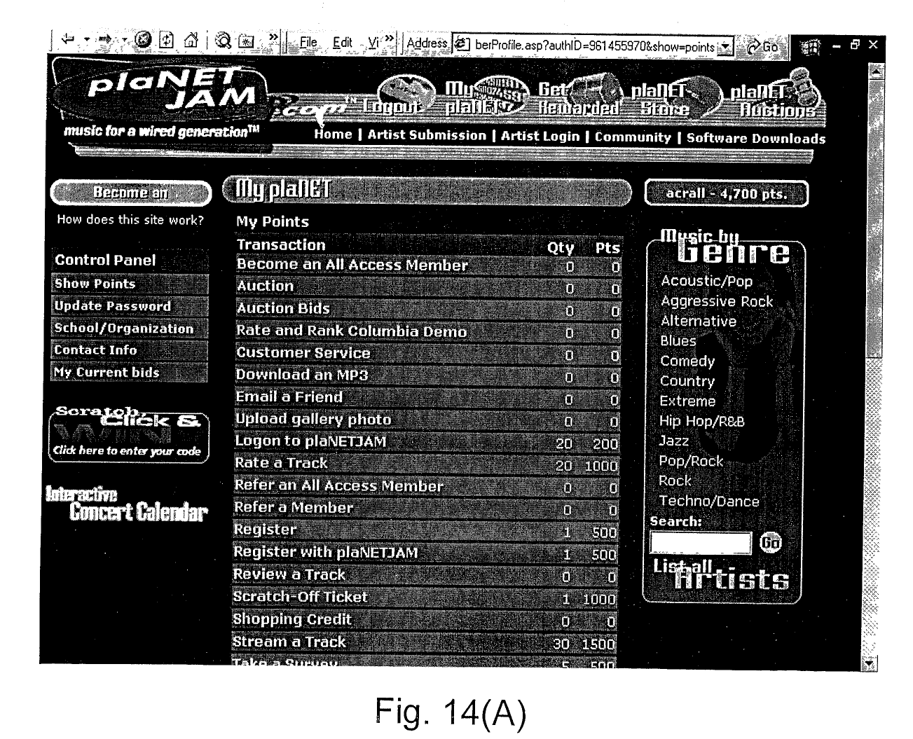

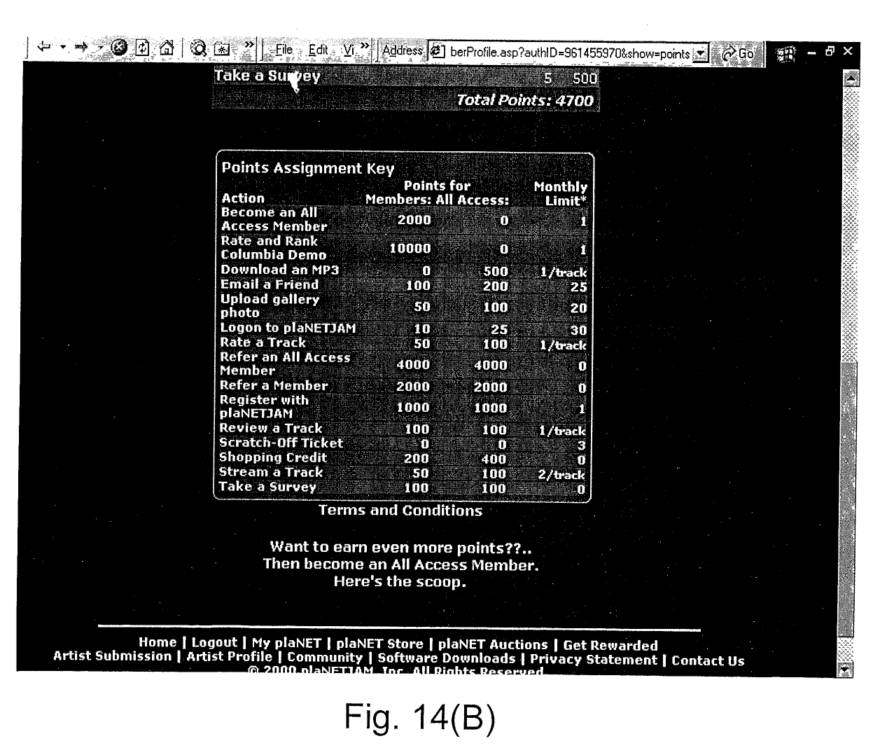

FIGS. 12A and 12B are a member login screen face which lists a number of perquisites or activities available to members. The user presents user name and password and clicks the login button to enter. She sees the interface shown in FIGS. 13A and 13B and that she already has 4,680 points simply for registering and completing the survey mentioned above. This screen face presents opportunities for interaction and activities which may be the same as or similar to activities mentioned in connection with FIGS. 7A and 7B above. The user can check her points as shown in FIGS. 14A and 14B. FIG. 14B also shows how points are awarded for various activities.

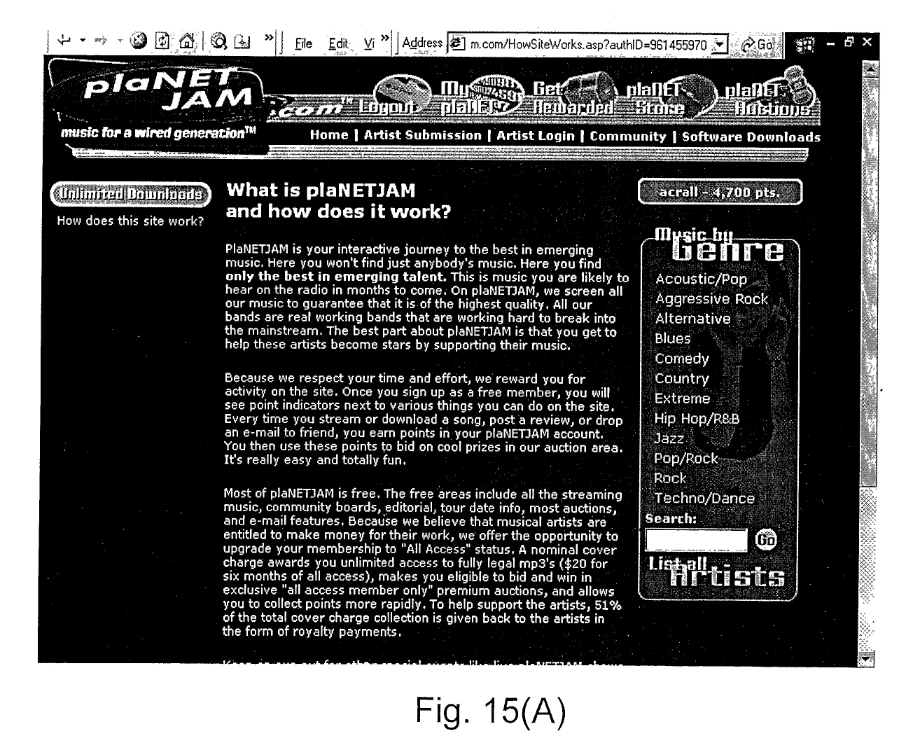

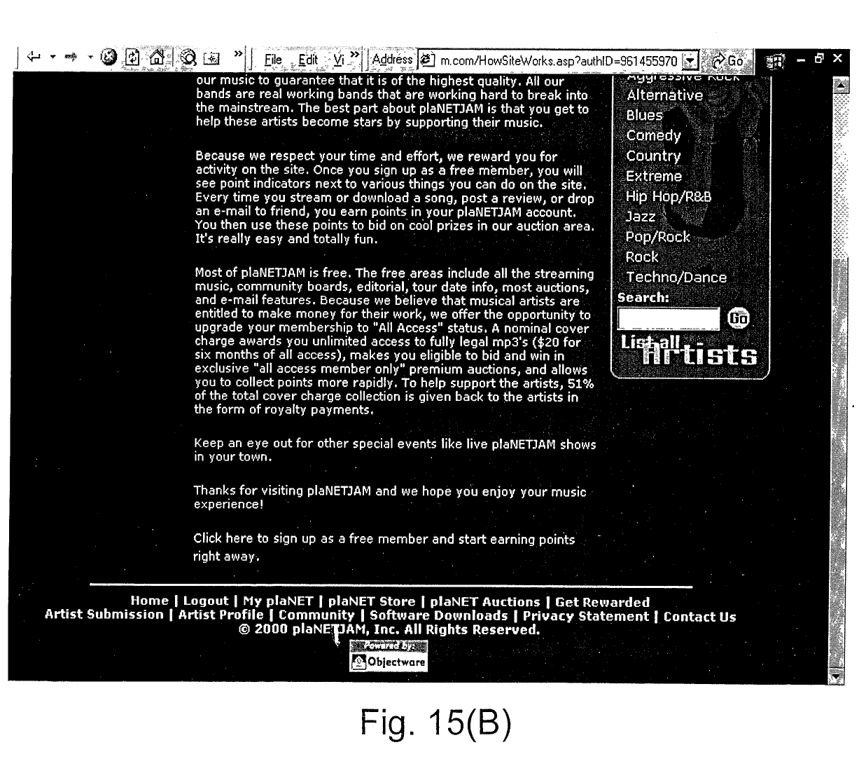

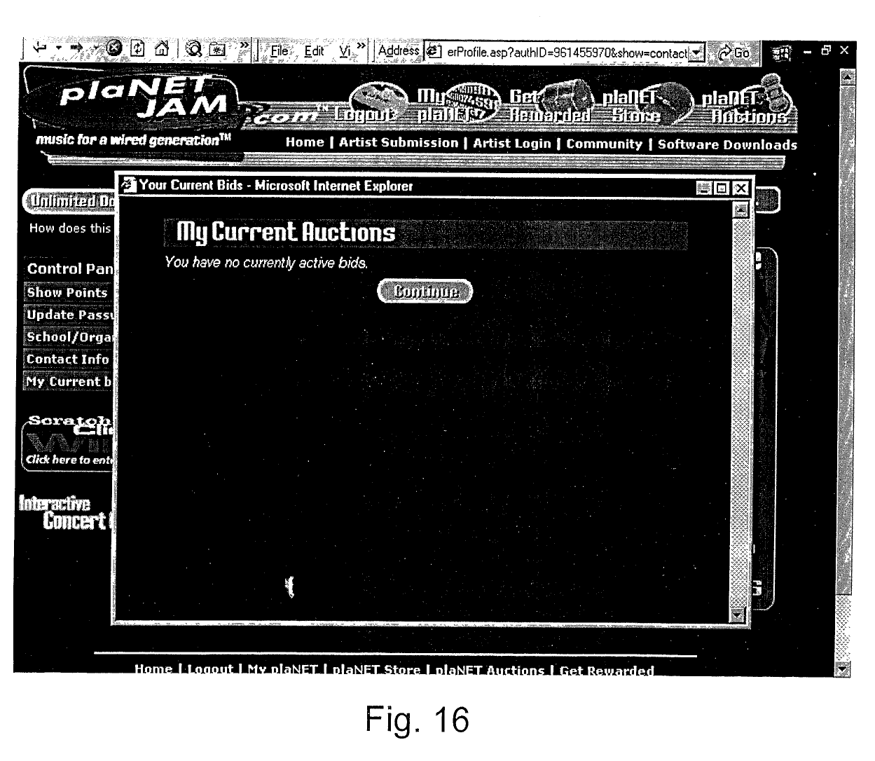

FIGS. 15A and 15B present certain rules for participating. FIG. 16 shows an interface which allows the user to check current auctions in which they are participating.

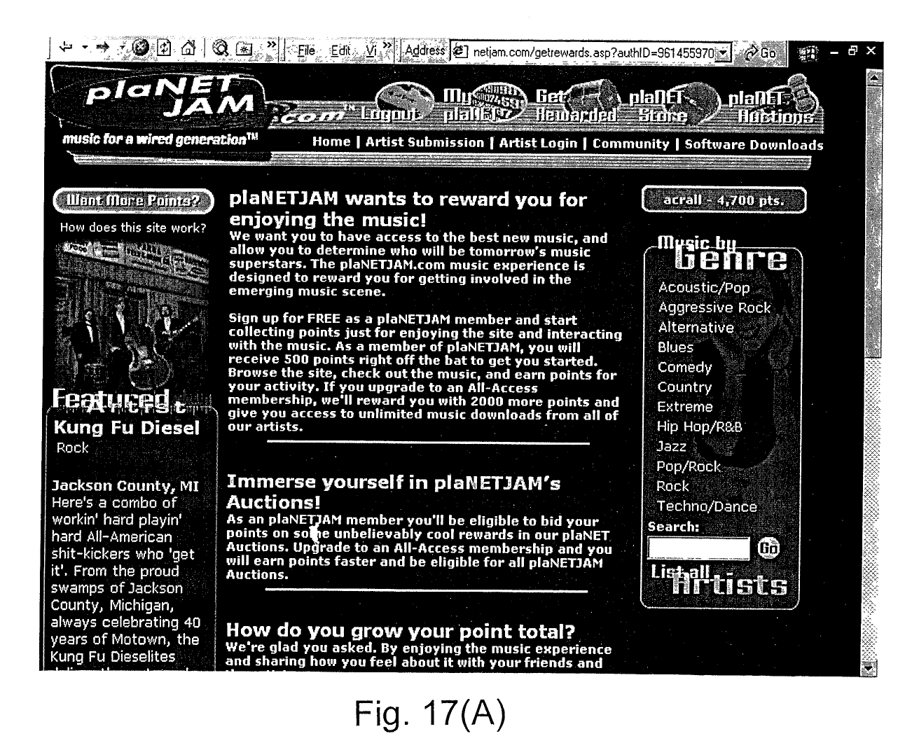

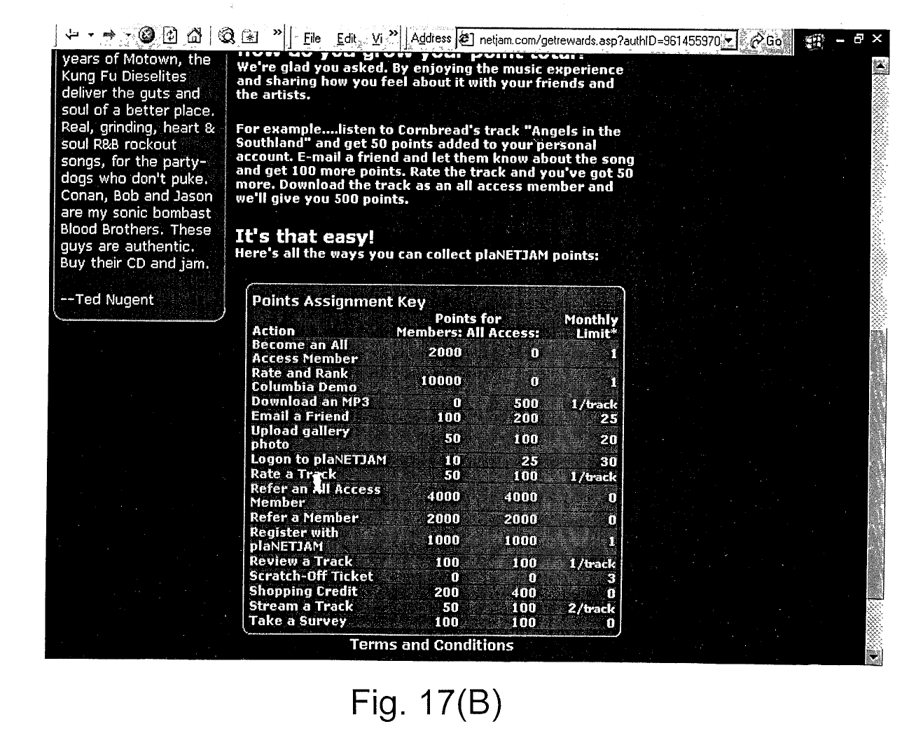

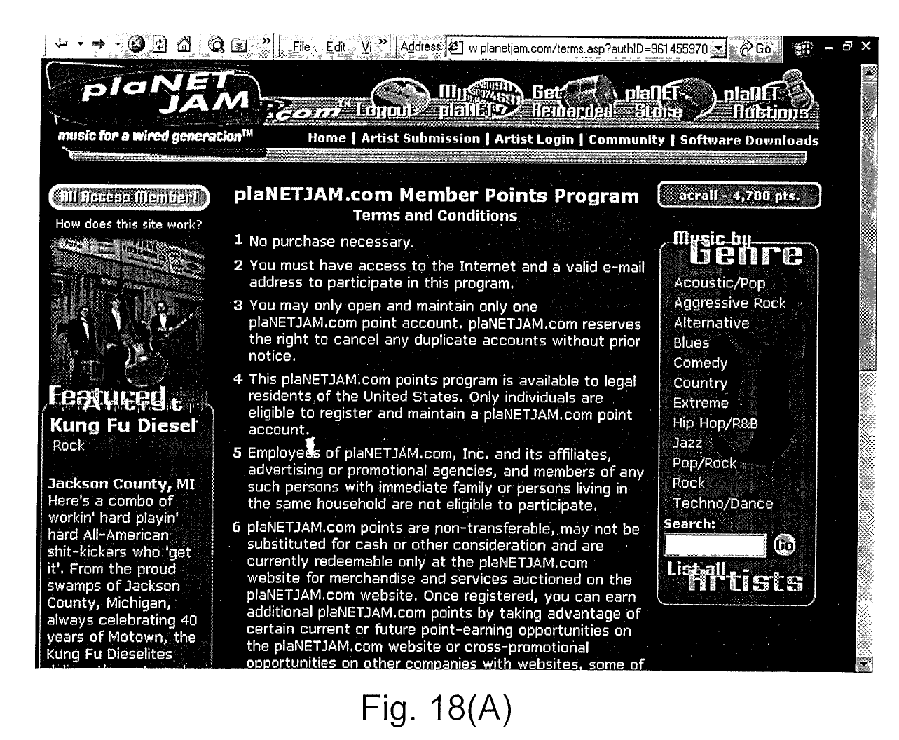

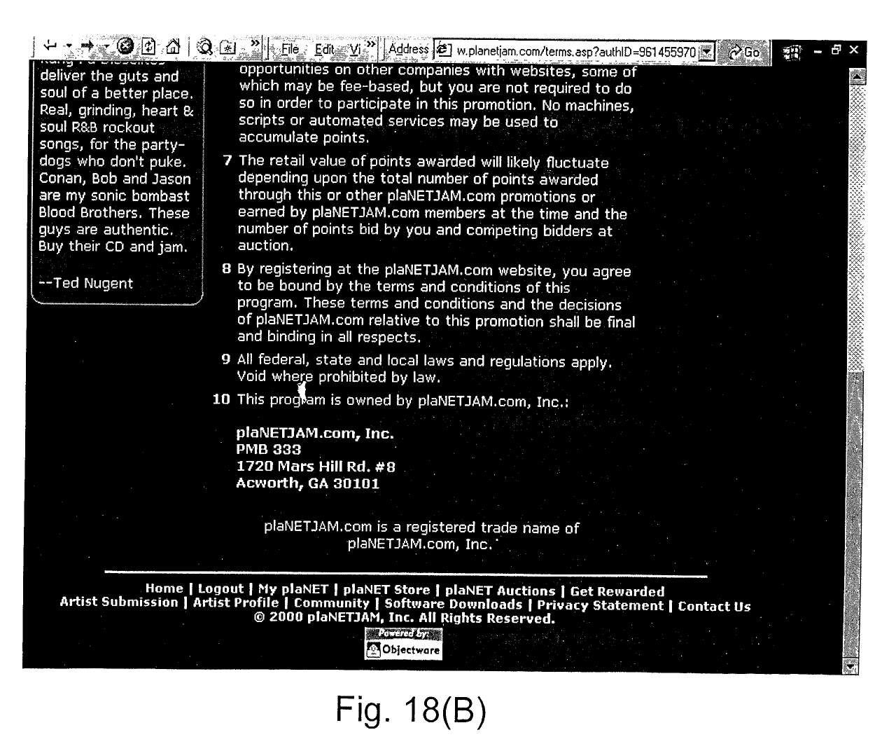

FIGS. 17A and 17B show an interface which outlines point award rules. FIGS. 18A and 18B show an interface which outlines participation in interacting, obtaining points and participating in auctions. These pages show terms and conditions to which the user agrees in order to interact and participate.

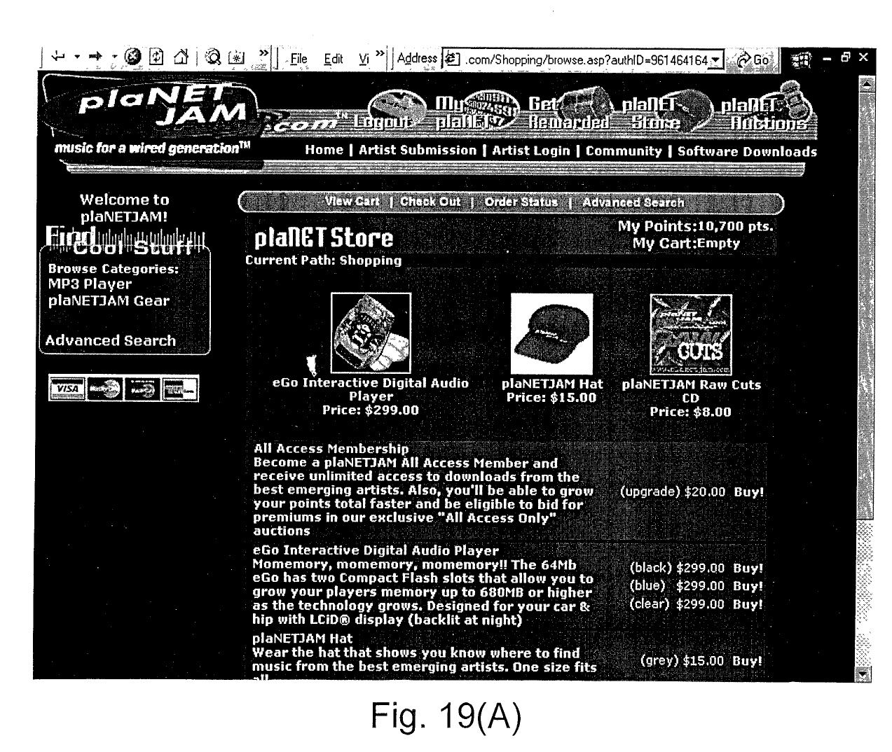

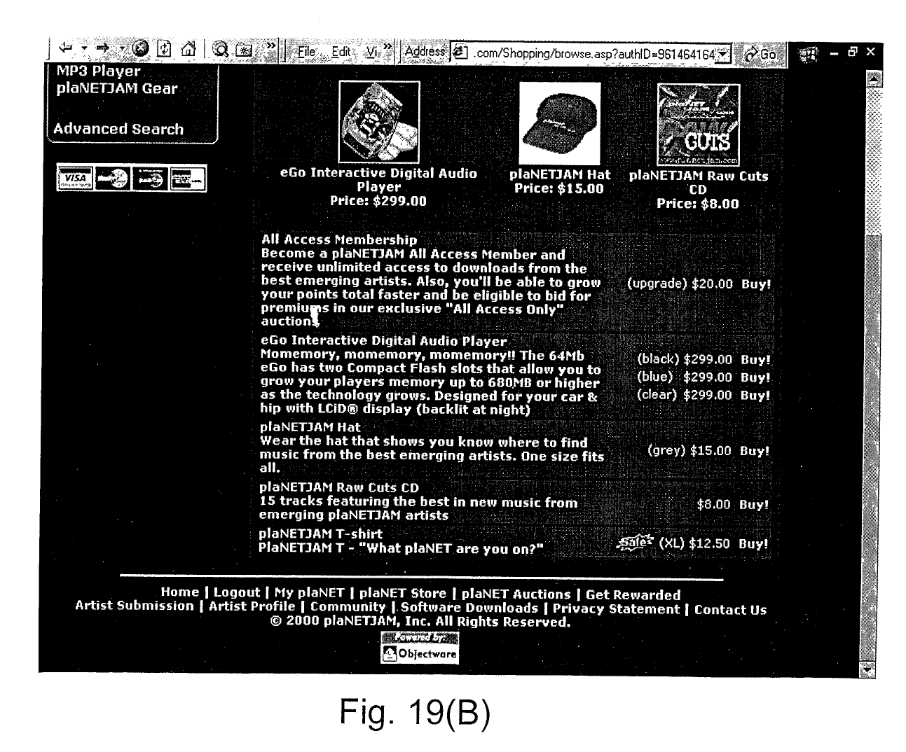

FIGS. 19A and 19B show items which may be purchased on platform 100 such as audio players, apparel, CDs, and other items.

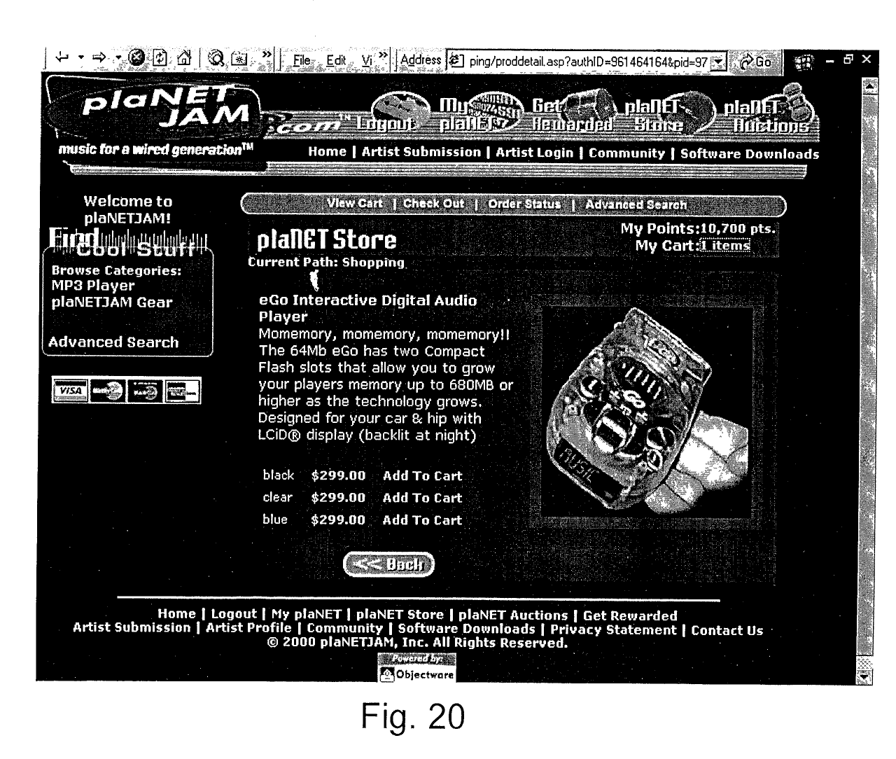

FIG. 20 shows an interface after a user has drilled down from FIG. 19 to obtain information about a digital audio player.

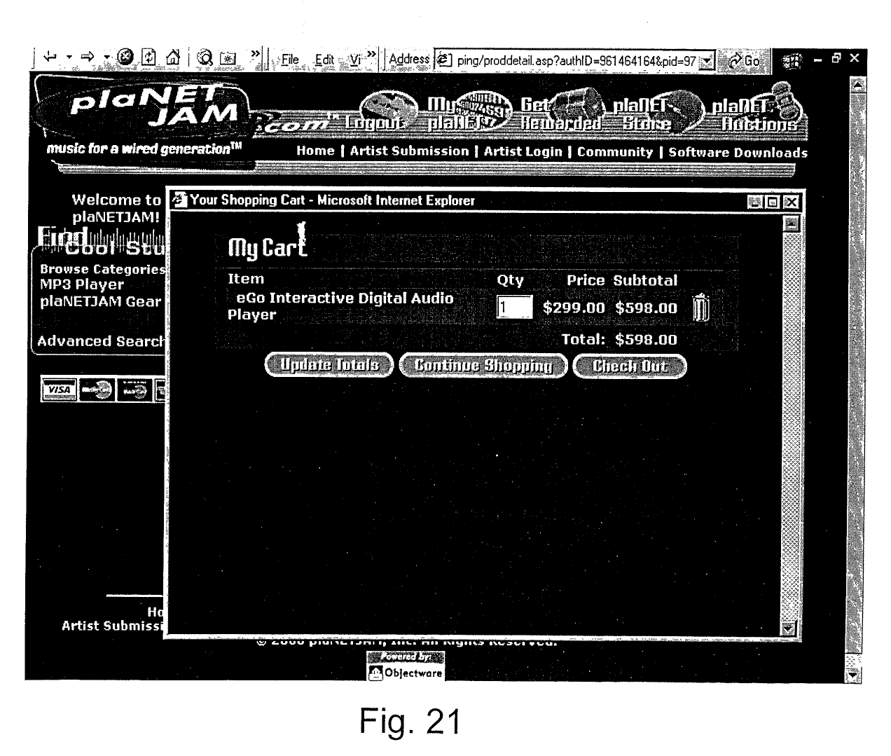

FIG. 21 shows a screen face for ordering the digital audio player shown in FIG. 20.

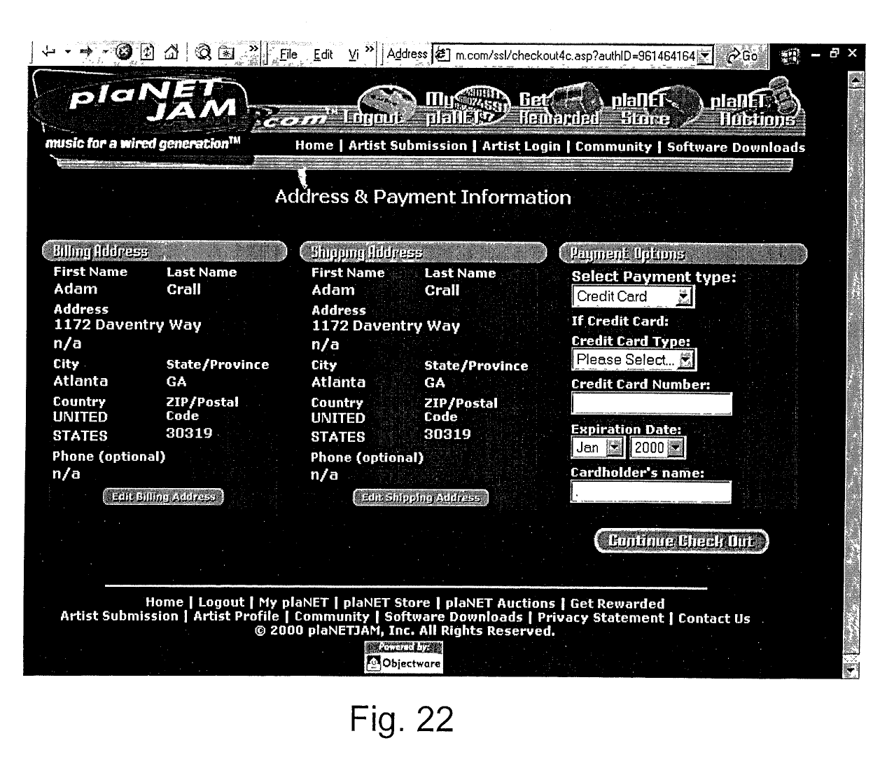

FIG. 22 shows a screen face that reflects address and payment information entered by the user.

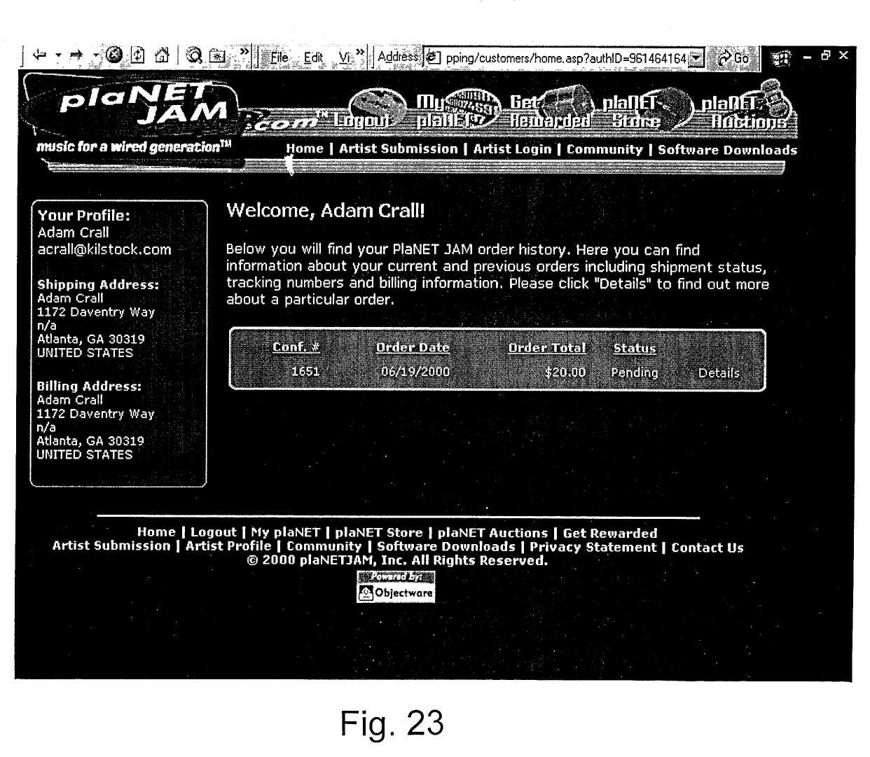

FIG. 23 shows an order history for previous orders of product on the site.

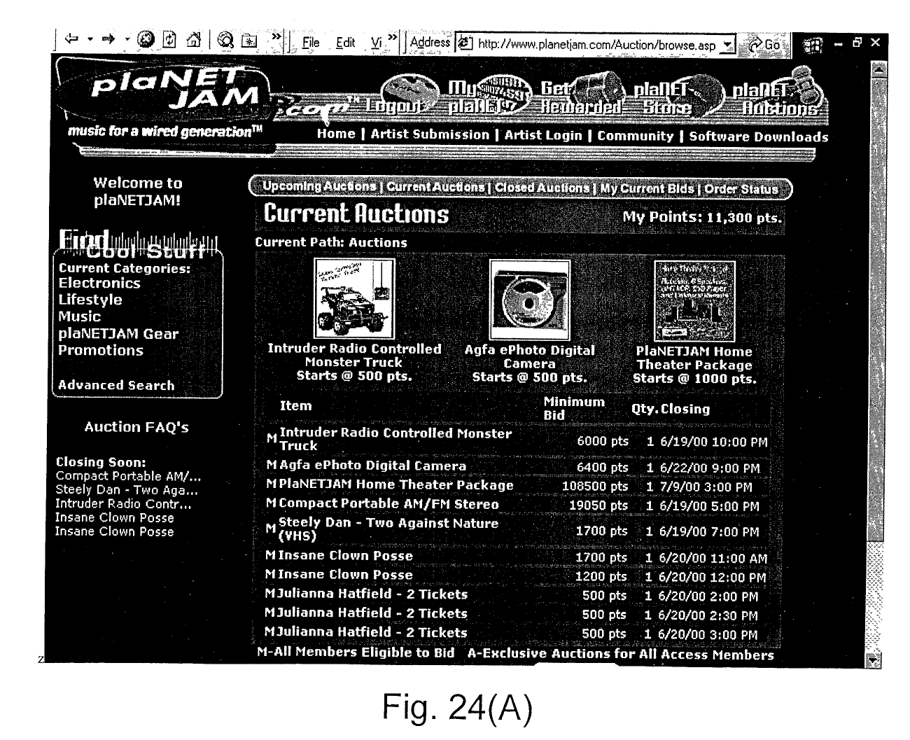

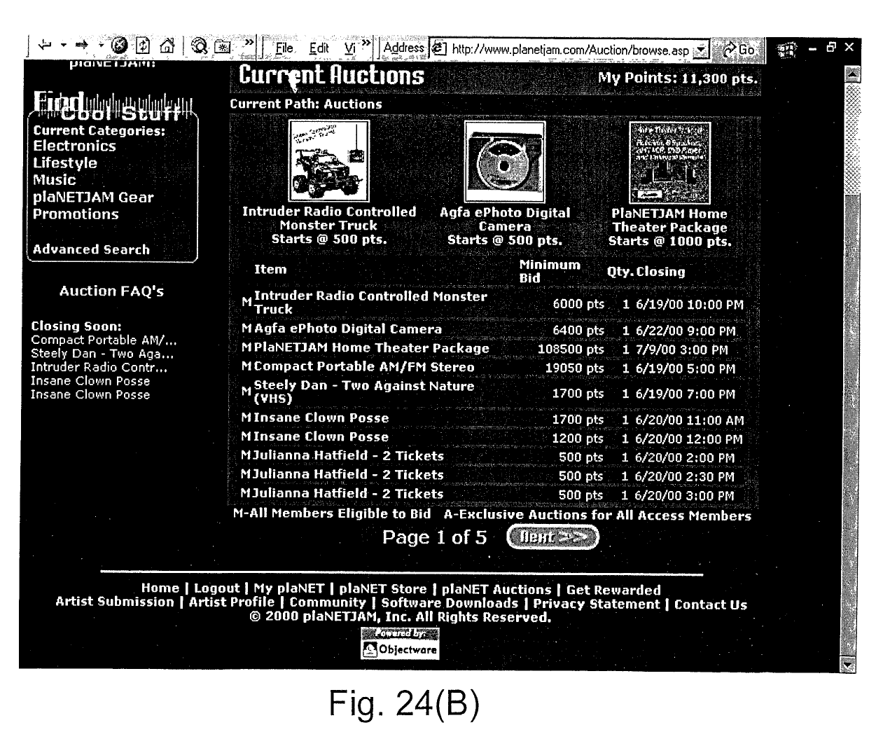

FIGS. 24A and 24B show auctions which are currently underway. The user may access this screen face from the main navigational screen face mentioned above.

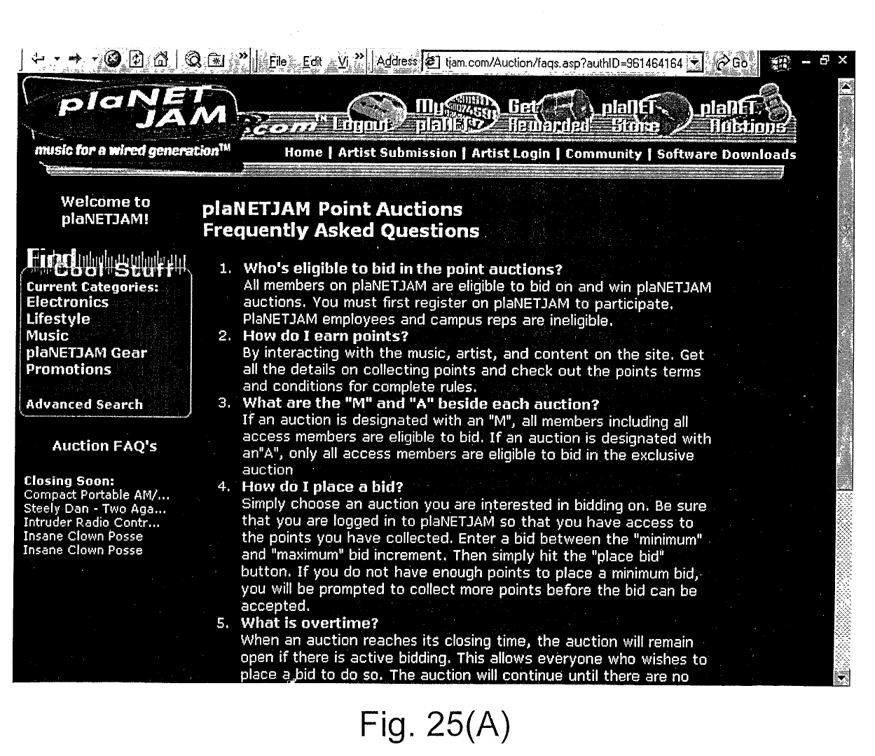

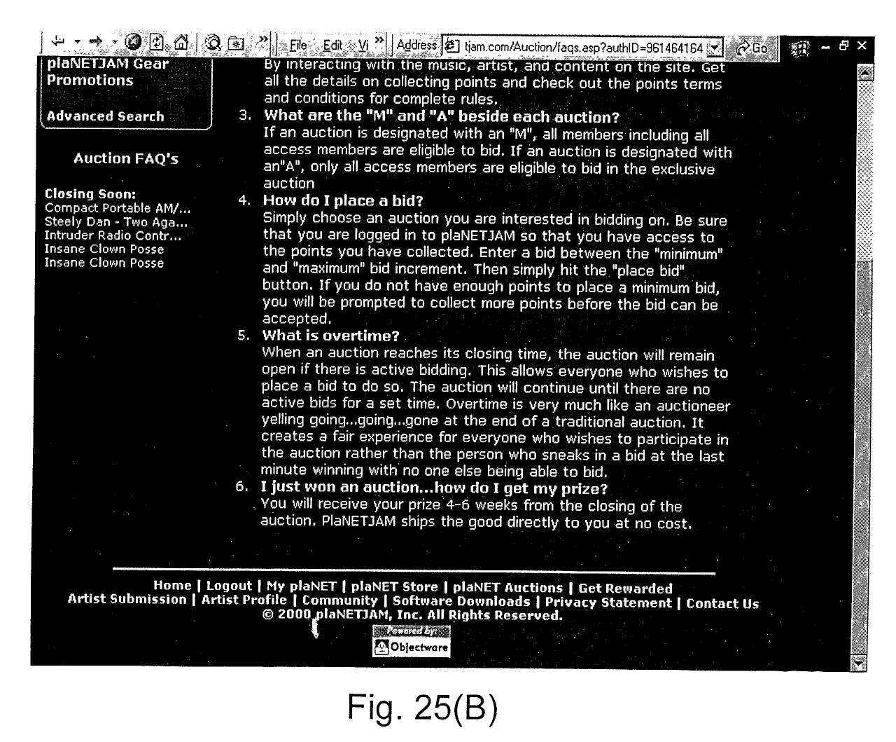

FIGS. 25A and 25B show frequently asked questions relating to auctions. Auctions are, in this embodiment, arranged for participation by multiple levels of members.

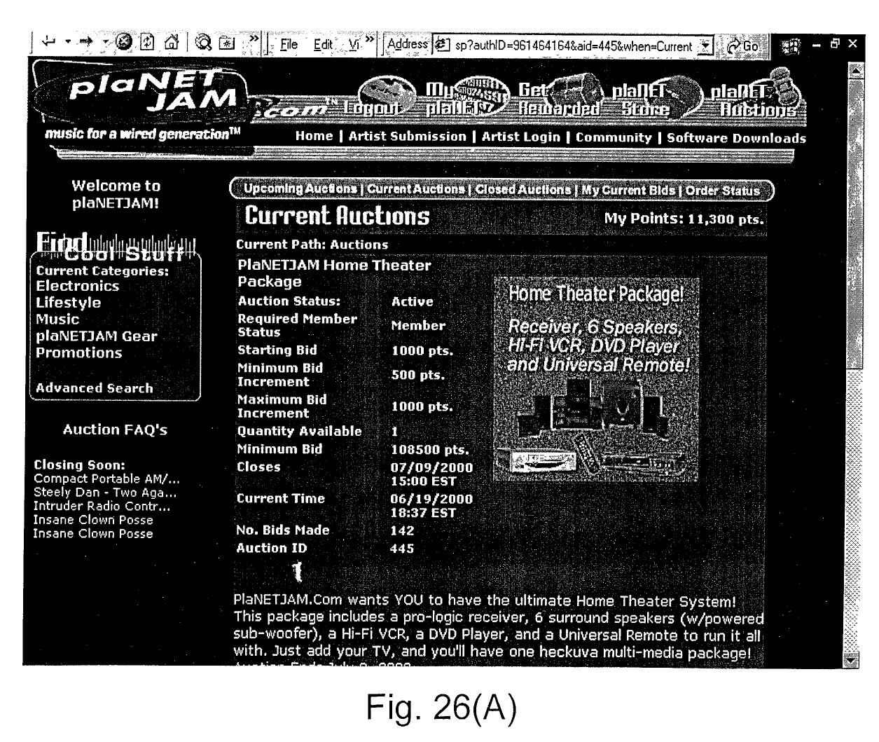

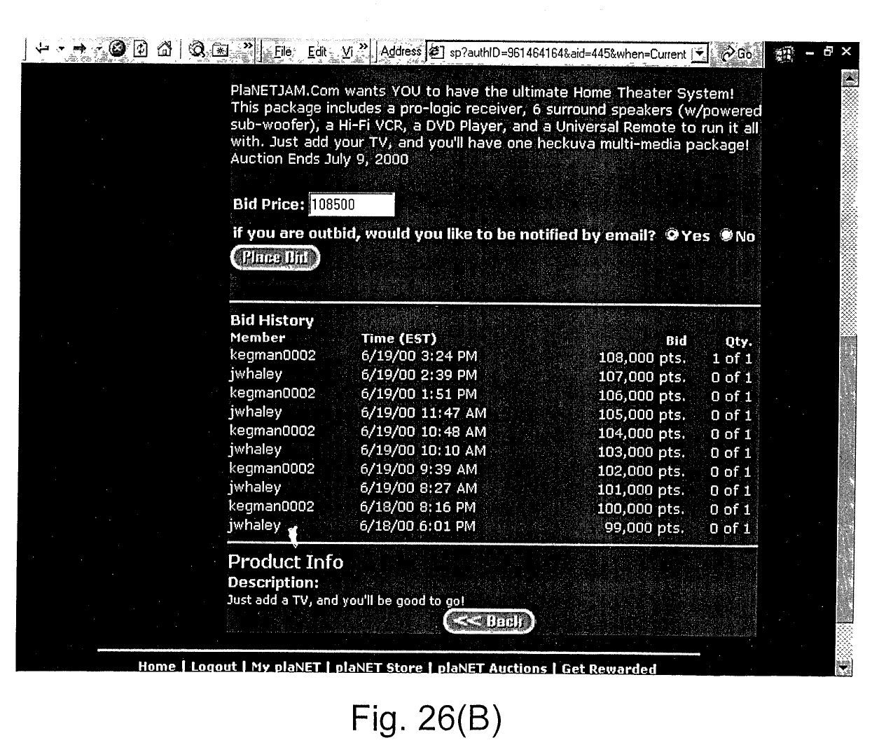

FIGS. 26A and 26B are a screen shot which shows current auctions underway and presents the opportunity to place a bid. They also show bid history in the auction, together with the starting bid amount, minimum and maximum bid increments and the current minimum bid available. The closing time and date are also shown.

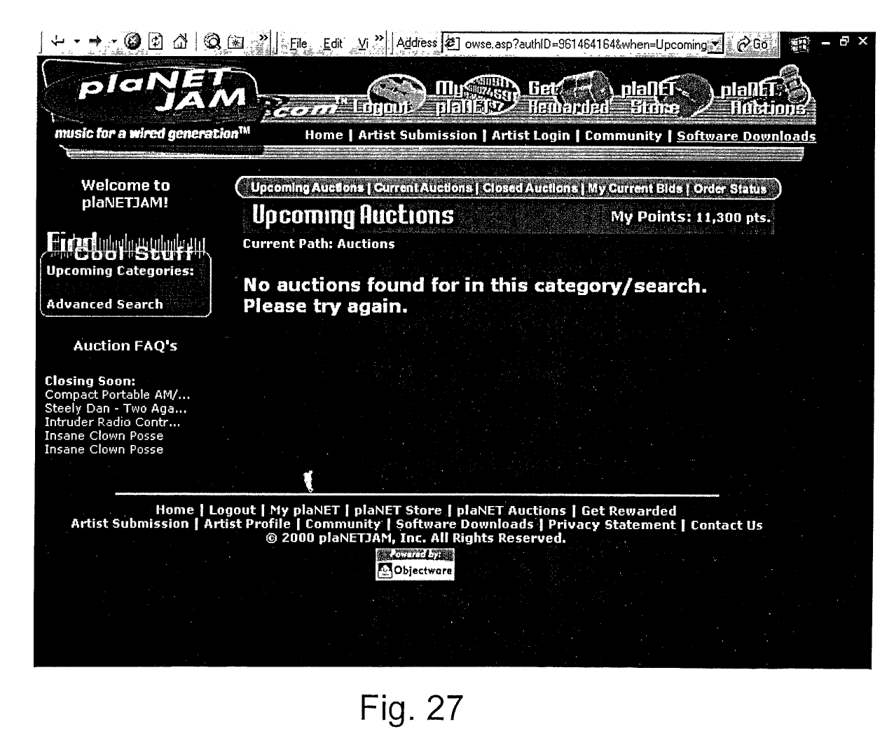

FIG. 27 is a screen shot which shows upcoming auctions.

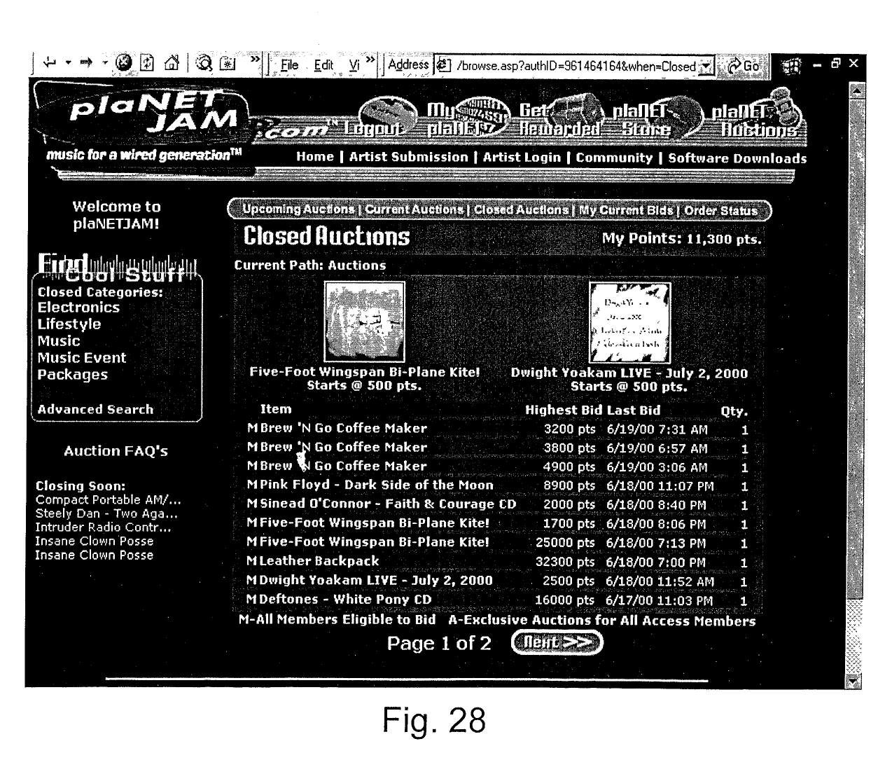

FIG. 28 is a screen shot which shows closed auctions. In this particular auction, bidding value for Pink Floyd's classic Dark Side of the Moon album turfs Sinead O'Connor's Faith and Courage CD by a multiple of over 400%, an indication of the musical judgment exhibited by users of this site.

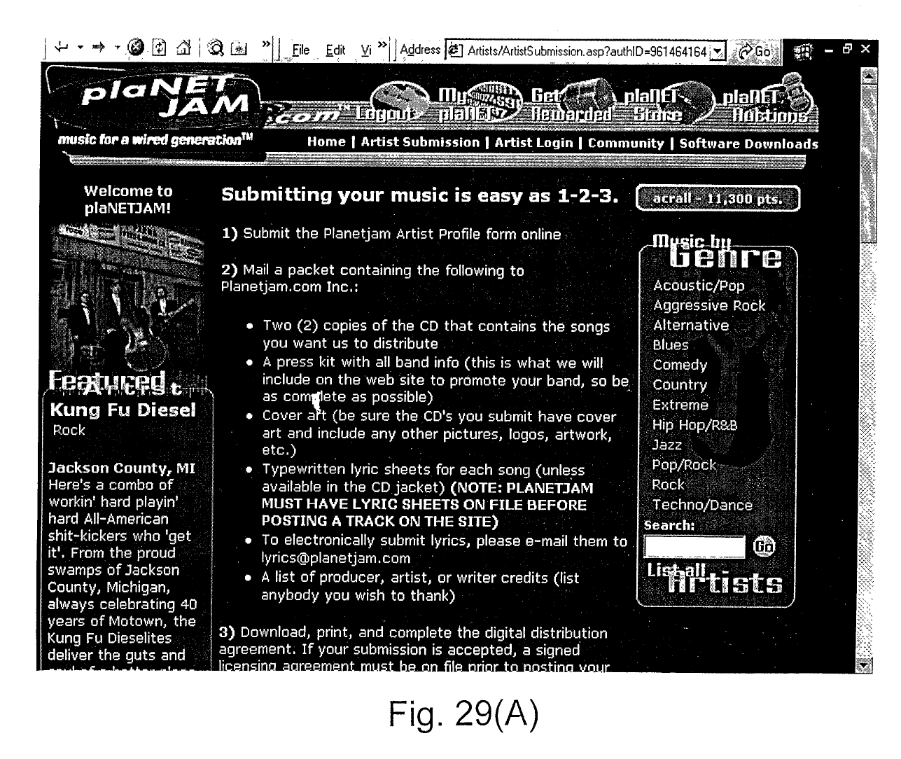

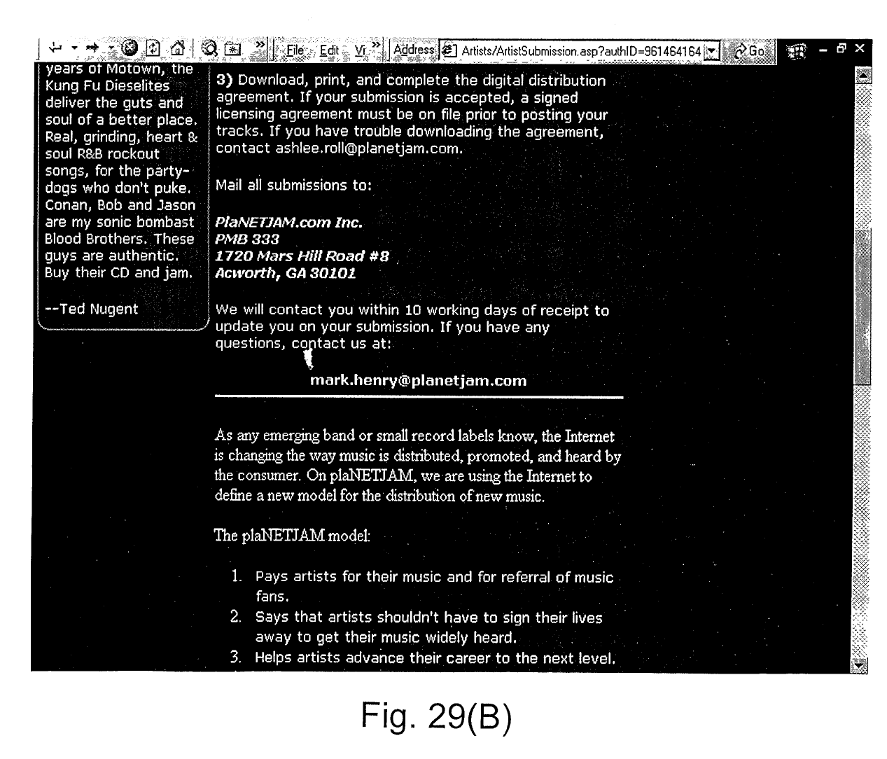

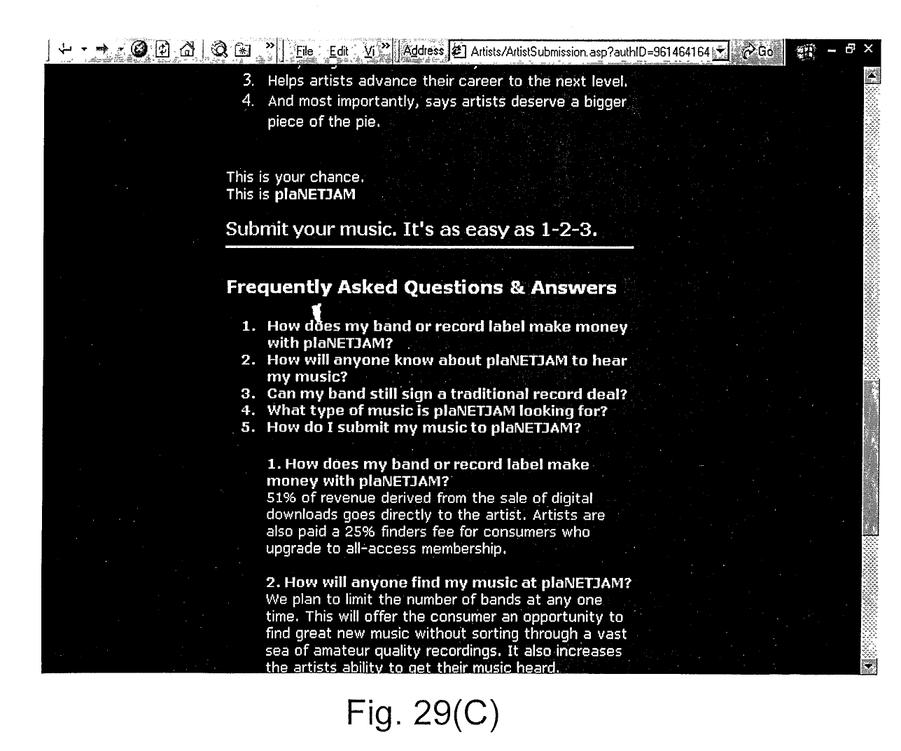

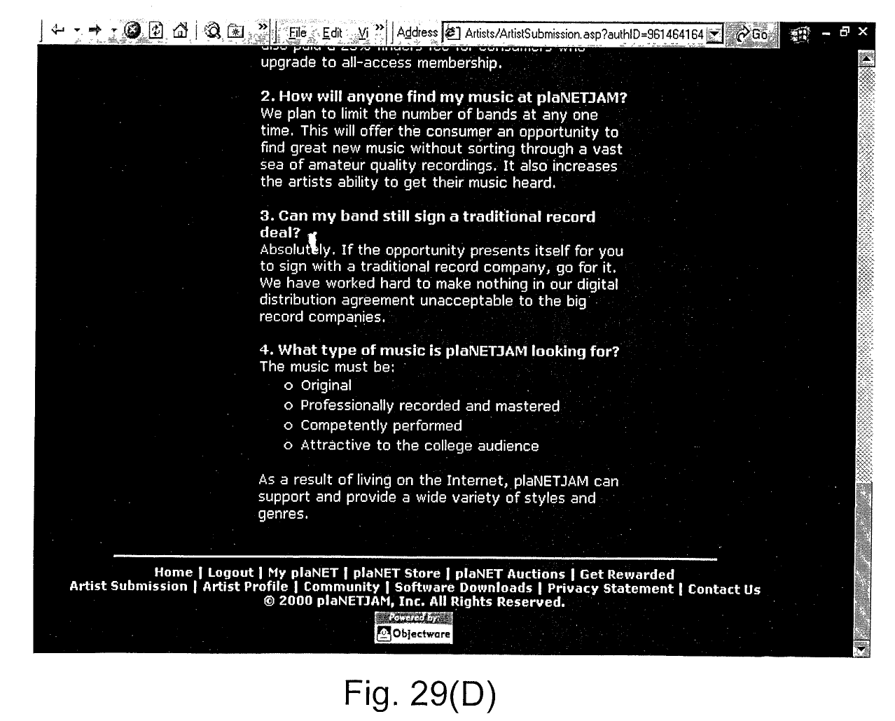

FIGS. 29A-29D are screen shots which show interfaces for allowing artists to submit music. According to the preferred embodiment, lyrics must be placed on file before tracks can be posted, and artists must enter into a distribution agreement and submit an artist profile in addition to the other information listed on the screen shot.

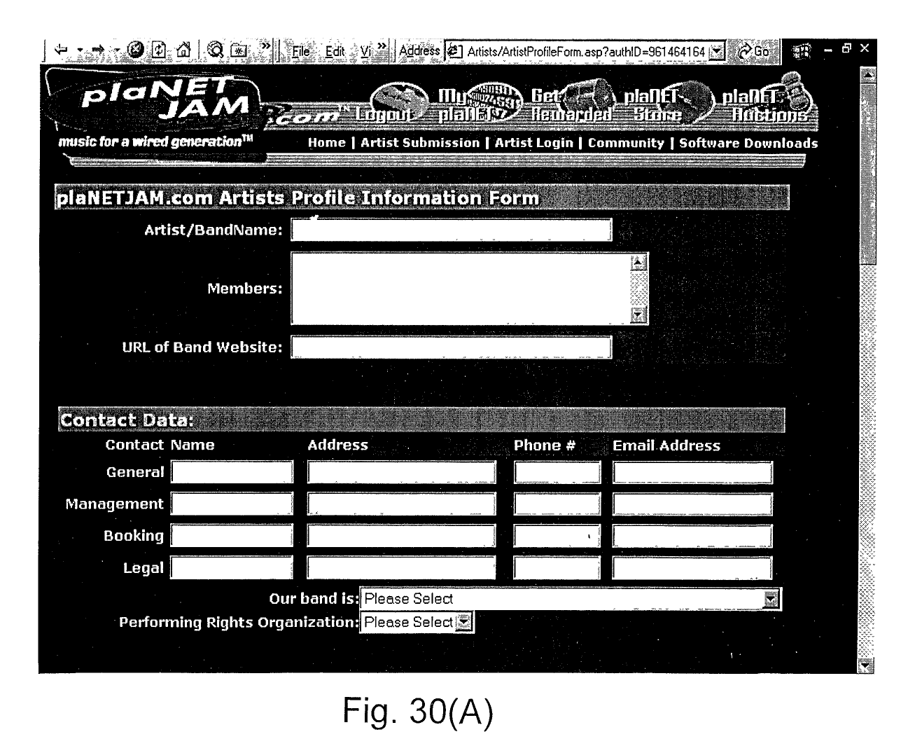

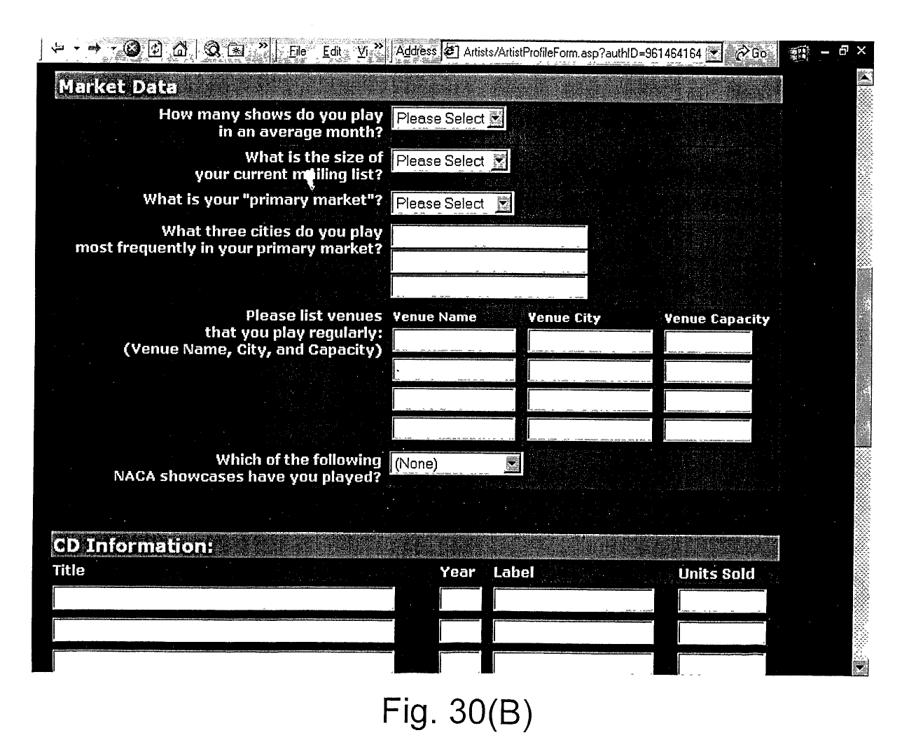

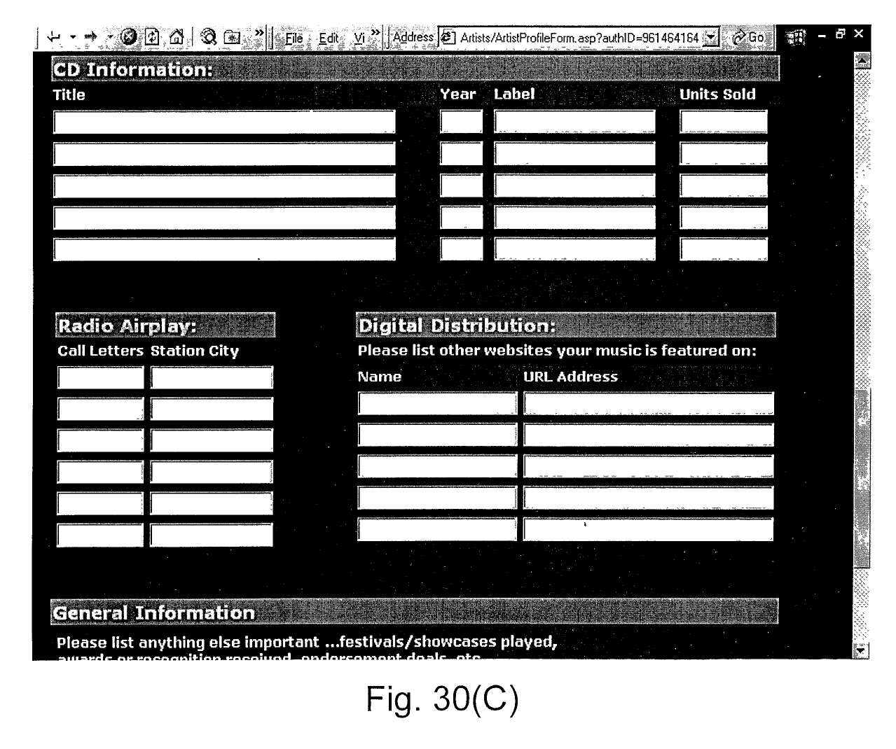

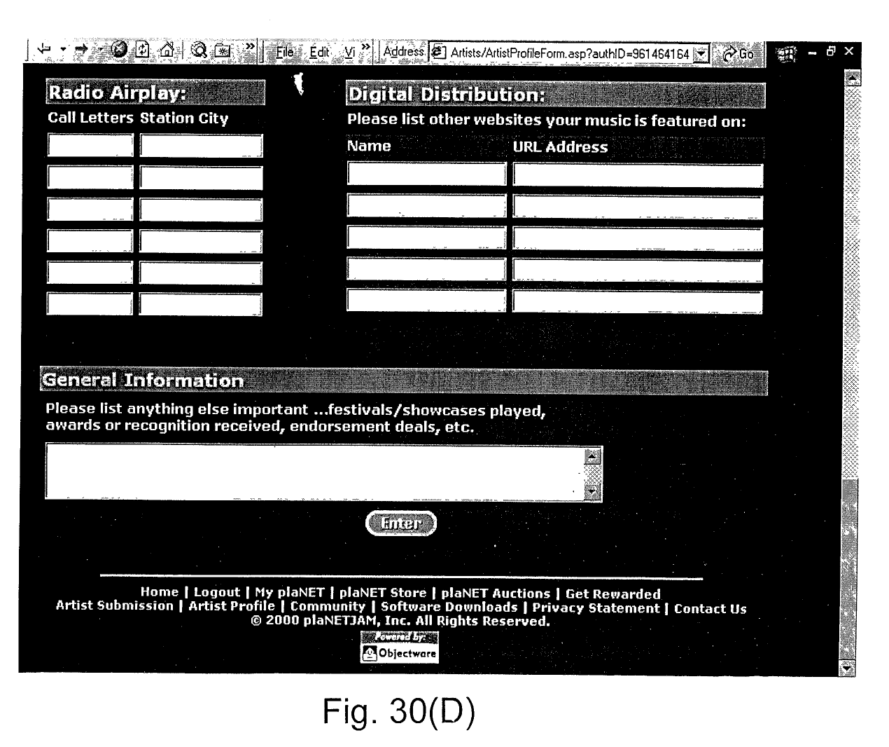

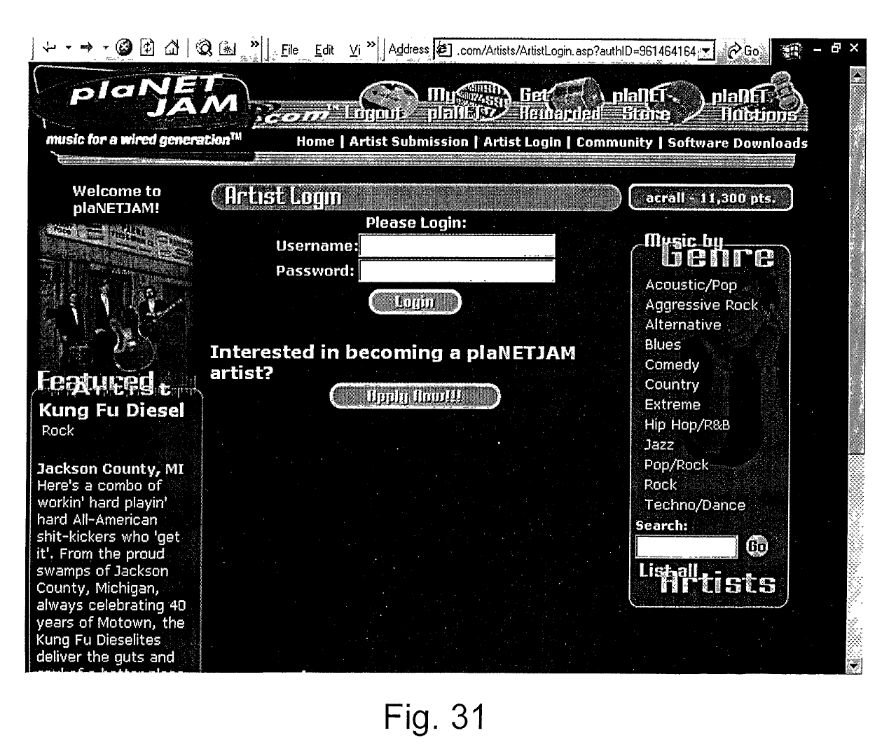

FIGS. 30A and 30B are screen shots showing the artists' profile information form. This form includes spaces for entry of artists' name, members of a band, url of the website, contact data, market data, CD information, radio airplay, digital distribution and other information of a general nature. FIG. 31 shows a logon screen for artists.

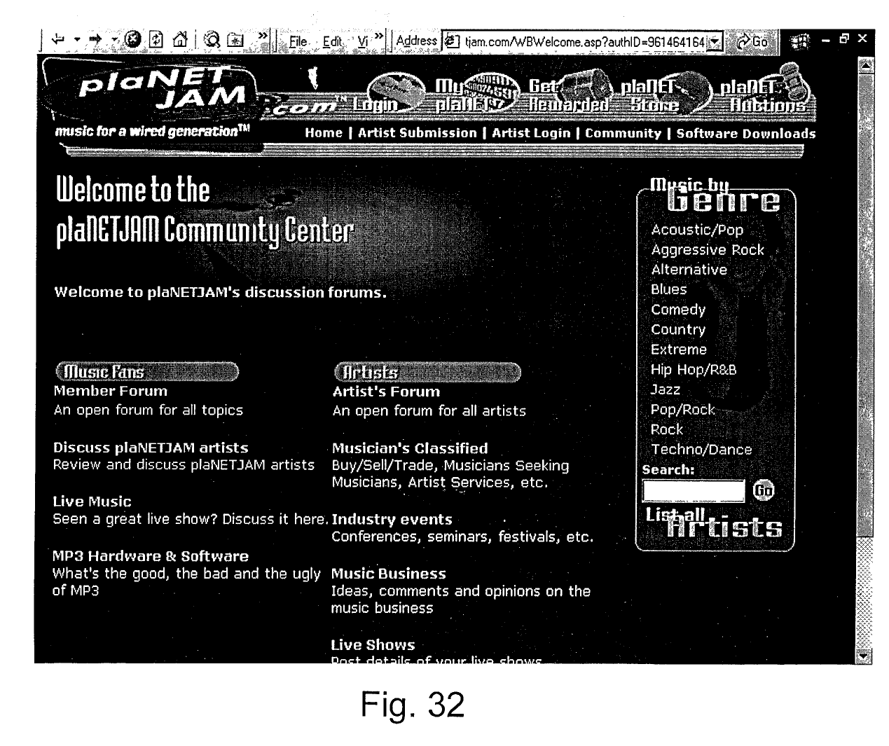

FIG. 32 shows a community center screen which lists a number of discussion forums about artists, live music, MP3 players, classified ads, industry events, music business, live shows and other discussion opportunities.

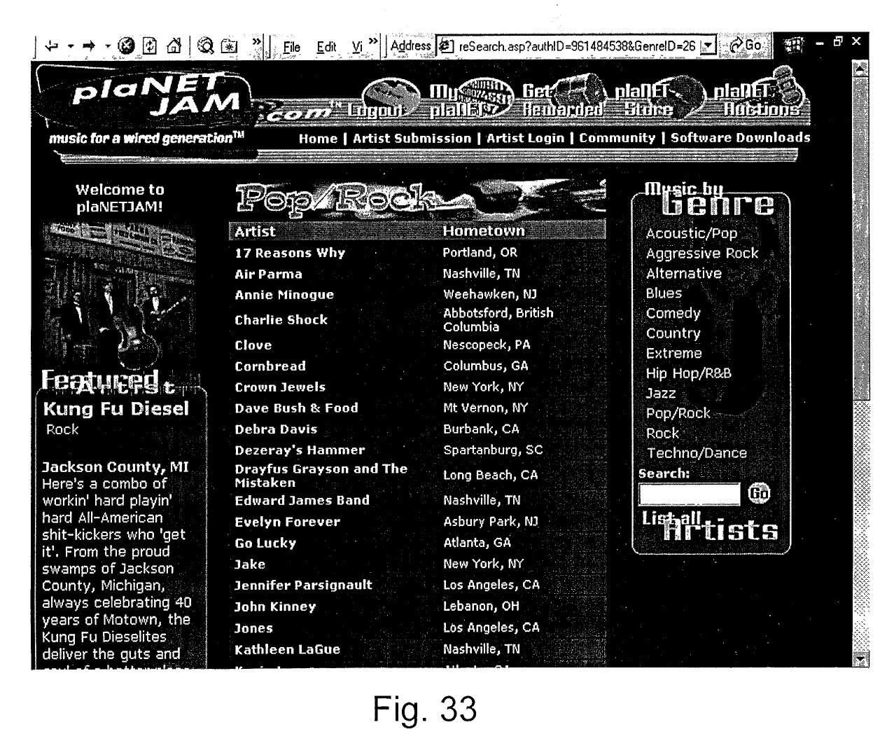

FIG. 33 shows an alphabetical listing of certain artists who have affiliated with the organization supporting the Platform 100.

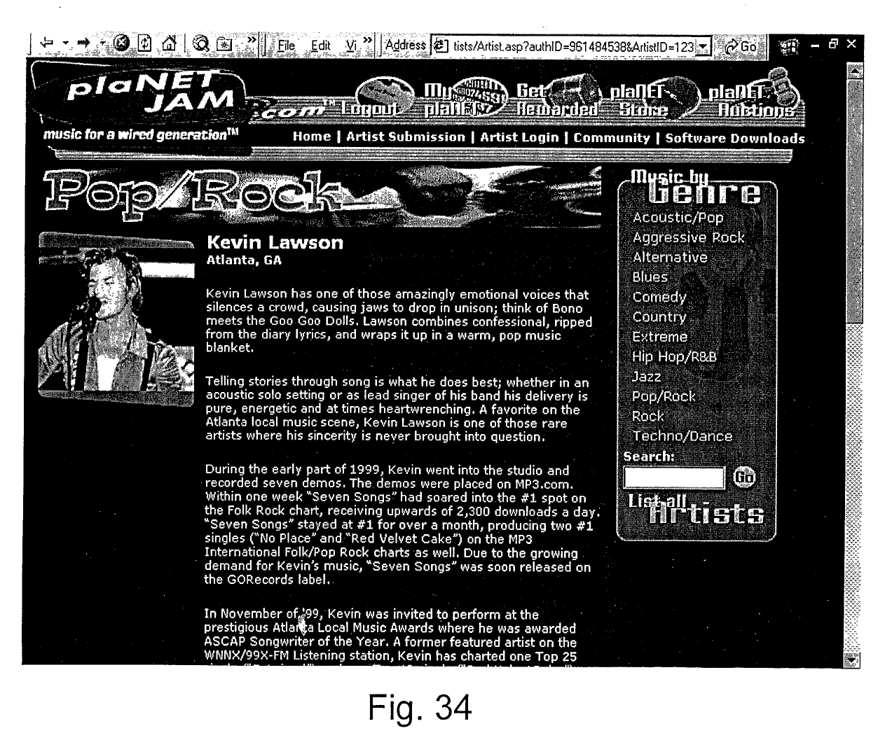

FIG. 34 is a drill down from the screen shot of FIG. 33 to Kevin Lawson, an Atlanta, Ga. artist.

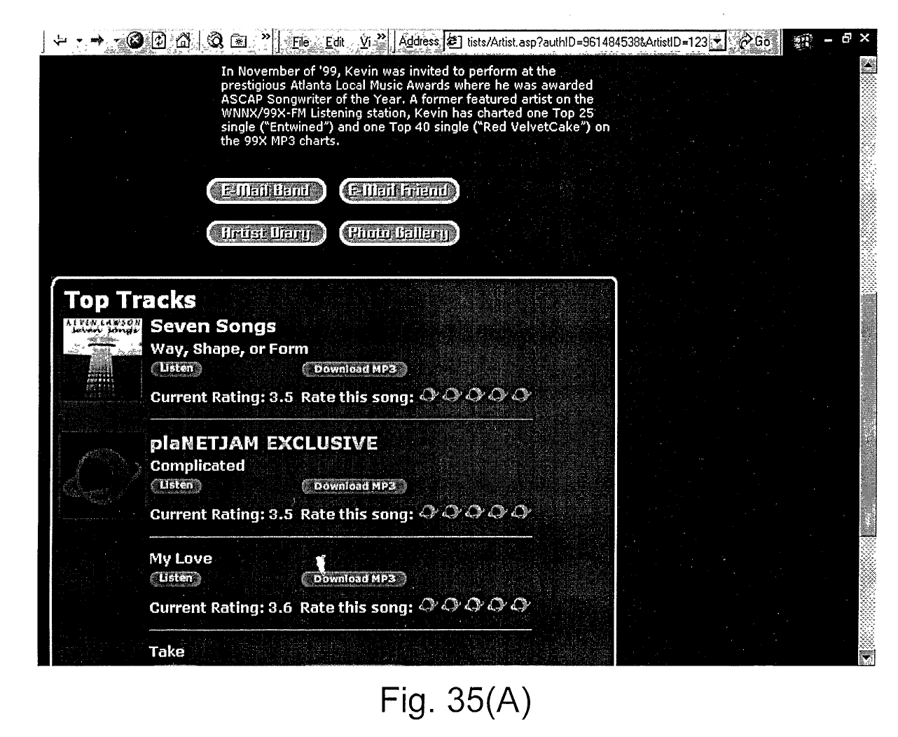

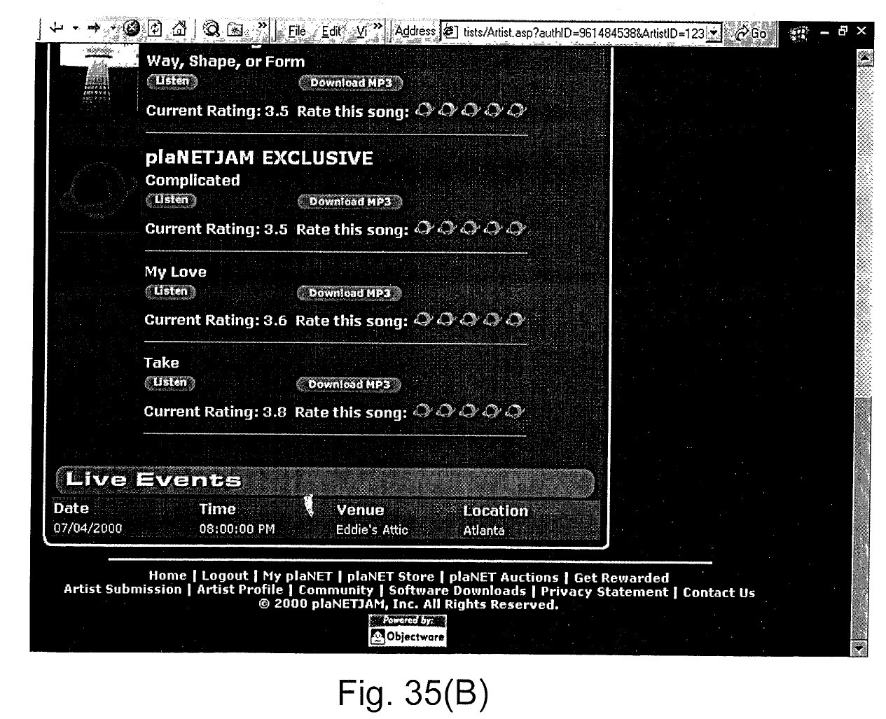

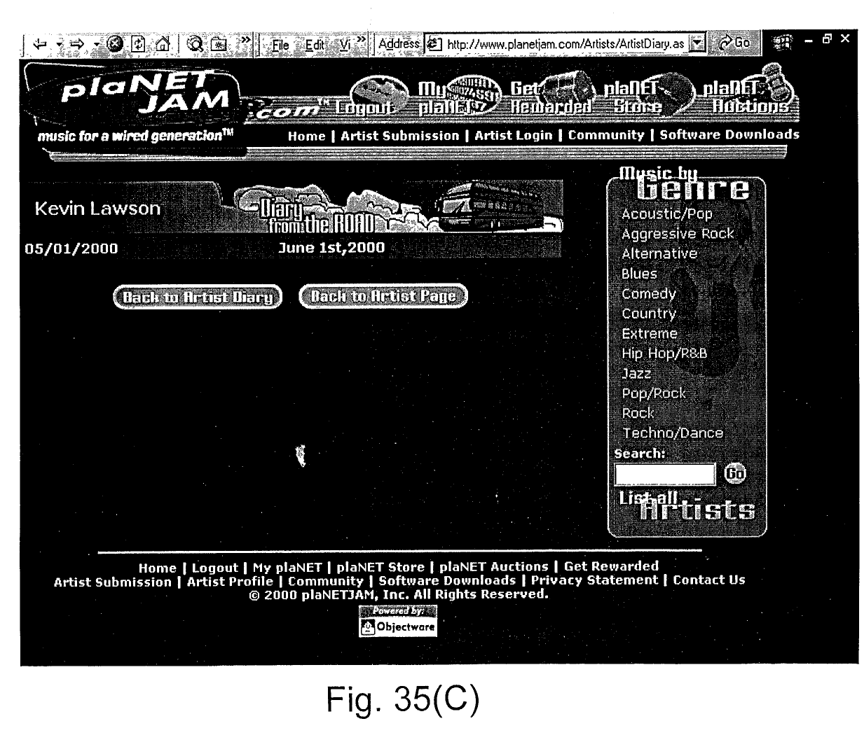

FIGS. 35A-C are a continuation of FIGS. 34 which allow the opportunity to download and rate Mr. Lawson's songs.

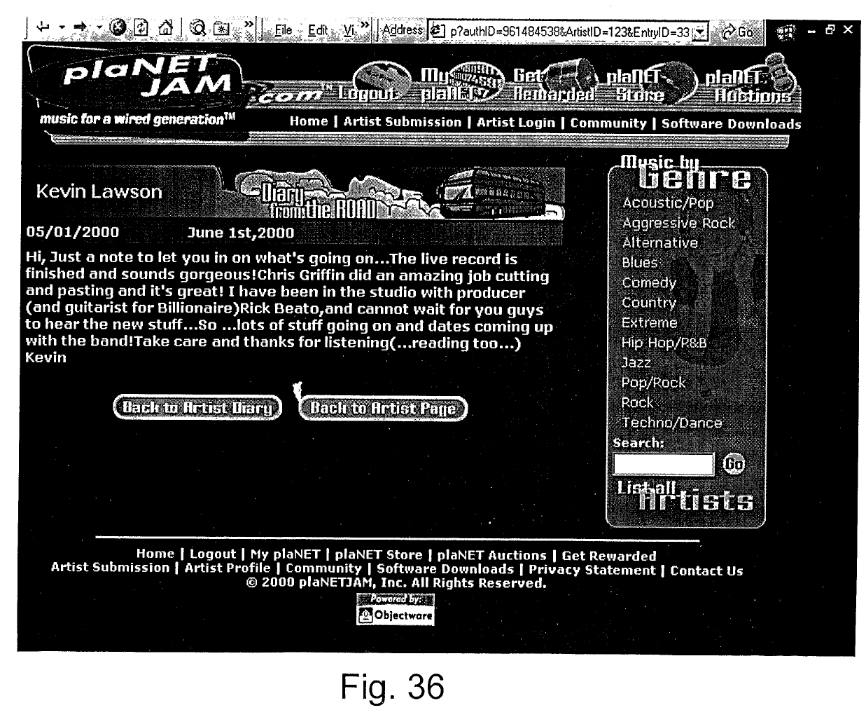

FIG. 36 is a page showing a diary entry from Mr. Lawson.

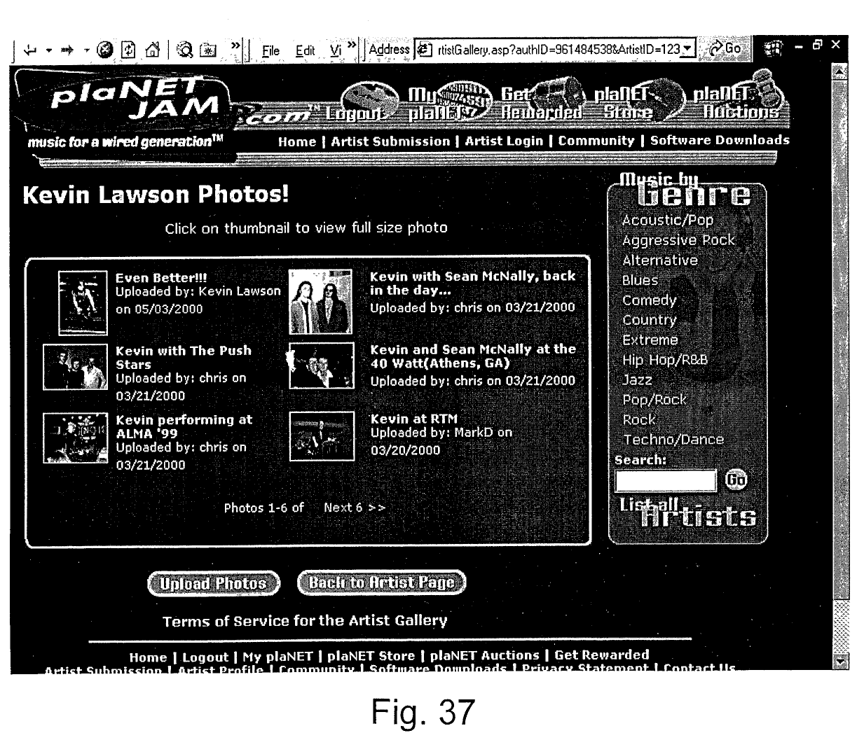

FIG. 37 allows the user to view or download photos of Mr. Lawson.

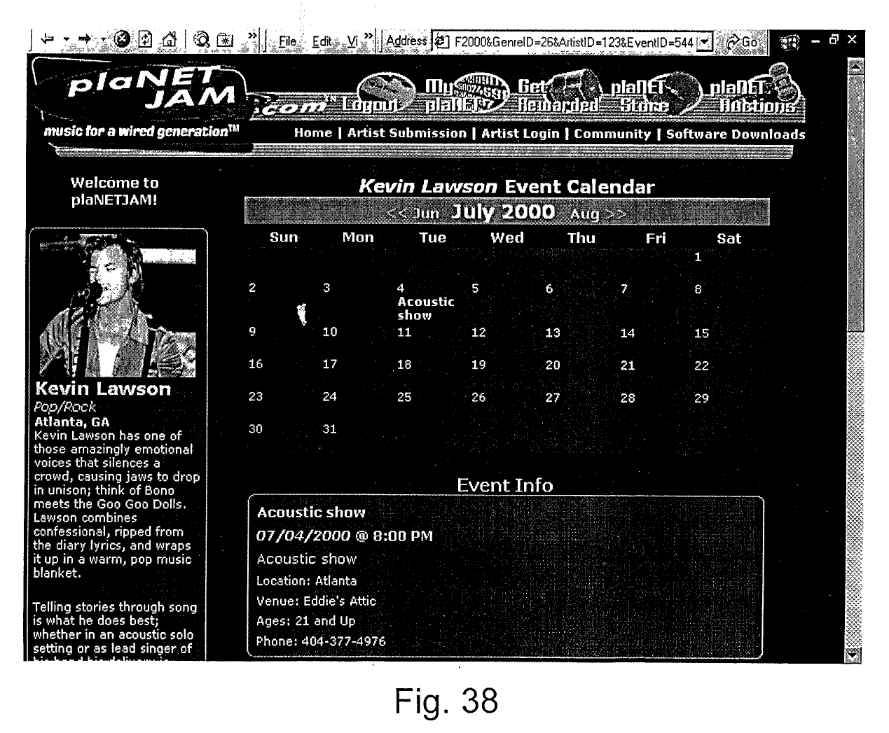

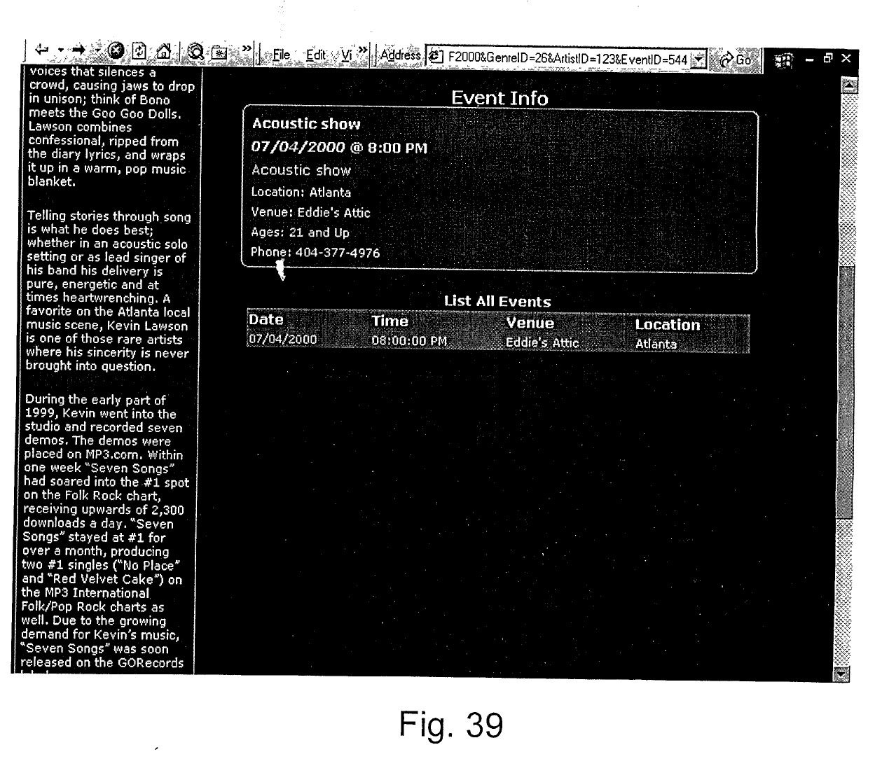

FIGS. 38 and 39 show an event calendar for Mr. Lawson.

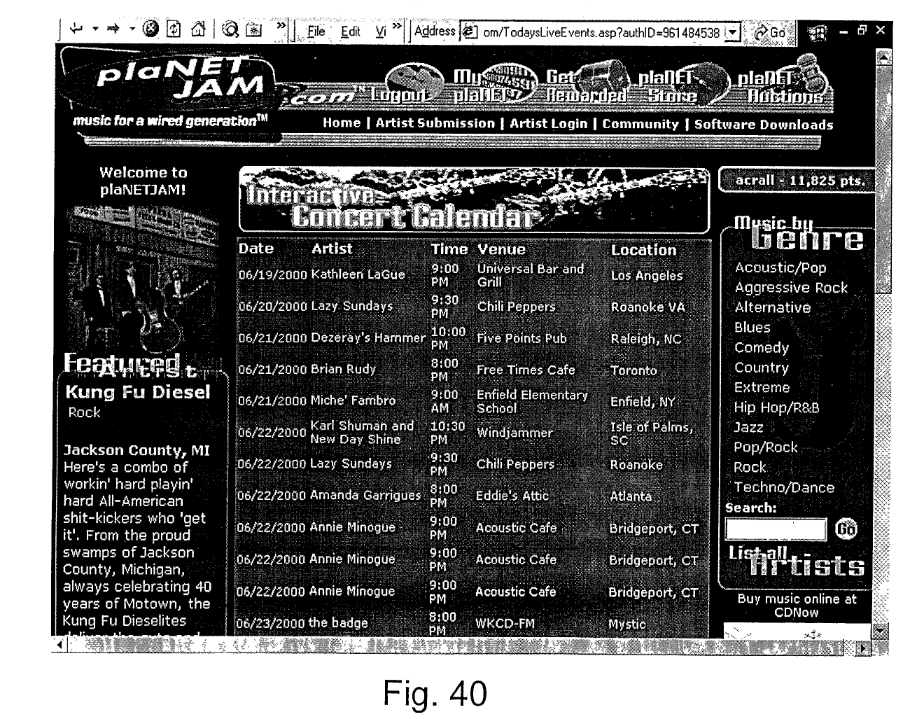

FIG. 40 is a listing of concerts for artists participating in the site.

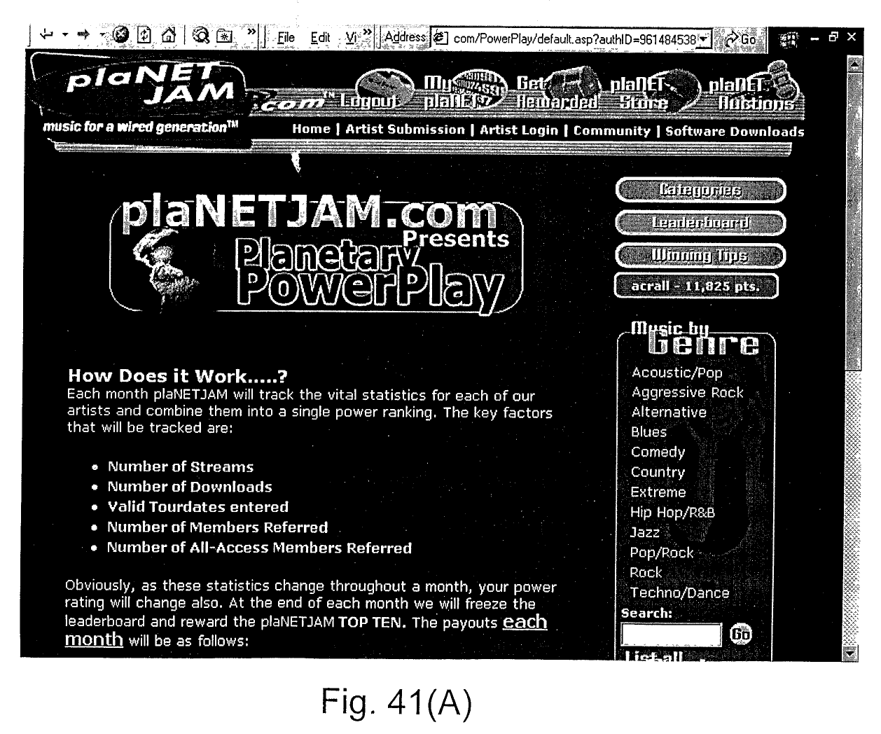

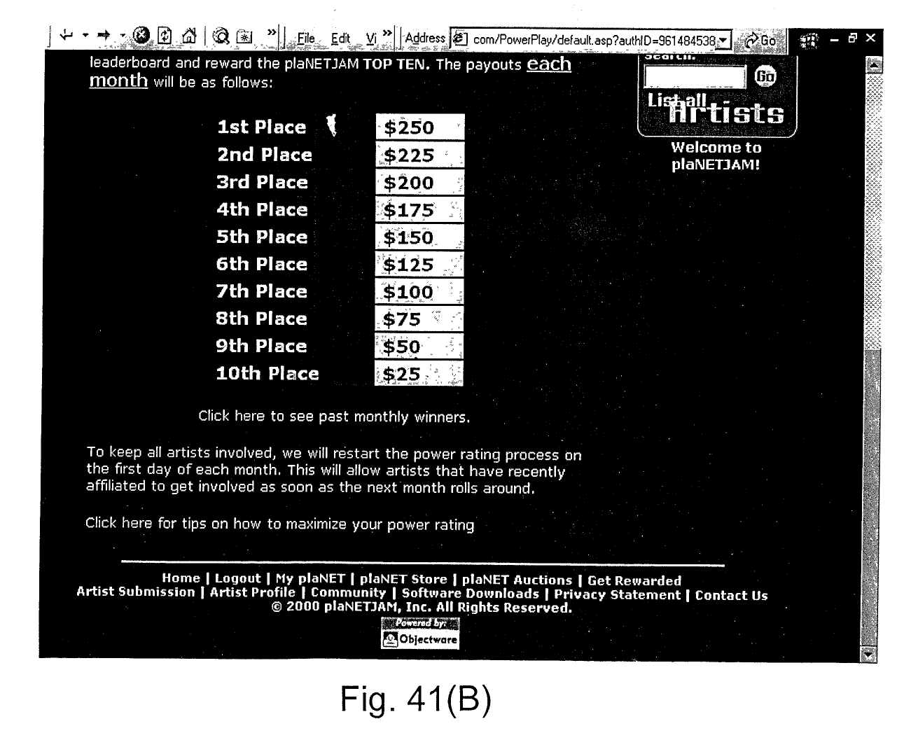

FIGS. 41A and 41B show an interface which allows artists to participate and earn royalties based on performance. Performance includes number of streams, downloads, and other activities conducted relative to the artist. Prizes can be awarded as shown by various rankings on FIG. 41B.

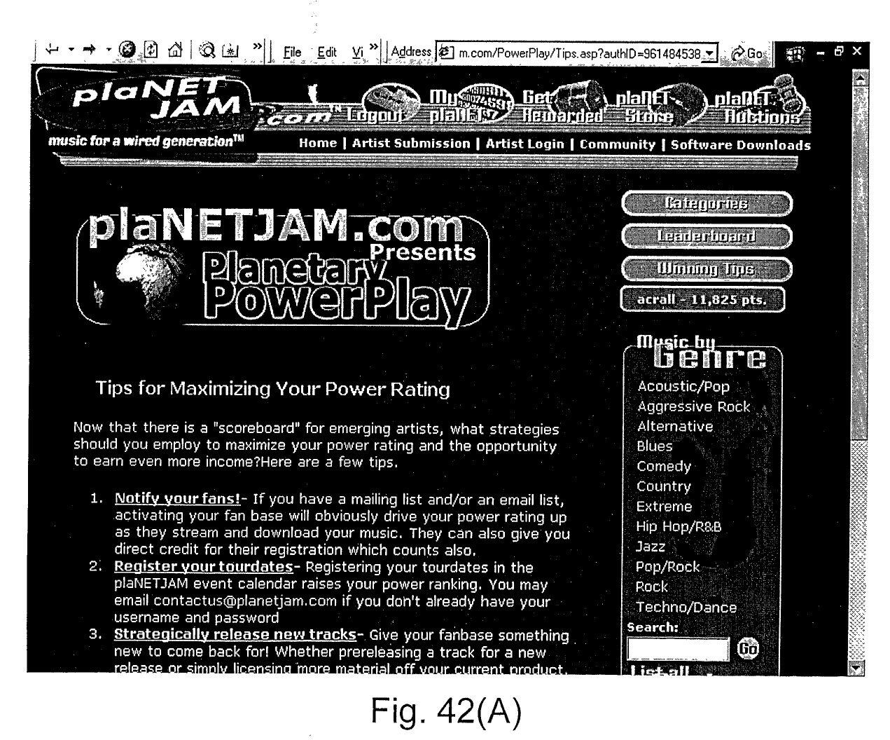

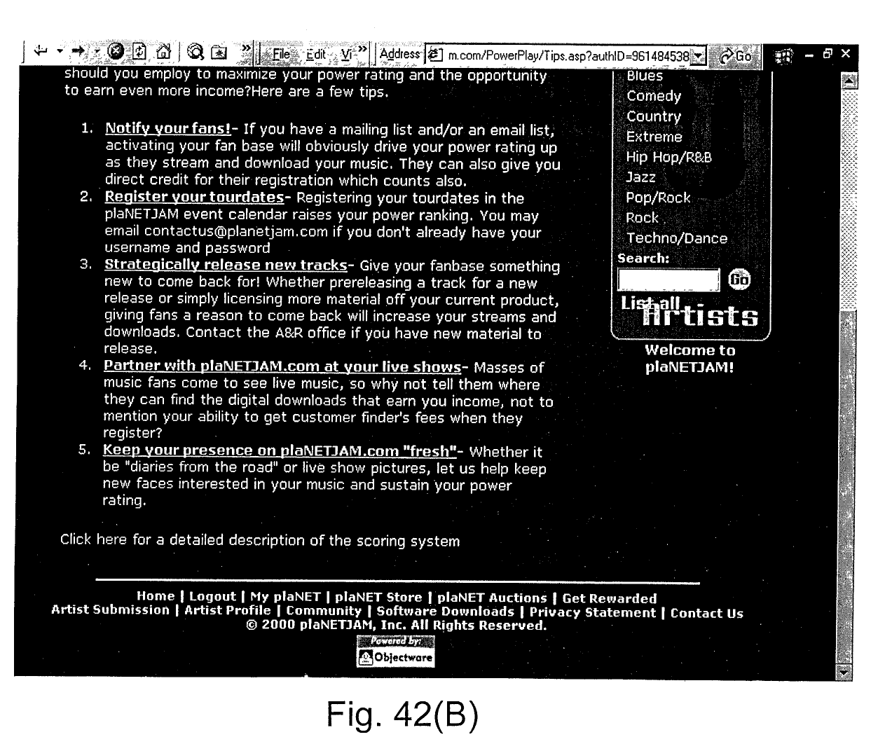

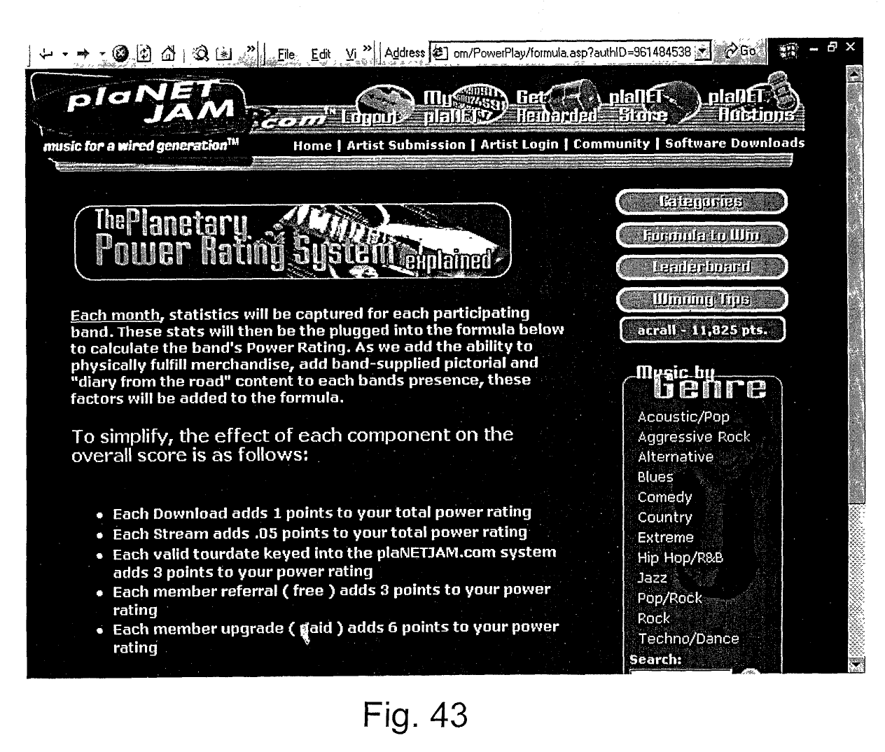

FIGS. 42A and 43B show tips for maximizing power ratings in connection with the artists who choose to participate.

FIG. 43 shows specifically how various activities add points to an artist's power rating.

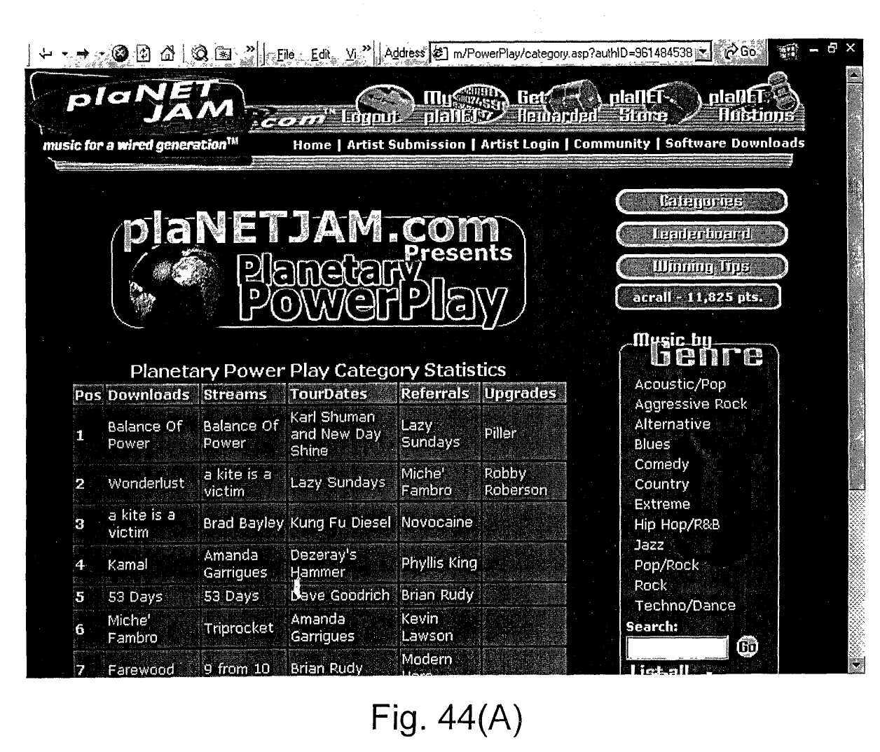

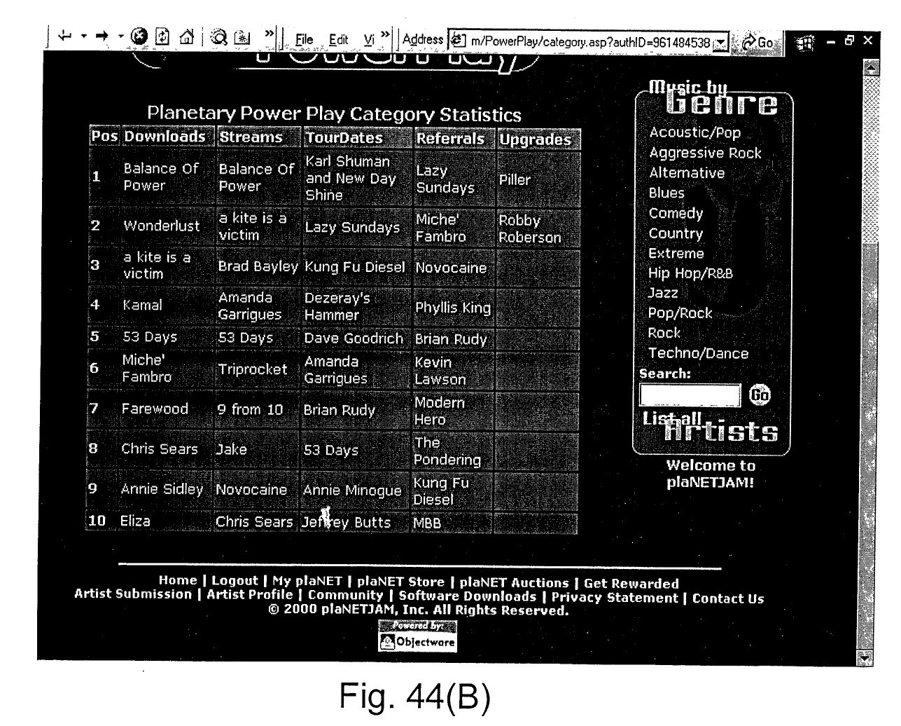

FIGS. 44A and 44B show a ranking for artists who participate in the power play contest, according to certain activities.

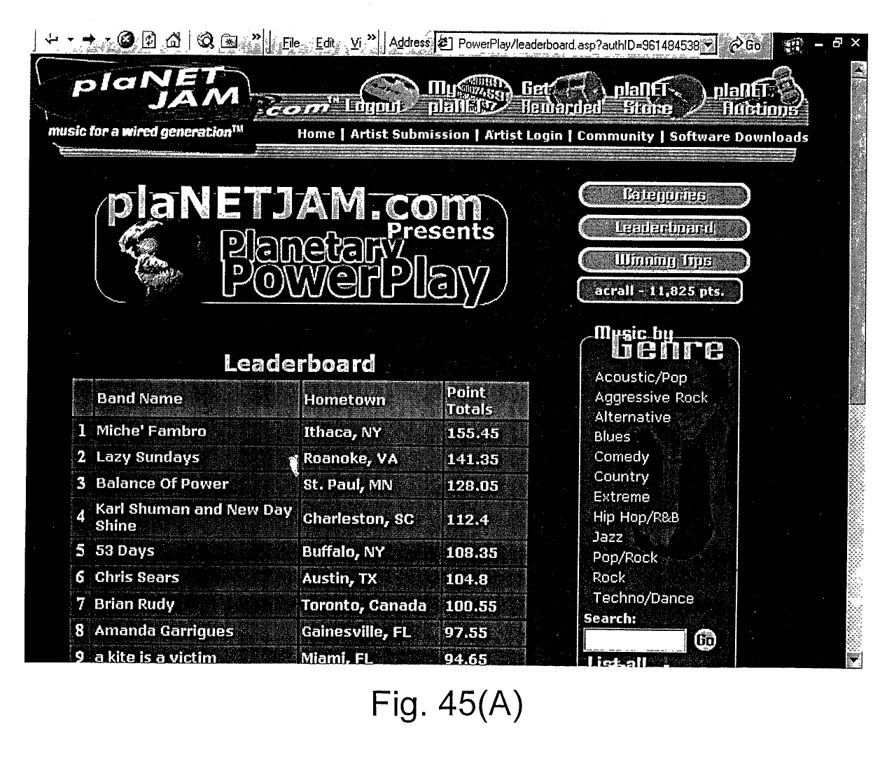

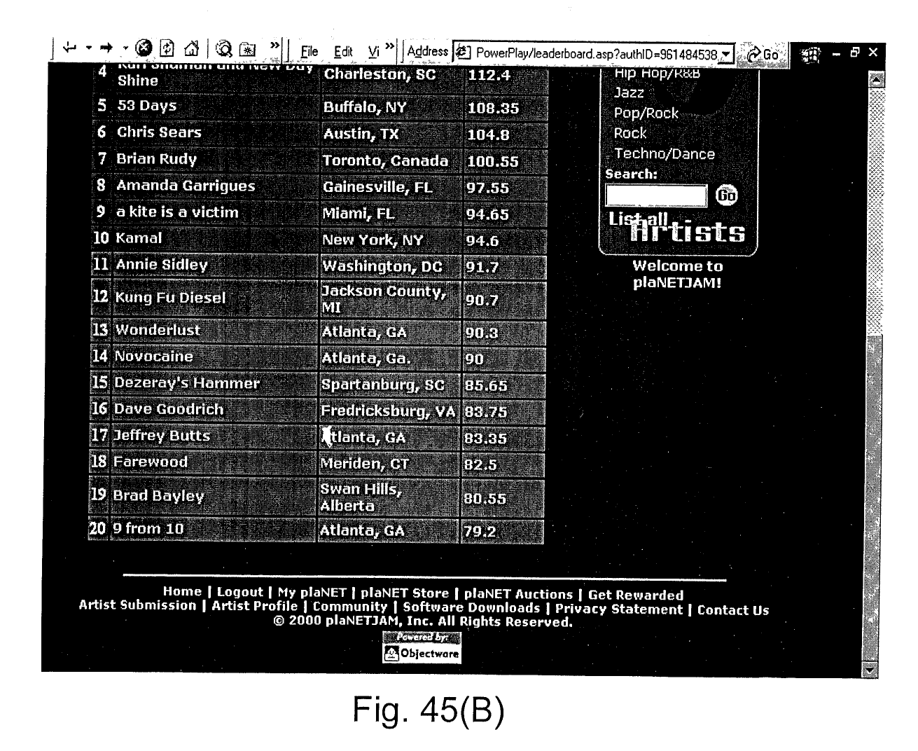

FIGS. 45A and 45B show ranking based on total points. The artist may, of course, be organized into categories, geographical vicinities or as otherwise desired in order to create variations on the contest.

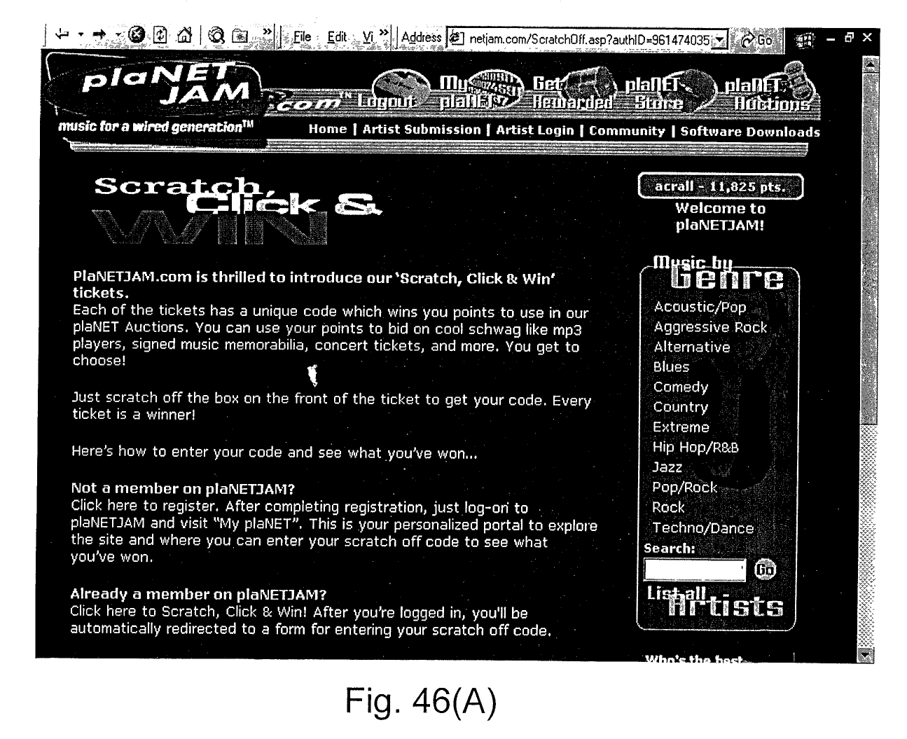

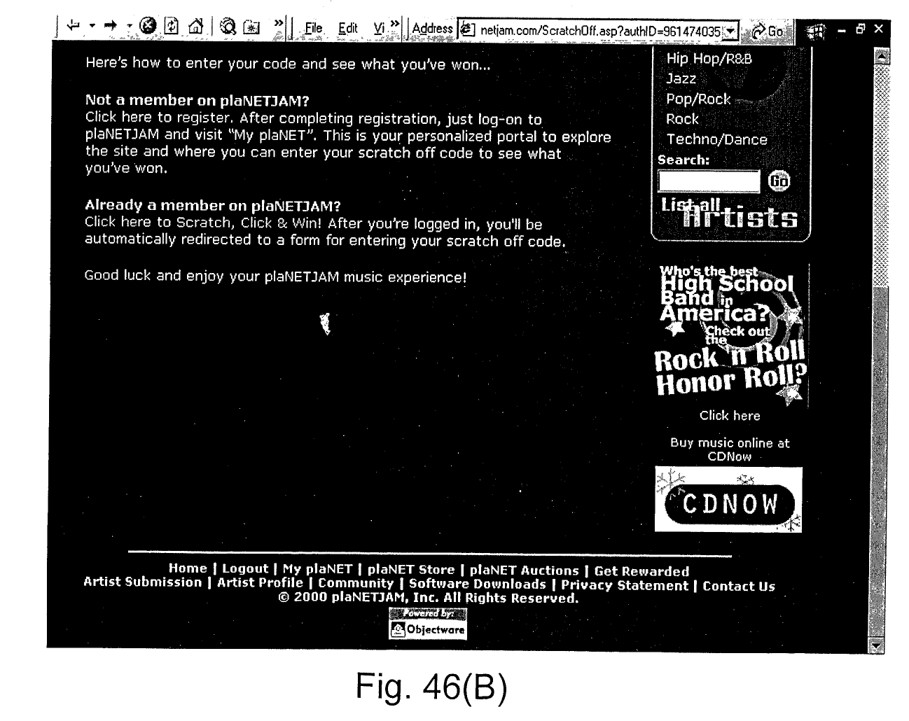

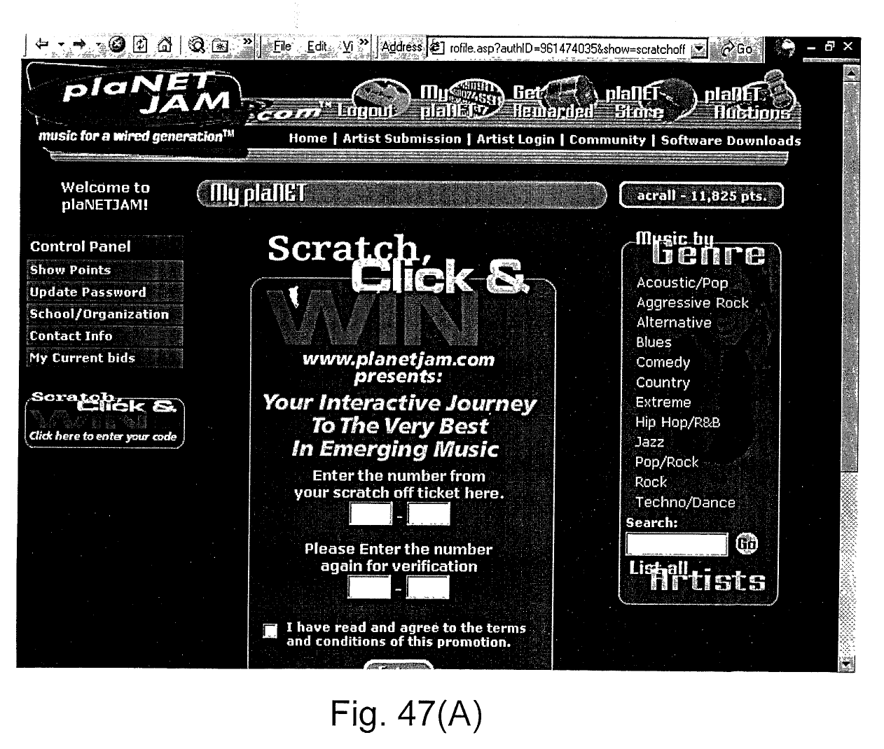

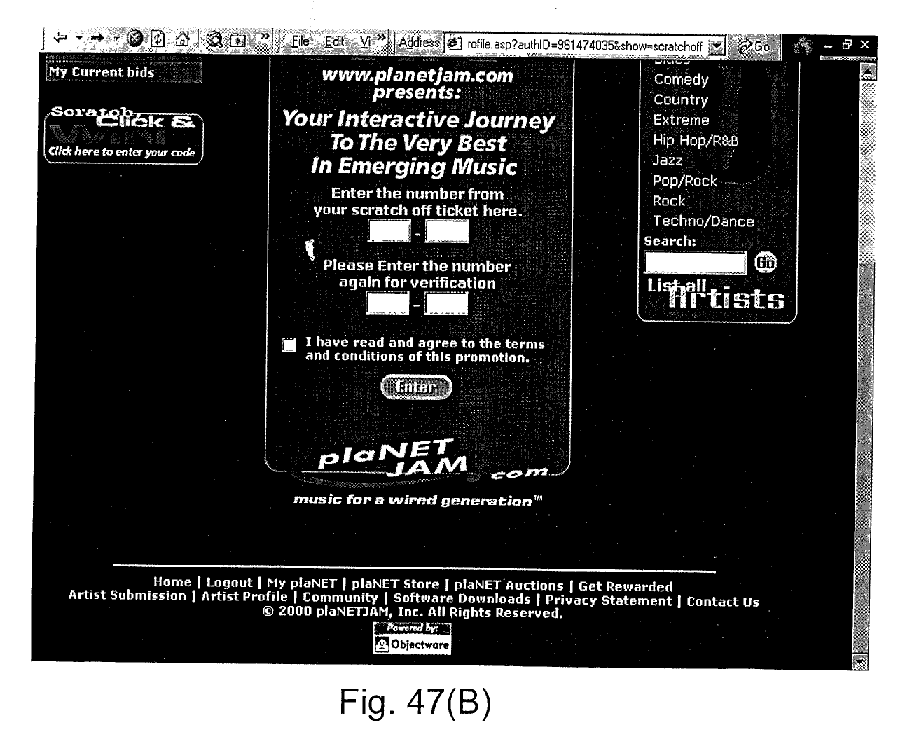

FIGS. 46A and 46B, and 47A and B are screen faces supporting a scratch, click and win cross media marketing functionality. The user obtains a ticket, coupon or other piece at a concert, a music store, a restaurant, or other location. She scratches a coating off the ticket to reveal alphanumeric information, a code or other indicia. The user uses that indicia on the screen face shown in FIGS. 47A and 47B to receive additional points which may be used in auctions.

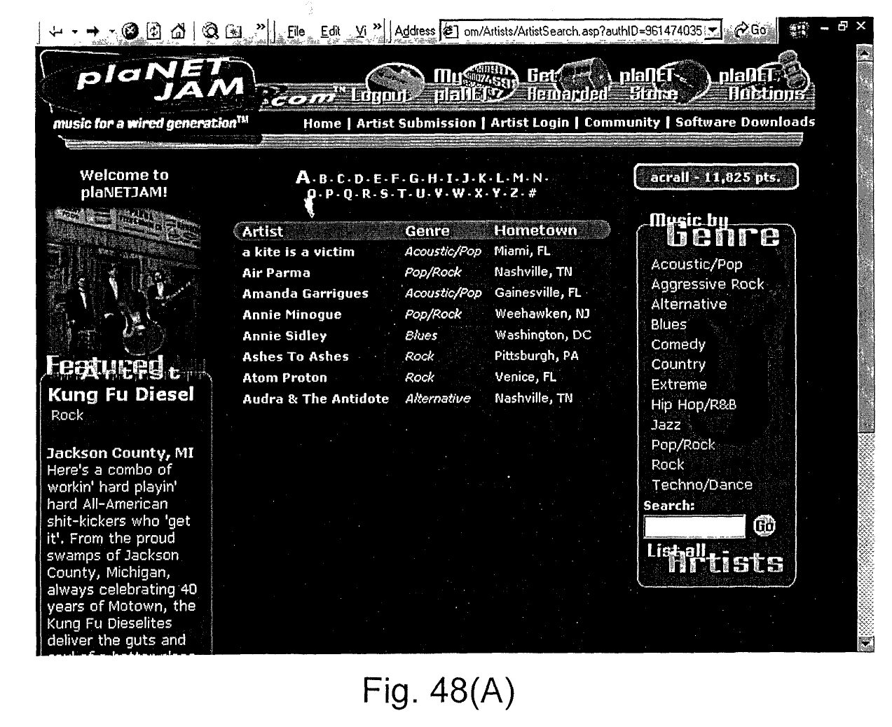

FIG. 48 shows an alphabetic listing of all artists whose names begin with A, their genre and their hometown.

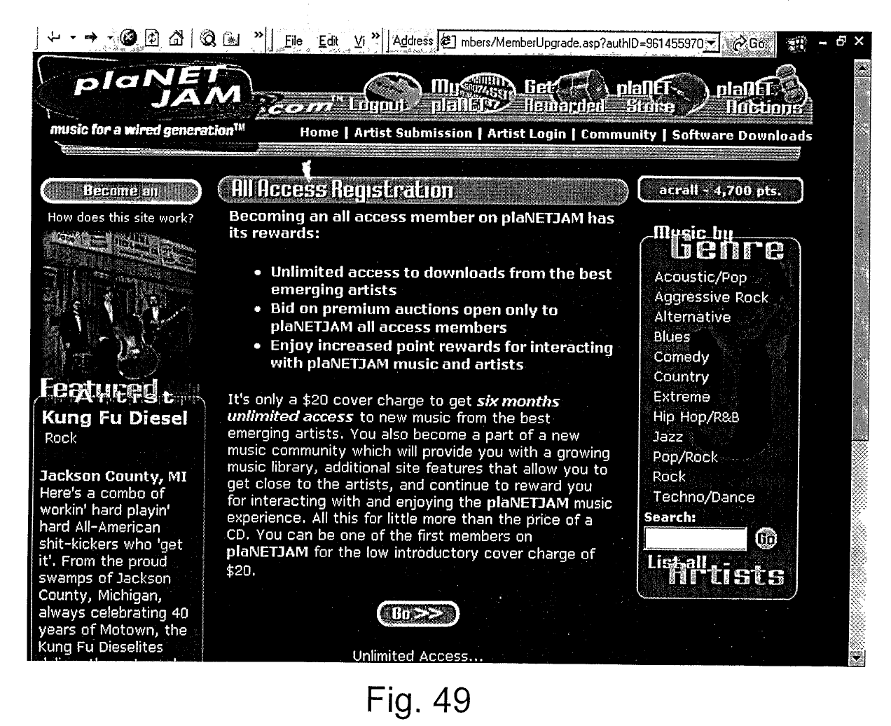

FIG. 49 shows a registration screen face for so called “All Access” Members. These members have unlimited access to downloads, access to bid on premium auction items, and increase point awards. All access registration is based on payment of a subscription or a sponsorship by third party in connection with certain activities or conduct.

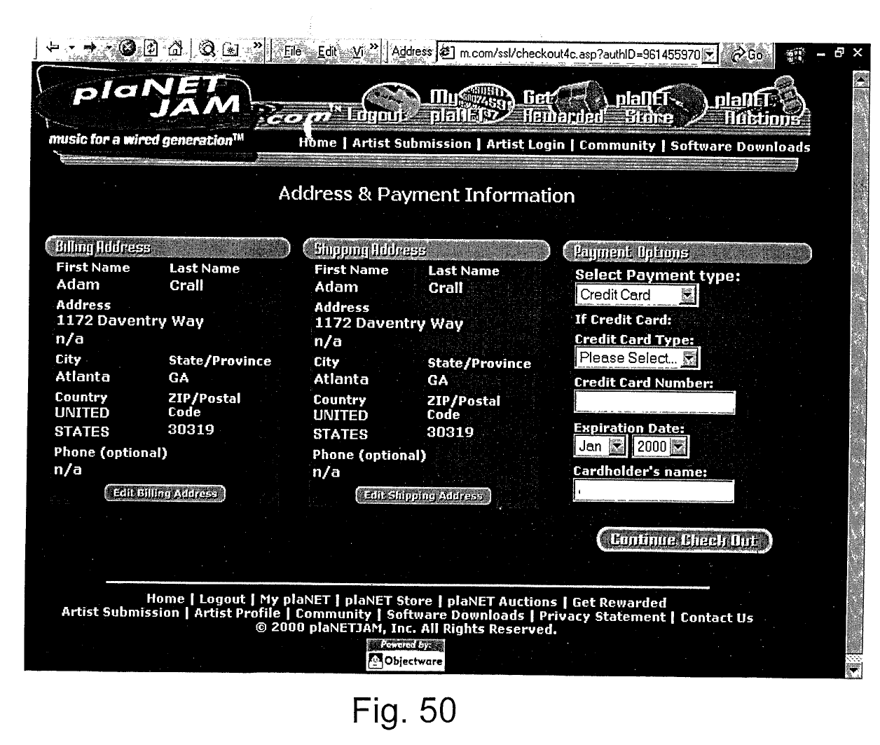

FIGS. 50, 51 and 52 show screen faces for information reflecting billing, shipping and payment to subscribe.

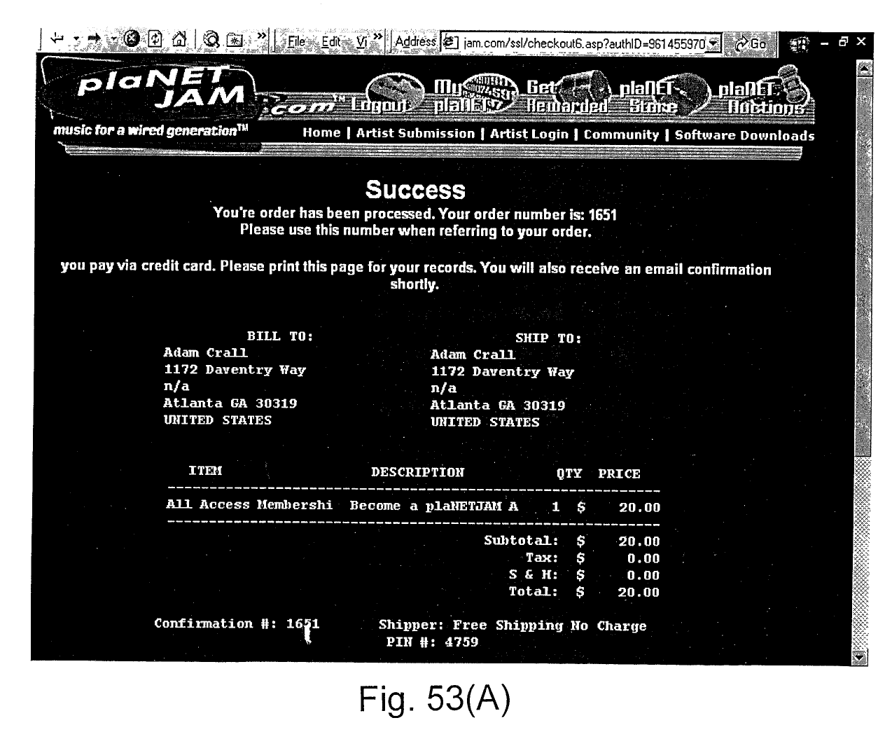

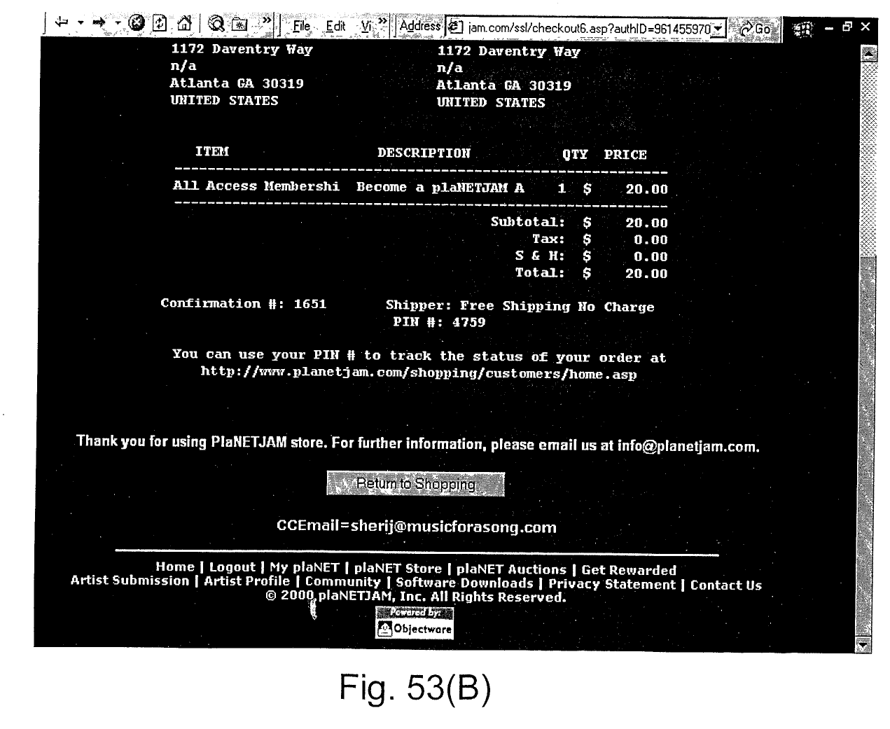

FIGS. 53A and 53B are a success screen reflecting confirmation of the All Access Membership Order.

In an interface supported on an affiliate 112 or other third party site by Platform 100, any or all of the functionality shown in screen shots in FIGS. 6-53A, and more, may be presented. Navigational buttons may be used in order to conduct certain activities such as to check a list of affiliates, participate in an auction, check points assignment, conduct account management, participate in a survey, linked to Platform 100, or otherwise interact, receive points, and participate in auctions.

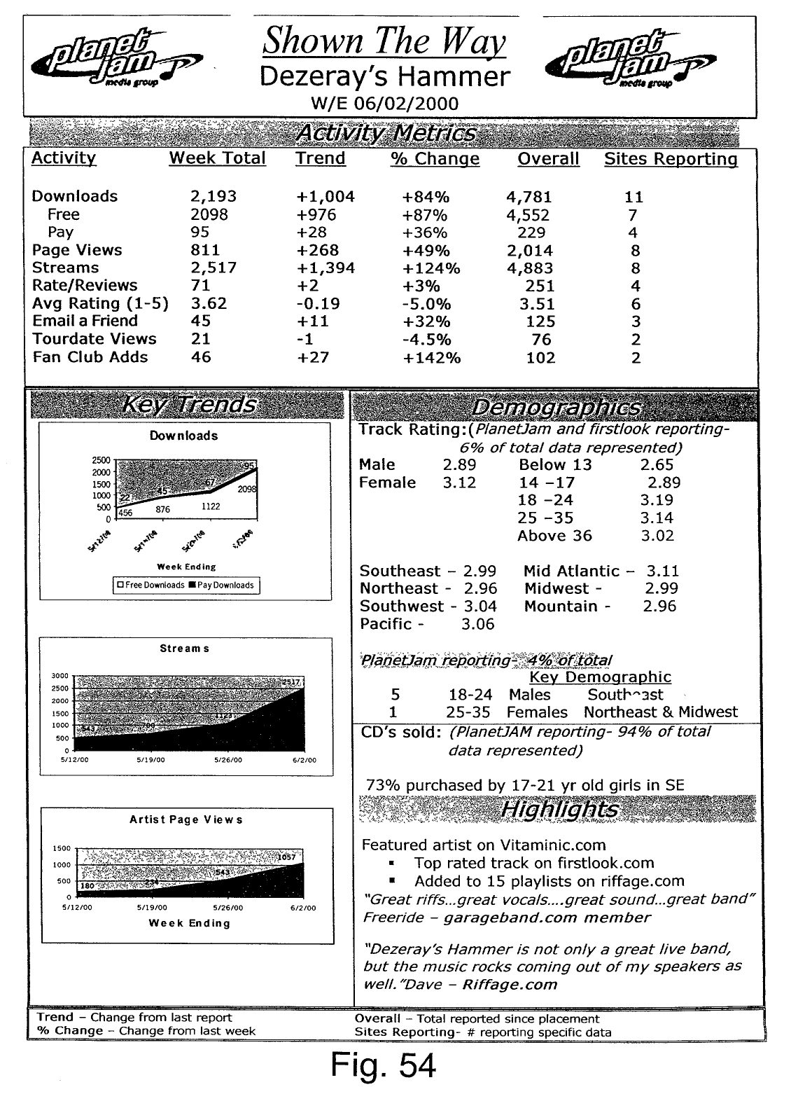

FIG. 54 shows one form of report which can be provided to labels, other talent intermediaries, advertising agencies, or any other entity who perceives user-related information from systems and processes according to the present invention to be of value and who is willing to pay for it monetarily or in other forms. For the particular artist and track in question, this proforma report is for the week ending Jun. 2, 2000. It shows a number of items about activity on this site relating to the artist and track. Other report formats can be tailored as desired, including only to the track, to the artist across a range of tracks, album based, geographical location based, age group based, sales based, gender based or otherwise. This particular report classifies and presents metrics relating to certain user activity including downloads, page views, streams, ratings and reviews, average rating, e-mails to friends, tour dates, and fan club additions. Free downloads far exceed paid downloads both in numbers and in upward trends from the previous time period. The number of users trying the artist out with streaming increased radically for the week, although the average rating fell off to some extent. However, the small number of ratings raises the question whether there is a statistically significant sample. A number of users, with an increasing trend, showed commitment to the level of joining a fan club perhaps because they want to know more about the band and be in touch with others who are fans.

Demographics on the right show a slightly larger audience in the female population, and the age group with the largest activity appears to be ages 18-24. Although the Mid-Atlantic region appears to generate the highest numbers, a significant degree of commitment is shown by females in the 17-21 age category in the Southeastern United States, who purchased 73% of the artists CDs for the week. This particular data does not show auction activity, but that and any other form of user response may be presented in any manner desired to assist in early identification of trendsetting artists, to assist labels in determining which artists to promote and how and where to promote them, and for other purposes. Such activity/demographic information may be provided in customized form in any manner desired by any entity who wishes to obtain it from the operator of Platform 100; it may be provided in the form of suitably security protected access to the database on Platform 110 in which activity information and/or demographic information are provided, so that the entity seeking access can obtain in real time the information they need in the form that they need it.

The foregoing disclosure presents certain systems and processes according to preferred embodiments of the present invention, on the understanding that additions, deletions, modifications, and other changes may be made to such systems and processes and are indeed expected, without departing from the scope or spirit of the present invention, as new information technology, communication systems and processes and bandwidth become available.

We claim:

1. An automated system for tracking user response to content, comprising:
a. a platform for presenting a plurality of activities related to said content to users, said platform including a database for storing said content;
b. a presentation/interaction functionality adapted to permit a user to input user demographic data and engage in said activities from said platform; and
c. a processing functionality adapted to cooperate with said presentation/interaction functionality to store, process, and provide information to and receive information from said presentation/interaction functionality.

2. The system as set forth in claim 1 wherein said database comprises an activity code assigned to each of said activities.

3. The system as set forth in claim 1 wherein said processing functionality tracks and records said activities engaged in by said user.

4. The system as set forth in claim 3 wherein said processing functionality is adapted to combine said activities and said activity codes of said activities engaged in by said user with said user demographic data.

5. The system as set forth in claim 4 wherein said database is adapted to cooperate with said processing functionality to store information about said activities engaged in by said user and said user demographic data.

6. The system as set forth in claim 5 further comprising a reporting communications functionality adapted to inform third parties of said activities engaged in by said user and said user demographic data.

7. The system as set forth in claim 3 wherein said database comprises a point value associated with each of said activities.

8. The system as set forth in claim 7 wherein said point values associated with said activities are based on an effort ranking.

9. The system as set forth in claim 7 wherein said point values associated with said activities are based on a commitment level ranking.

10. The system as set forth in claim 7 wherein said point values associated with each of said activities can be controlled.

11. The system as set forth in claim 7 wherein said processing functionality tracks and records said points awarded said user for engaging in said activities.

12. The system as set forth in claim 11 wherein said database is adapted to cooperate with said processing functionality to store information about said points awarded said user for engaging in said activities.

13. The system as set forth in claim 12, further comprising an auction engine which is adapted to cooperate with said platform and said presentation/interaction functionality to conduct an auction for premiums and receive user bids of points for said premiums made by said user interacting with said presentation/interaction functionality.

14. The system as set forth in claim 13 wherein said auction can be controlled at least by adjusting the time period in which the auction occurs.

15. The system as set forth in claim 14 wherein said auction can be controlled at least by adjusting the minimum or maximum bids for said premium.

16. The system set forth in claim 13 wherein activities in said auction are assigned activity codes for tracking by said processing functionality and reporting by said reporting communications functionality.

17. The system as set forth in claim 1, wherein said platform is a web site.

18. An automated system for aggregation of data about user response to content, comprising:
a. a platform including a database for storing user information;
b. an affiliate presentation/interaction functionality including an interface adapted for cooperation with said platform, said affiliate presentation/interaction functionality adapted to receive user requests for activities related to said content and to permit a user to input user demographic data;
c. a delivery platform adapted to cooperate with said platform and said affiliate presentation/interaction functionality to receive said user requests for activities, said affiliate presentation/interaction functionality adapted to present a plurality of activities related to said content to users and allow said users to engage in said activities;
d. a processing functionality adapted to cooperate with said affiliate presentation/interaction functionality to store, process, and provide information to and receive information from said affiliate presentation/interaction functionality and to track and record said activities engaged in by said user; and
e. a reporting communication functionality adapted to inform third parties of said activities engaged in by said user and said user demographic data.

19. The system as set forth in claim 18 wherein said database comprises activity codes assigned to each of said activities.

20. The system as set forth in claim 19 wherein said processing functionality is adapted to combine said activity codes of said activities engaged in by said user with said user demographic data.

21. The system as set forth in claim 20 wherein said database comprises a point value associated with each of said activities.

22. The system as set forth in claim 21 wherein said processing functionality tracks and records said points awarded said user for engaging in said activities.

23. The system as set forth in claim 22 wherein information about said points accumulated by said user is stored on said platform.

24. The system as set forth in claim 23 further comprising an auction engine which is adapted to cooperate with said platform to conduct an auction for premiums and receive user bids of points for said premiums made by said user.

25. An automated system for collecting relevant information about user response to content and providing incentive for users to engage in activities related to said content, comprising:
a. a platform for presenting a plurality of activities related to said content to users, said platform including a database for storing said content;
b. a presentation/interaction functionality adapted to permit a user to input user demographic data and engage in said activities from said platform, each of said activities associated with a point value awarded to said user for engaging in said activity;
c. a processing functionality adapted to cooperate with said presentation/interaction functionality to store, process, and provide information to and receive information from said presentation/interaction functionality; and
d. an auction engine adapted to conduct an auction for premiums and receive user bids of points for said premiums made by said user interacting with said presentation/interaction functionality.

26. The system set forth in claim 25 wherein said activities include at least downloading content, streaming files, reviewing artists, reviewing tracks, rating artists, rating tracks, joining an artist fan club, participating in surveys, purchasing merchandise, logging on, sending e-mail, listening to electronic radio stations, entering a code from a scratch off coupon, participating in an auction, reading news, conducting a search, accessing an artist concert calendar, accessing information about an artist, and accessing information about showings.

27. The system as set forth in claim 23 wherein said database comprises an activity code assigned to each of said activities.

28. The system as set forth in claim 27 wherein said processing functionality tracks and records said activities engaged in by said user.

29. The system as set forth in claim 28 wherein said processing functionality is adapted to combine said activity codes of said activities engaged in by said user with said user demographic data

30. The system as set forth in claim 29 wherein said database is adapted to cooperate with said processing functionality to store information about said activities engaged in by said user and said user demographic data.

31. The system as set forth in claim 30 wherein auction activities are assigned a point value.

32. The system as set forth in claim 31 wherein said point values associated with said activities are based on an effort ranking.

33. The system as set forth in claim 32 further comprising a reporting communications functionality adapted to inform industry entities of said activities engaged in by said user, said point values of said activities and said user demographic data.

34. The system as set forth in claim 33 wherein said auction can be controlled at least by adjusting the time period in which the auction occurs.

35. The system as set forth in claim 34 wherein said auction can be controlled at least by adjusting the minimum/maximum bid for said premium.

36. The system as set forth in claim 25 wherein said premiums are made available in recognition of promotional value on said platform.

37. An on-line method of measuring user response to content, comprising:
receiving user demographic data;
providing a platform to users so that said users can access said content;
providing activities related to said content to said users;
tracking said activities engaged in by said users; and
combining said user demographic data with said activities engaged in by said user and reporting to third parties.

38. The method as set forth in claim 37, wherein the receiving user demographic data comprises allowing said users to input said user demographic data.

39. The method as set forth in claim 37, wherein the providing activities related to said content to users comprises allowing users to select from a menu of activities related to said content.

40. The method as set forth in claim 37, wherein each of said activities are assigned a point value.

41. The method as set forth in claim 40, wherein said point value associated with each of said activities is based on a commitment level ranking.

42. The method as set forth in claim 41, wherein the tracking said activities engaged in by said users comprises tracking the point value accumulated by said user engaged in by said users.

43. The method as set forth in claim 41, further comprising providing an on-line auction to said users for premiums.

44. The method as set forth in claim 43, wherein proving an on-line auction to said users for premiums comprises receiving user bids of points from said users for said premiums.

45. The method as set forth in claim 44, further comprising awarding said premiums to said users.

46. The method as set forth in claim 44, further comprising assigning point values to user bids for premiums and tracking accumulated point values by said users during said on-line auctions.

47. The method as set forth in claim 37, further comprising receiving payments from a client in exchange for providing said client's content on said platform.

48. A method of providing commercially relevant information about user response to content available on-line, comprising:
allowing users to access an affiliate site comprising said content and activities related to said content;
allowing said users to input user demographic data;
allowing users to request and receive said content from said affiliate site;
providing a platform adapted to interact with said affiliate site and for receiving, storing, and correlating said user demographic data and said users requests for content; and
reporting said user demographic data and said users requests for content to an industry entity.

49. The method as set forth in claim 48, further comprising allowing said users to engage in activities related to said content on said affiliate site.

50. The method as set forth in claim 49, wherein each of said activities is assigned a point value reflecting a commitment level of said user.

51. The method as set forth in claim 50, further comprising awarding points to said users for engaging in said activities.

52. The method as set forth in claim 51, further comprising storing said points accumulated by said users in said platform.

53. The method as set forth in claim 52, further comprising providing an auction engine adapted to cooperate with said platform.

54. The method as set forth in claim 53, wherein the providing an auction engine comprises allowing said users to bid said points in exchange for premiums.

55. The method as set forth in claim 54, further comprising awarding said premiums to said user making the highest bid.

56. The method as set forth in claim 48, further comprising awarding royalty payments to clients in exchange for providing said content to said affiliate sites.

57. A method of providing user access to on-line content, comprising:
providing a platform comprising said content and activities related to said content;
allowing users to input demographic data;
allowing users to request said content;
allowing users to engage in activities related to said content;
awarding points to users for requesting content and/or engaging in activities related to said content, the amount of said points awarded based on a commitment level ranking of said activities;
providing an auction engine adapted to cooperate with said platform; and
allowing users to bid points in an auction in exchange for premiums.

58. The method as set forth in claim 57, further comprising setting a fixed amount of time for said users to bid points in said auction.

59. The method as set forth in claim 57, further comprising awarding said premium to said user placing the highest bid for said premium.

60. The method as set forth in claim 57, further comprising setting a minimum point bid amount for said premiums in said auction.

61. The method as set forth in claim 57, further comprising providing a processing functionality for receiving and correlating user demographic data with said users request for content and said activities engaged in by said user.

62. The method as set forth in claim 61, further comprising providing a reporting communications functionality adapted to cooperate with said processing functionality and for reporting correlated user demographic data with said users request for content and said activities engaged in by said user to industry entities.

63. The method as set forth in claim 57, further comprising allowing said users to pay a subscription fee in exchange for increased interactive opportunities and increased point accumulation for engaging in said activities.
